(19) United States
(12) Patent Application Publication
(10) Pub. No.: US 2013/0173402 A1
(43) Pub. Date: Jul. 4, 2013

(54) TECHNIQUES FOR FACILITATING ON-LINE ELECTRONIC COMMERCE TRANSACTIONS RELATING TO THE SALE OF GOODS AND MERCHANDISE

(71) Applicant: TUNIPOP, INC., Boulder, CO (US)

(72) Inventors: Andrew Morrison YOUNG, Lafayette, CO (US); Arthur A. PORCARO, Westminster, CO (US)

(73) Assignee: TUNIPOP, INC., Boulder, CO (US)

(21) Appl. No.: 13/779,150

(22) Filed: Feb. 27, 2013

Related U.S. Application Data
(63) Continuation of application No. PCT/US2011/049469, filed on Aug. 27, 2011.
(60) Provisional application No. 61/378,125, filed on Aug. 30, 2010.
(60) Provisional application No. 61/428,221, filed on Dec. 29, 2010.

(51) Int. Cl. G06Q 30/06

(52) U.S. Cl. CPC G06Q 30/0631
USPC 705/14.73; 705/26.7

(57) ABSTRACT

Various aspects described herein are directed to different methods, systems, and computer program products for facilitating on-line electronic commerce transactions relating to the sale of goods, merchandise, services, and/or special offers.

### RELATED APPLICATION DATA

The present application is a continuation of pending International Patent Application No. PCT/US2011/049469, titled “TECHNIQUES FOR FACILITATING ON-LINE ELECTRONIC COMMERCE TRANSACTIONS RELATING TO THE SALE OF GOODS AND MERCHANDISE”, naming Young et al. as inventors, filed on Aug. 27, 2011, designating the United States, the entirety of which is incorporated herein by reference for all purposes.

This application claims benefit from and incorporates by reference in its entirety and for all purposes U.S. Patent Application Ser. No. 61/378,125 (Attorney Docket No. TUNIP001P) titled “TECHNIQUES FOR FACILITATING ON-LINE ELECTRONIC COMMERCE TRANSACTIONS RELATING TO THE SALE OF GOODS AND MERCHANDISE”, by Young et al., filed Aug. 30, 2010.

This application claims benefit from and incorporates by reference in its entirety and for all purposes U.S. Patent Application Ser. No. 61/428,221 (Attorney Docket No. TUNIP001P2) titled “TECHNIQUES FOR FACILITATING ON-LINE ELECTRONIC COMMERCE TRANSACTIONS RELATING TO THE SALE OF GOODS AND MERCHANDISE”, by Young et al., filed 29 Dec. 2010.

### BACKGROUND

The present application relates to techniques for facilitating on-line electronic commerce transactions relating to the sale of goods and merchandise. As the popularity and use of the Internet for conducting commercial transactions and advertising continues to increase, many types of retail commercial transactions continue to be adapted for electronic commerce implementation via the Internet.

### BRIEF DESCRIPTION OF THE DRAWINGS

FIG. 1 illustrates a simplified block diagram of a specific example embodiment of a Merchandise Query and Sales System (MQSS) 100 which may be implemented in network portion 100.

FIG. 2 shows a specific example embodiment of a network diagram illustrating various aspects of a Merchandise Query and Sales System (MQSS) and/or process, which may be utilized for implementing various aspects, described herein.

FIG. 3 shows a diagrammatic representation of machine in the exemplary form of a client (or end user) computer system 300 within which a set of instructions, for causing the machine to perform any one or more of the methodologies discussed herein, may be executed.

FIG. 4 is a simplified block diagram of an exemplary client system 400 in accordance with a specific embodiment.

FIG. 5 illustrates an example embodiment of a server system 580 which may be used for implementing various aspects/features described herein.

FIG. 6 illustrates an example of a functional block diagram of a MQSS Server System in accordance with a specific embodiment.

FIGS. 7-13 illustrate various example embodiments of different MQSS procedures and/or procedural flows which may be used for facilitating activities relating to one or more of the MQSS aspects disclosed herein.

FIGS. 14-44 illustrate example screenshots of various GUIs which may be used for facilitating activities relating to one or more of the MQSS aspects disclosed herein. In at least one embodiment, at least a portion of the GUIs may be configured or designed for use at one or more mobile devices.

### DETAILED DESCRIPTION OF EXAMPLE EMBODIMENTS OVERVIEW

Various aspects described herein are directed to different methods, systems, and computer program products for facilitating on-line electronic commerce transactions relating to the sale of goods, merchandise, services, and/or special offers.

Various objects, features, functions, benefits and advantages of the various aspects described or referenced herein will become apparent from the following description of its example embodiments, which description should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

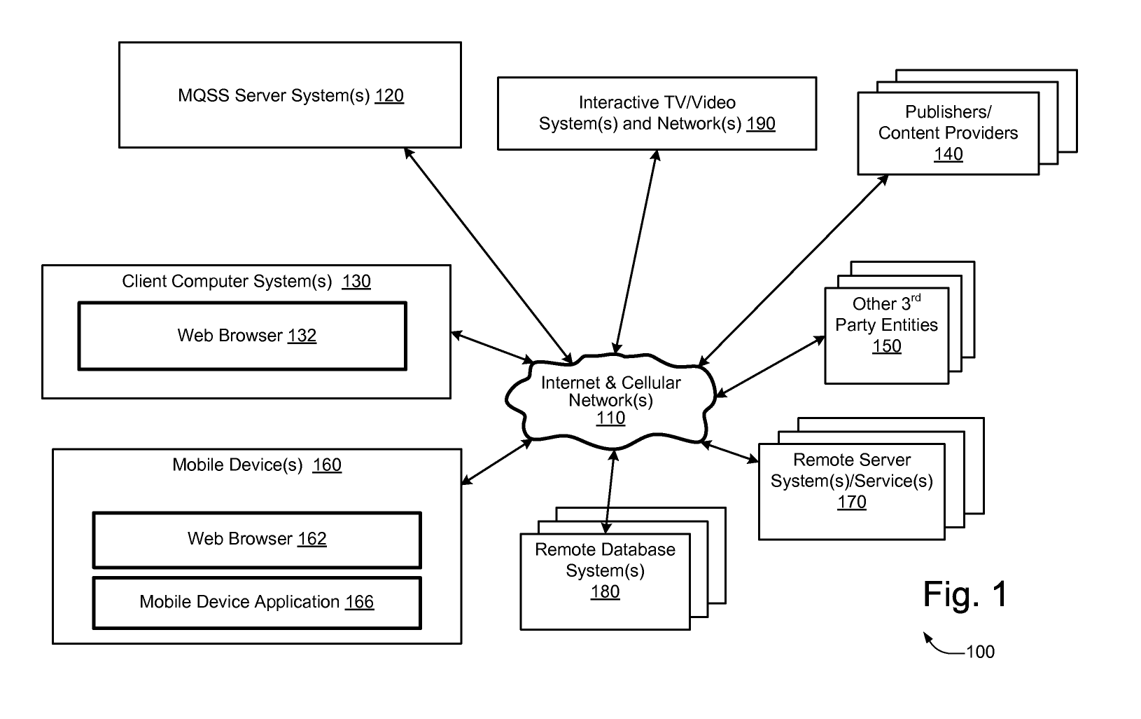

FIG. 1 illustrates a simplified block diagram of a specific example embodiment of a Merchandise Query and Sales System (MQSS) 100 which may be implemented in network portion 100. As described in greater detail herein, different embodiments of MQSS Systems may be configured, designed, and/or operable to provide various different types of operations, functionalities, and/or features generally relating to merchandise query and sales technology. Further, as described in greater detail herein, many of the various operations, functionalities, and/or features of the MQSS System(s) disclosed herein may provide may enable or provide different types of advantages and/or benefits to different entities interacting with the MQSS System(s).

For example, selling music merchandise like t-shirts and posters is one of the most profitable parts of the music business. Yet, it remains remarkably underutilized within the vast digital music landscape at the same time artists and record labels are committed to offsetting declines in CD sales, and online music services are desperate to monetize their growing user base. This disconnect between digital music distribution and the multi-billion dollar merchandise market has left authorized suppliers and artists without the means to communicate the availability of their products to hundreds of millions of music consumers in a way that is both familiar and comparable to online music discovery and purchasing. As a result, fans are left to search for items on their own, outside of the digital music experience, often leaving the retailer's site hoping to find authorized items from a reliable source. Business requirements for conveying digital content are very different than selling physical goods like merchandise. Consequently, music services do not have the time, budget, expertise or operations to work with multiple suppliers, nor do traditional merchandisers have a selling method or product information scheme that correlates with digital media.

It is also recognized that the merchandise marketplace is currently out of sync with trends in digital music discovery and consumption. Management and delivery of physical merchandise has very different requirements than that of digital media purchasing and/or streaming. Accordingly, today's fans are forced to seek out authorized suppliers via a separate experience from their music discovery/purchasing/streaming activities.

Accordingly, in at least one embodiment, the MQSS System may be configured or designed to provide a centralized music merchandise fulfillment network that empowers online music retailers, while eliminating significant infrastructure, investment and operating costs. By leveraging the MQSS System's technology, artists and authorized suppliers may expedite the sale of merchandise across a vast global network of music related services. Those same music services add a new layer of value for their fan base and capture new forms of revenue with zero cost outlay. Additionally, this may be accomplished without having to establish relationships with thousands of suppliers and artists, thus speeding the time to market.

The MQSS System's end-to-end solution provides a strong platform to manage various desired functions for the entire industry as merchandise selling shifts away from traditional methods to one that corresponds with digital music in a way that is convenient, timely and relevant to consumers. In at least one embodiment, the MQSS System may serve as a connection point for both the suppliers and retailers to reach users in the broad music marketplace. The rules-based platform allows both the supplier and retailer to set guidelines related to merchandise display, which builds on the collective strength of the entire the MQSS network.

For example, today's music merchandise industry is an extremely fragmented market place, and the MQSS System may be advantageously used to serve as the link between its various players. In at least one embodiment, the MQSS System sits between content delivery sites and merchandisers of product to create a one stop shop for aggregation and delivery of merchandise in the music and video industry. In at least one embodiment, the MQSS System may be configured or designed to provide a multi-layer solution that addresses both the content delivery sites as well as the merchandisers of product.

For the content delivery sites, the MQSS System may provide and/or facilitate enablement of one or more of the following (or combinations thereof):
A website, server, and/or API interface capable of handling a continuous stream of high transactions from a “Is there any merchandise for this artist/song/album?” perspective.
A self learning and correcting algorithm to address the complexity of disparate naming conventions between the content delivery sites.
An e-commerce platform with an easy to use user interface which may be seamlessly and quickly integrated into various websites and skinned appropriately.

For the merchandisers, the MQSS System may provide:
A robust order placement and management interface.
A flexible communication platform to integrate into various systems for fulfillment and distribution
A means of tracking consumer orders with shipment information Internally, the MQSS System may provide
A financial settlement system
A customer service system
A reporting system

According to different embodiments, at least some MQSS System(s) may be configured, designed, and/or operable to provide a number of different advantages and/or benefits and/or may be operable to initiate, and/or enable various different types of operations, functionalities, and/or features, such as, for example, one or more of those described and/or referenced herein.

For example, according to different embodiments, one or more MQSS System(s) may be configured, designed, and/or operable to provide a number of different advantages and/or benefits and/or may be operable to initiate, and/or enable various different types of operations, functionalities, and/or features, such as, for example, one or more of the following (or combinations thereof):
Intelligent rules-based platform for serving merchandise information
Cloud-based application model—secure, scalable, reliable
Aggregated supplier & data format import/export capabilities
Correlation engine that matches products with artist ID schemes
Flexible deployment model: hosted service or XML data feed
Integrates within online retailer's site, ensuring “site sticky-ness”, and allowing online retailer to customize look-and-feel as desired
Independent supplier and retailer management dashboards
Standard API and sandbox environment for developers
Ability to deliver a commerce network that recognizes any brand in digital media, including, for example, artists, bands, sports teams, music, video, etc.
Intelligent rules-based platform for serving merchandise information
   Rules engine allows administrative control for the retailer
   Ability to select what types of merchandise to be displayed/paired with an artist's catalog
   Ability to define the distribution sources, based on reliability, rating, reputation, best margin
   Merchandise choices may be defined as “top 10”, “most popular”, “other also bought”
Correlation engine that matches products with artist ID schemes
   Merchandise tags/identifiers are matched up with music/artist/genre IDs
   Flex/Flash, HTML5, and/or JavaScript API component (embedded application) serves tag of artist, song or genre to the MQSS System application, upon match, merchandise selection is served to the MQSS System merchandise widget interface (powered by the Flex/Ad server)
Independent supplier and retailer management dashboards
   Administrative utility allows for distributors to maintain their source feed, update items, alter pricing/margins, daily status on existing orders
   Administrative utility allows for retailers to monitor transactions fulfilled through the MQSS System, ability to toggle choices of merchandise, choice of distributors
Standard API and sandbox environment for developers
   Open, standards-based APIs that allow retailers to customize the MQSS System merchandise widget
Flexible deployment model
   Ability to implement as hosted service, cloud-based model or locally installed copy of the application (Widget/Ad server) installed within the retailer's data center
   The MQSS System's Centralized database is stored securely, on a highly scalable and reliable platform (5 9s of reliability, data stores are encrypted, replicated to a disaster recovery site (for business continuity and compliance purposes)
Aggregated supplier & data format import/export capabilities
   Distributor's catalogs may be reconciled, duplicates removed, competitive items may be sorted by best price and margin, converted into a consolidated “merchandise feed”
   Merchandise feed is updated daily and distributed electronically to retailer's site
   Feed may be imported manually or automatically ingested using a standard file format (example formats: xml, csv)
Integrates within online retailer's site, ensuring “site sticky-ness”
   The MQSS System implements as embedded Java script and HTML5 code within partner's site
   “Look and feel” of the MQSS System merchandise widget may be “skinned” to match retailer's site aesthetic
   Connect merchandise anywhere a brand, name or product may be identified in digital media such as, for example, various forms of digital entertainment (e.g., movies, television, games, radio, video, etc.,), sports, politics, etc.
Mobile & Live Event Considerations
   Enhance merchandise sales, before, during and after a live concert event
   Pre-authorize merchandise sales to CC used during ticket purchase via text message on user phone
   Deliver merchandise catalog feed to mobile applications
Dynamic filtering of merchandise availability results based on various types of filtering criteria such as, for example, one or more of the following (or combinations thereof):
   Brand ID
   Content Provider ID
   Ad ID
   User Location
   Geographical Criteria
   Time/Date
   Marketing Channel
   Sales Channel
   Customer demographics
   Media Type Category (e.g., Advertisement, Music, Video, Movie, Television, Radio, Website, Publisher, Social Network, Blog, Email, Platform (web, mobile, etc.), Text Message, etc.)
   Supplier ID
   SKU
   etc.
The MQSS System provides a complete end-to-end solution for mobile apps
   Data Collection
   Media recognition
   Delivery and Customer services

In at least one embodiment, merchandise may be sold congruently with music and matched by the artist name, album, song, video, brand related information and/or contextual related information. Revenues may come from a combination of user paid transaction fees on various transactions such as, for example, sales, monthly subscription(s) (e.g., charged to suppliers for participation in the MQSS System merchandise marketplace), etc. A portion of transactional revenues may be shared with retail partners. Operationally and developmentally, the model may be efficient relative to the sheer scale and number of music related touch-points and artists on the web today. Notable drivers may be the number of online music services (sales channels), authorized suppliers (artists) and the quantity and efficiency of sales transactions processed.

It will be appreciated that the MQSS System is the first platform to fundamentally change the way non-recorded music merchandise is marketed and sold online by unifying the fractured $5+billion global music merchandise marketplace, streamlining the supply chain, and connecting authorized suppliers with consumers in the expanding online music space. In this way, the MQSS System may provide additional benefits/advantages such as, for example, one or more of the following (or combinations thereof):
Equal access for one or more artists
Convenient, relevant, and timely access
Enable new marketing and bundling
Create value for the entire supply chain
Drive D2C sales, eliminate the retailer
Avoidance of licensing, warehousing or manufacturing
Connect sale of physical product with any digital media

According to different embodiments, at least a portion of the various types of functions, operations, actions, and/or other features provided by the MQSS System may be implemented at one or more client systems(s), at one or more server systems (s), and/or combinations thereof.

According to different embodiments, the MQSS System 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the MQSS System may include one or more of the following types of systems, components, devices, processes, etc. (or combinations thereof):
MQSS Server System(s) 120—In at least one embodiment, the MQSS Server System(s) may be operable to perform and/or implement various types of functions, operations, actions, and/or other features such as those described or referenced herein (e.g., such as those illustrated and/or described with respect to Figure ZZZ).
Publisher/Content Provider System component(s) 140
Client Computer System (s) 130
3^{rd} Party System(s) 150
Internet & Cellular Network(s) 110
Remote Database System(s) 180
Interactive TV/Video System(s) and/or Network(s) 190, which, for example, may include one or more of the following (or combinations thereof): cable TV system(s)/network(s), interactive video system(s)/network(s), satellite TV/Video system(s)/network(s), internet TV/Video system(s)/network(s), etc.
Remote Server System(s)/Service(s) 170, which, for example, may include, but are not limited to, one or more of the following (or combinations thereof):
Content provider servers/services
Media Streaming servers/services
Database storage/access/query servers/services
Financial transaction servers/services
Payment gateway servers/services
Electronic commerce servers/services
Event management/scheduling servers/services
Etc.
Mobile Device(s) 160—In at least one embodiment, the Mobile Device(s) may be operable to perform and/or implement various types of functions, operations, actions, and/or other features such as those described or referenced herein (e.g., such as those illustrated and/or described with respect to Figure ZZZ).
etc.

In at least one embodiment, the MQSS System may be operable to utilize and/or generate various different types of data and/or other types of information when performing specific tasks and/or operations. This may include, for example, input data/information and/or output data/information. For example, in at least one embodiment, the MQSS System may be operable to access, process, and/or otherwise utilize information from one or more different types of sources, such as, for example, one or more local and/or remote memories, devices and/or systems. Additionally, in at least one embodiment, the MQSS System may be operable to generate one or more different types of output data/information, which, for example, may be stored in memory of one or more local and/or remote devices and/or systems. Examples of different types of input data/information and/or output data/information which may be accessed and/or utilized by the MQSS System may include, but are not limited to, one or more of those described and/or referenced herein.

According to specific embodiments, multiple instances or threads of the MQSS System may be concurrently implemented and/or initiated via the use of one or more processors and/or other combinations of hardware and/or hardware and software. For example, in at least some embodiments, various aspects, features, and/or functionalities of the MQSS System may be performed, implemented and/or initiated by one or more of the various systems, components, systems, devices, procedures, processes, etc., described and/or referenced herein.

In at least one embodiment, a given instance of the MQSS System may access and/or utilize information from one or more associated databases. In at least one embodiment, at least a portion of the database information may be accessed via communication with one or more local and/or remote memory devices. Examples of different types of data which may be accessed by the MQSS System may include, but are not limited to, one or more of those described and/or referenced herein.

According to different embodiments, one or more different threads or instances of the MQSS System may be initiated in response to detection of one or more conditions or events satisfying one or more different types of minimum threshold criteria for triggering initiation of at least one instance of the MQSS System. Various examples of conditions or events which may trigger initiation and/or implementation of one or more different threads or instances of the MQSS System may include, but are not limited to, one or more of those described and/or referenced herein.

It will be appreciated that the MQSS System of FIG. 1 is but one example from a wide range of MQSS System embodiments which may be implemented. Other embodiments of the MQSS System (not shown) may include additional, fewer and/or different components/features that those illustrated in the example MQSS System embodiment of FIG. 1.

Generally, the MQSS techniques described herein may be implemented in hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the MQSS techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

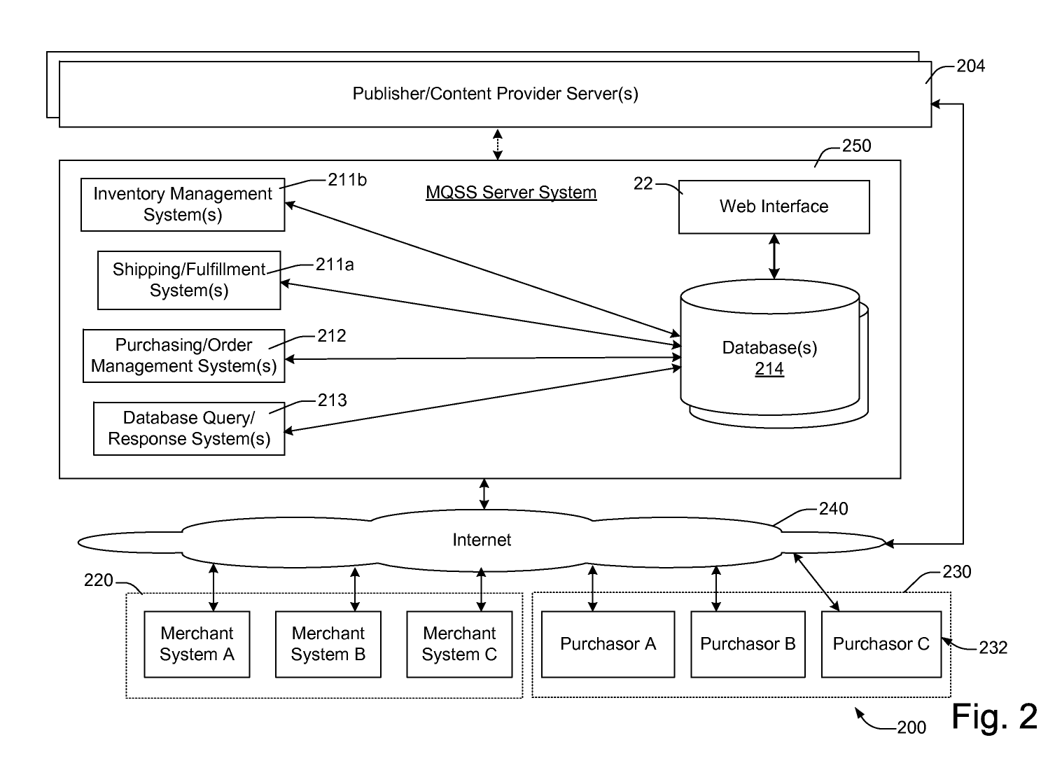

FIG. 2 shows a specific example embodiment of a network diagram illustrating various aspects of a Merchandise Query and Sales System (MQSS) and/or process, which may be utilized for implementing various aspects, described herein. In at least one embodiment, the interaction diagram of FIG. 2 illustrates the technical aspects of how the Merchandise Query and Sales System initiates and/or performs a variety of different types of merchandise query and sales operations and/or activities such as those described herein.

According to specific embodiments, the Merchandise Query and Sales System may be accessible to various entities such as, for example: individual persons, corporate or business entities, system administrators, online content providers, online publishers, merchants, artists, copyright holders, etc.

In at least one embodiment, the Merchandise Query and Sales System may be configured or designed to automatically identify various types of criteria (e.g., song, artist, album, TV show, sporting event, movie title, sports team, etc.) relating to content being displayed to a user as the user browses content at a publisher's (or content provider's) website. For example, if it is assumed that user is browsing the a content provider's website, and submits a request to view (or listening to) online content relating to a particular song or artist (e.g., John Denver), the Merchandise Query and Sales System may automatically identify the artist ID (e.g., John Denver), and may automatically initiate a query to the MQSS System to determine whether there is any John Denver related merchandise (e.g., hats, t-shirts, stickers, concert tickets, etc.) available for purchase. In one embodiment, if any available related merchandise is identified, the user may be automatically informed or notified (e.g., via an icon or logo appearing on the user's display screen which, for example, signifies to the user that there is artist-related merchandise (and/or other types of goods/services) available for purchase.

In the example of FIG. 2 it may be assumed that a purchaser (e.g., Purchaser A) is accessing an online content provider website (e.g., www.MP3.com) and desires to initiate an online purchase for an item of merchandise associated with a selected artist.

In at least one embodiment, a GUI may be displayed to the purchaser to facilitate the online purchase of the item of merchandise. In one embodiment, the GUI may be implemented in the form of a dynamic overlay layer which enables the purchaser to complete the purchase of desired items of merchandise without causing the user's browser application to navigate away from the underlying web page. In at least one embodiment, a User Web Interface (e.g., 210, FIG. 2) may provide functionality for dynamically generating at least a portion of the MQSS Application GUI.

In an alternate embodiment, a user may be accessing an online video streaming website such as youtube.com or Netflix.com, whereupon the MQSS System (in communication with the website server) may identify brands (e.g., artists, actors, movies, etc.) relating to the user's browsing and/or streaming activities, and may automatically identify and present opportunities for the user to purchase merchandise relating to (or associated with) the identified brands. For example, a GUI may be displayed to the purchaser to facilitate the online purchase of item(s) of merchandise. In one embodiment, the GUI may be implemented in the form of a dynamic overlay layer which enables the purchaser to complete the purchase of desired items of merchandise without causing the user's browser application to navigate away from the underlying web page.

As illustrated in the example embodiment of FIG. 2, MQSS System may include one or more databases (e.g. 214, FIG. 2), which, for example, may be populated with information relating to merchants, merchandise, artists, order information, etc.

In at least one embodiment, one or more of the databases may be queried via the use of various types of programming languages and/or protocols such as, for example, one or more of the following (or combinations thereof):
HTML
XML
MySQL
Perl
Ajax
JavaScript
Etc.

In at least one embodiment, a purchaser may initiate a merchandise query and sales session via the Internet (e.g., via 240, FIG. 2) to cause the Merchandise Query and Sales System to search out and/or find the best matches for purchasing multiple different items of merchandise, according to user-specified purchasing criteria.

In at least one embodiment, the MQSS System may be operable to populate and/or access information at Database(s) 214, and utilize such information in order to identify and/or determine available merchandise information. Examples of such database information may include, but are not limited to, one or more of the following (or combinations thereof):
Merchant Profile Criteria, including, but not limited to merchant rating, merchant feedback, etc.;
Shipping criteria;
Item condition criteria;
Negative filter criteria;
Pricing criteria;
Artist criteria (e.g., show only available merchandise associated with an a selected artist which has been identified, for example, based upon the user's browsing activities and/or the content being displayed or presented to the user);
Brand-related criteria such as, for example, branding information related to (or associated with) one or more of the following (or combinations thereof):
   TV Shows
   Song
   Band
   Team
   Celebrity
   Album
   Sporting event
   Movie title
   Video title
   Book title
   Sports team
   Sports player
   Venue
   Gaming platforms
   Business entity
   Publisher
   Author
   Distributor
   Character
   Actor
   Political Figure
   Artist
   Musician
   Consumer Brand (Levi, Burton, Nike)
Media type criteria
Etc.

In at least one embodiment, after a user has completed the merchandise selection process, the Merchandise Query and Sales System may present the purchaser/user with a GUI displaying their user-selected items in a cart for review. To complete the transaction, the user may provide appropriate payment information via the GUI.

In at least one embodiment, after the user has completed the checkout process, the Purchasing/Order Management System (e.g., 212, FIG. 2) may record details of the order in one or more databases, and may automatically forward the order information to the appropriate merchant for processing and order fulfillment. Additionally, in at least one embodiment, the MQSS System may be operable to automatically track the progress of the order such as, for example, order confirmation, order fulfillment, shipment tracking, delivery tracking, refunds, etc.

It will be appreciated that the various embodiments of the Merchandise Query and Sales Systems disclosed herein are but a few examples from a wide range of Merchandise Query and Sales System embodiments which may be implemented. Other embodiments of the Merchandise Query and Sales System (not shown) may include additional, fewer and/or different components/features that those illustrated and described herein.

In at least one embodiment, the Merchandise Query and Sales System functionality may be operable to perform and/or implement various types of functions, operations, actions, and/or other features such as, for example, one or more of the following (or combinations thereof):
Monitor user behaviors and activities;
Identify brand-related information associated with user-accessible content that the user is accessing; has requested access to; and/or has interest in;
Identify available merchandise based on specified criteria;
Manage and track revenue sharing;
Manage reporting;
Transact online ordering and purchasing;
Transact Database queries/responses
Acquire and manage merchandising information;
Manage merchant subscription services;
Provide query disambiguation;
Facilitate order management and tracking;
Etc.

According to specific embodiments, multiple instances or threads of the Merchandise Query and Sales System functionality may be concurrently implemented and/or initiated via the use of one or more processors and/or other combinations of hardware and/or hardware and software. For example, in at least some embodiments, various aspects, features, and/or functionalities of the Merchandise Query and Sales System mechanism(s) may be performed, implemented and/or initiated by one or more of the following types of systems, components, systems, devices, procedures, processes, etc. (or combinations thereof):
Inventory Management system(s)
Shipping/Fulfillment management system(s);
Online Order management/tracking system(s);
Shopping cart system(s);
Databases
Database query interface(s)
Merchant interface component(s)
Publisher/Content Provider interface component(s)
Customer Interface component(s)
Administrative interface component(s)
Sales channel partner interface component(s)
Artist interface component(s)
etc.

According to different embodiments, one or more different threads or instances of the Merchandise Query and Sales System functionality may be initiated in response to detection of one or more conditions or events satisfying one or more different types of minimum threshold criteria for triggering initiation of at least one instance of the Merchandise Query and Sales System functionality. Various examples of conditions or events which may trigger initiation and/or implementation of one or more different threads or instances of the Merchandise Query and Sales System functionality may include, but are not limited to, one or more of the following (or combinations thereof):
Detection of user interest in particular artist, brand and/or other criteria
Identification of user;
Detection of user input;
Detection of merchant input;
Identification of available merchandise matching selected criteria such as, for example, artist criteria, brand criteria, etc.;
Detection of user's interest in purchasing merchandise (e.g., user clicks on MQSS icon)
Identification of merchandise that user desires to purchase;
Detection completed purchase/order transaction;
Determination of revenue sharing distributions;
Receiving database query communication from external server (e.g., Content Provider Server)
Etc.

In at least one embodiment, a given instance of the Merchandise Query and Sales System functionality may access and/or utilize information from one or more associated databases. In at least one embodiment, at least a portion of the database information may be accessed via communication with one or more local and/or remote memory devices. Examples of different types of data which may be accessed by the Merchandise Query and Sales System functionality may include, but are not limited to, one or more of the following (or combinations thereof):
Brand-related information;
Merchandise availability information;
Pricing information;
User behavior and analytic information;
Performance information;
Inventory information;
Merchant information;
Supplier information;
Brand related taxonomy information;
Merchant subscription information;
Ecommerce related transaction information;
Order information;
Publisher/Content Provider information;
User profile information;
Merchant-brand association information;
etc.

In at least one embodiment, the Merchandise Query and Sales System may include automated intelligence for translating the many iterations of an artist (or brand) reference (name or number) from a music, news or media stream provider, and matching those with available items connected to that brand in an electronic catalog database. According to different embodiments, this is accomplished in different ways, such as, for example, using one or more of the following types of features/functionality.

In at least one embodiment, the MQSS System (e.g., 250) may be configured or designed to automatically and/or dynamically analyze and process a catalog database from multiple suppliers, and may be further configured or designed configured or designed to correct, standardize and/or correlate one or more artist name references. In at least one embodiment, the MQSS System may also be configured or designed to generate and/or assign a unique Identifier (e.g., Brand ID) to at least one catalog item by, for example, referencing Artist name, and matching Artist approved item ID or SKU, with suppliers item or SKU. In at least one embodiment, system may include automated mechanism for ensuring or verifying that supplier submitted SKUs are authorized for sale by requesting the Artist SKU #s.

In at least one embodiment, each Artist SKU# may be assigned a respectively unique Brand ID. In one embodiment, it may be expected that the MQSS System may receive the same catalog item from multiple suppliers. However, in at least one embodiment, these duplicates may be assigned the same Brand ID and may be displayed to the end user as a single item/entry. Such a feature may be referred to as catalog normalization or disambiguation. Order for items with multiple suppliers may be fulfilled by a preferred supply selection process.

In at least one embodiment, the MQSS System (e.g., 250) may be further configured or designed to identify disparate products feeds and standardize them correlated to artist ID, and syndicate the feed to distribution partners (e.g., Music services).

According to different embodiments, the MQSS System may be configured or designed to perform one or more of the following functions/operations (or combinations thereof):
Lookup of one or more different spellings (e.g., of Artist name(s), song(s), brand(s), etc.). According to different embodiments, lookup tables may be manually and/or automatically populated. In at least one embodiment, an automated process monitors and flags future non-recognized Branding ID (lookup data). Flagged entries are reviewed (e.g., by human or automated process) and categorized correctly, adding new term into lookup table based on that particular case.
Use associated data/metadata to help accurately determine proper Brand ID.
   e.g., For identifying Artist, one or more of the following (or combinations thereof) could be used:
      song/track
      album
      co-artist information
      etc.
Identify Brand ID based on most likely/relevant match.
   In one embodiment, a unique Brand ID is associated with each artist. For example, in one embodiment, when one or more different spellings of an artist has been provided to the system, the system may automatically and dynamically select the most likely/relevant matching artist name from its database, and identify a unique Brand ID associated with the selected artist name.
   It two artists are collaborating on a song, track or album, and the Music retailer feed supplies either both artists or the collaborating track or album, the MQSS System may collect Brand IDs from both artists and display relevant merchandise associated with each of the identified Brand IDs.
   In at least one embodiment, if the collaborating artists have special merchandise for these collaborated songs, then the MQSS System may assign a different unique Brand ID for the combined artist merchandise and only display these catalog items to the user. This feature facilitates identification of special events or artist groups, such as “The MQSS Server System are the World”, “Band Aid” etc. where many artists collaborate, and merchandise is specific to the song or event and not the artist, and/or some of the proceeds go to the charity or cause. In this example a new artist brand is produced along with a Brand ID to assign the relevant merchandise.
   In at least some embodiments, the MQSS System may be configured or designed to include tagging functionality for enabling a given artist and/or item of merchandise to be tagged with multiple different Brand IDs and/or vice-versa.
Show similar artist merchandise.
   e.g., User views Paul Simon, and the MQSS System may automatically and/or dynamically suggest
      Simon and Garfunkel
      Graceland
      The Graduate soundtrack
These options may be presented as links or buttons on the catalog main screen. Once selected, the catalog may search the database by suggested Artist name, Genre, soundtrack, etc., and populate the main screen catalog with the additional merchandise
Translation Reference—In at least one embodiment, this may include building a database table of one or more known artist spellings with their associate record tracks, albums and other reference to use as a validation table for searching the MQSS System catalog for the correct artist.
Brand ID Service—In at least one embodiment, when responding to one or more Music Retailer requests, the MQSS System may return the Brand ID back to them to use as a reference identifier. This database and service (e.g., of catalog normalization and artist/Brand ID identification) may be leveraged to provide a variety of benefits/features/advantages.
   For example, in at least one embodiment, the data collected, stored and normalized may allow a Music Retailer or any other interested party to purchase, lease or use this lookup service to feed raw artist data and receive the corrected spelling and associated Brand ID. They may then use this to communicate with Brand ID enabled merchandise suppliers to collect merchandise catalog information outside of the MQSS System Service, or use the Artist's corrected spelling to do a more efficient search on the artist or submit requests and reduce errors to services such as Rovi or Gracenotes.
   In addition, the MQSS System's relationships with Rovi and other like services may associate the Brand ID to Rovi and other artist identification services, for example, to allow the Music Retailer to obtain the Rovi or any other service number via the MQSS System. The MQSS System may then share this revenue with the respective identification service. In at least one embodiment, the MQSS System may also provide the Brand ID information to these identification services so they may provide the Brand ID numbers to their clients and/or request a Brand ID for an artist.
Supplier ID—In at least one embodiment, the MQSS System may identify each of the different suppliers (and/or vendors), and may generate a respectively unique Supplier ID (SID) to be associated with each identified supplier.
Merchandise ID and Tagging—In at least one embodiment, the MQSS System may generate and/or associate a respectively unique Merchandise ID (or SKU) with each different item of merchandise in the MQSS database. In at least some embodiments, the MQSS System may be configured or designed to include tagging functionality for enabling a given item of merchandise to be tagged with multiple different types of identifiers or IDs, which, for example, may include, but are not limited to, one or more of the following (or combinations thereof):
   Brand ID
   Supplier ID (e.g., SID)
   Merchandise ID (e.g., SKU)
Exception Table—In at least one embodiment, this may include capturing one or more Music Retailer artist requests and build an exception table when the system cannot find a perfect match. Then use this exception table to improve the Translation Reference System by manually and/or automatically researching the referenced artist by originating media and/or other criteria.
Merchandise Authorization:
Database of authorized merchandise suppliers for any given artist, which may be filtered, for example, by one or more of the following (or combinations thereof):
   Region (e.g., geographic location),
   Attribute,
   SKU number,
   Expiration Date (loss of license or phase out of a particular supplier)
   Venue/Event
   Catalog type
   Preferred match of Music Retailer to a particular Supplier
      E.g., Best Buy owns Napster and if Napster wants one or more fulfillment orders to go to Best Buy fulfillment first before other suppliers
   Etc.
End to End Service
In at least one embodiment, the end to end process may include, but is not limited to, one or more of the following (or combinations thereof):
   Receiving a request for merchandise,
   Translating the artist name,
   Associating artist name (or other brand ID criteria) with selection of catalog items,
   Delivering various types of MQSS related information via and API or semi transparent application layer to the end user, Music Retailer, and/or other 3^{rd} parties,
   Catalog browsing,
   Shopping cart transactions,
   Etc.

In at least one embodiment, one or more of these processes may be performed and/or facilitated by the MQSS System without requiring that the user (or user's web browser) navigate away from the primary digital service (or current web page being displayed at the client system). For example, in at least one embodiment, a user may be browsing for music on MP3.com, and chose to initiate a music merchandise purchasing transaction (e.g., via the MQSS System), for example, by clicking on an appropriate icon displayed on the webpage currently being viewed by the user. In response, a dynamic overlay layer (or overlay GUI) may be caused to be displayed by the user's web browser, and may be configured or designed to enable the user to complete a merchandise purchasing transaction via the user's interaction with the overlay GUI. In at least one embodiment, all of the processes involved in the merchandise purchasing transaction (e.g., browsing inventory/merchandise, adding to shopping cart, completion of checkout and payment transactions, etc.) may be performed via the overlay GUI, without causing the user's web browser to navigate away from its current web page (e.g., MP3.com). After the merchandise purchasing transaction has been completed (or been cancelled), the overlay layer may automatically close, thereby allowing the user to continue his browsing activities from where he left off (e.g., browsing for music on MP3.com) prior to initiating the merchandise purchasing transaction.

In addition to the MQSS System features/functions/advantages/benefits described above, one or more embodiments of MQSS System(s) may be configured, designed, and/or operable to provide a number of other advantages and/or benefits and/or may be operable to initiate, and/or enable various different types of operations, functionalities, and/or features, such as, for example, one or more of the following (or combinations thereof) described below.

### Ticketing—Features/Benefits/Advantages/Example Embodiments

In at least one embodiment, the MQSS System may be operable to deliver (or facilitate delivery of) a merchandise offering against ticket sales. This may be implemented, for example, by pre-authorizing merchandise purchase amount(s) on a user's credit or debit card.
Pre-authorize merchandise sale at time of purchasing ticket online.
   In at least one embodiment, the MQSS System may facilitate the sale of pre-authorize merchandise at the time of purchasing ticket online. According to specific embodiments, such transactions may be performed via computer, cell phone, smart phone, tablet, and/or or other types of mobile device(s).
   Location and/or Time based service may ping user about purchasing merchandise based on detected criteria such as, for example, when show has ended, when user leaving venue.
   For example, in one embodiment, user snaps a picture of a bar code for a particular item. In one embodiment, the bar code is generated by the MQSS System, and displayed on the user's web browser during an online transaction (such as, for example, the purchasing of event tickets). The bar code may be converted to an order request within the MQSS System.
   According to different embodiments, there may be a variety of different ways for the user to complete the merchandise purchasing transaction such as, for example, one or more of the following (or combinations thereof):
      User gets an email to complete the order
      User gets a text message with instructions to complete the order
      User may confirm the order directly on the phone or device and authorized via carrier service or payment method
   Users who provide a cell phone number at the time of ticketing (and/or who signs in via social network service) may be tracked via GPS type service and if they are at the live event, they may get special treatment or unique product offerings that they may order based on any various different techniques such as, for example, one of more of those described herein.
   According to different embodiments, users may receive various types of promotions, offers, and/or notifications via their mobile device. In at least one embodiment, different types of criteria may be used for determining whether a particular event/condition has been satisfied or has occurred for triggering an automated communication to the user. Examples of such criteria may include, but are not limited to, one or more of the following (or combinations thereof):
      Time criteria
      User location criteria
      Event criteria
      Inventory criteria
      etc.

Additional examples illustrating different ways users may be tracked and/or notified of offerings at the event venue may include, but are not limited to, one or more of the following (or combinations thereof):
Free T-shirt to first n (e.g., n=100) users who check in at specific booth/location at the venue.
User receives some type of promotion/reward if they arrive at the venue before/after a certain time.
MQSS system detects that user had arrived at event venue, and sends a reminder via text message for the user to remember to pick up their pre-purchased merchandise.
MQSS system detects that it is past the time for the scheduled event to end, and detects that the user is still at the event venue, and also detects that the user has not picked up his or her pre-purchased merchandise. System sends a message to user to remind user to pick up their pre-purchased merchandise.
MQSS system detects that it is past the time for the scheduled event to end, and detects that the user is still at the event venue . . . . MQSS server dynamically generates and sends message to user with promotion for user to purchase merchandise at one or more vendor booths at the venue.
Etc.

In at least one embodiment, a Live Event merchandise table may reference the MQSS System Brand ID or other unique identifier(s) which may allow the user to send a message to the MQSS System to store the product they want to purchase without having to wait in line. If they have pre-authorized the purchase, the item may be automatically shipped to the purchaser without requiring further interaction/input from the purchaser.
E.g., enable random drawings of promotional items at the live event, for example, if users trigger any of the above methods.
Enables and facilitates ability to sell ticketing/event tickets when browsing music provider (or content provider) website.

### Mobile Environments—Features/Benefits/Advantages/Example Embodiments

According to different embodiments, the MQSS System may be operable to utilize various mobile devices (e.g., smart phones, PDA, tablets, etc.) to conduct and/or facilitate one or more of the various types of transactions described and/or referenced herein. Some examples may include, but are not limited to, one or more of the following (or combinations thereof):
Validate/enable user's ability to purchase merchandise via mobile device (e.g., cell phone, PDA, etc.)
a) Purchasing techniques:
   Text message. E.g., Use text to purchase goods at event for later shipping or present bar code for purchase on-site.
   Mobile device performs barcode scan of item to be purchased (e.g., at event). For example, in one embodiment, user may use the camera functionality of the user's mobile device to take a snapshot (or screenshot) of a barcode.
   Vendor (e.g., at event) scans barcode presented on user's mobile device. In one embodiment, the vendor may use the camera functionality of the vendor's mobile device to take a snapshot (or screenshot) of a barcode, and/or
b) Bar code sales
   At least one user provided with unique barcode ID which user may display on user's cell phone, and user may purchase items at concert by letting vendor scan bar code and then scanning purchased merchandise
   Vendors provide list of barcodes for merchandise . . . user simply scans barcodes that user wishes to purchase . . . use phone camera to scan barcode.
   Pre-authorized amount (e.g., for kids)
   Authorized/Linked to credit card
   According to different embodiments, the Bar Code information may include or may be used for various purposes/activities such as, for example, one or more of the following (or combinations thereof):
      as a receipt or proof of purchase (or pre-purchase) of item (or order) of merchandise
      as a way to identify/access user's shopping cart
      to offer promotion, coupons and/or discounts
      as a verification tool which may be used for verifying various different criteria such as, for example:
         user's identity
         user's present location
         vendor/merchant identity
         merchandise identity
         order identity
         purchase confirmation
         order confirmation
         financial payment/transaction information
         etc.
c) User (or third party such as user's friend, user's parent, etc.) may preauthorize purchases for up to max desired total value at time when completing online ticket purchase.
d) Use geo location, time, and/or other dynamic criteria to determine and present merchandise offerings.

### Playlist Integration—Features/Benefits/Advantages/Example Embodiments

Ability to investigate/interrogate a users play list or song catalog to determine appropriate merchandise offerings. (e.g., with permission).
Within a user's playlist, artist names may be part of the information stored on the users system. The MQSS System may interrogate these artist names, run them through the MQSS System translation system, gather one or more of the artist ID and the related Brand IDs and present the user with a consolidated catalog of one or more artists, related Merchandise, related events, etc. The MQSS System may store the catalog for repeated use.
The user may sort, select and eliminate artists and/or related merchandise offerings from the list and then purchase via a checkout process, which, for example, may be transacted via the MQSS System.
If the user modifies the artist list, such as, for example, by adding more artists, the user's playlist and catalog items may be automatically and/or dynamically updated. According to different embodiments, the Service may store the catalog information on the user's machine and/or may store the catalog information at the MQSS System, and make it available as a web service.

### Aggregated Activity Data

In at least one embodiment, collected data may be mined and monetized. Various example embodiments are described below.
A. Competition/consideration: Services such as Gracenotes and Rovi provide an artist identifier, but do not associate the artist identifier with merchandise. In at least one embodiment, the MQSS System database may be leveraged to provide opportunities to cross license their database to match it with MQSS's Brand ID/merchandise databases. Thus, for example, in one embodiment, the MQSS System may be configured or designed to provide services/functionality for cross-referencing Brand ID-ROVI artist identifiers to thereby enable Rovi to associate artist-related merchandise with their artist identifiers.
B. Other opportunities and marketplace value: As the MQSS System receives merchandise requests the MQSS Server System are in a position to capture one or more music being streamed by one or more retailer using the MQSS Server System service. This information may be analyzed and used to build a sales pipeline of artists who have not submitted their catalog to the MQSS System, discuss with artist within a defined tier that engaging with the MQSS System services could reap similar tier revenue performance, and help merchandisers manage inventory levels.
C. Music Industry. The MQSS System's database provide instant access to songs streamed. This may be used to create industry data such as, for example, one or more of the following (or combinations thereof):
   Top Artists
   Top Genres
   Impact of Artist event on downloads and number of plays
   Impact of Industry events (e.g. Grammy's on downloads and artists play requests)
   Where types of music are played (e.g., geographic regions)
D. Music Labels—Various techniques disclosed herein may provide a number of benefits/advantages/features to Music Label Entities such as, for example, one or more of the following (or combinations thereof):
   a. Accurate indication of Artist appeal
      i. More valuable than social network information
   b. See immediate impact of marketing efforts
      i. Modify marketing efforts
         1. by region
         2. by artist
         3. by genre
   c. Activity—e.g., User Activities, Vendor/Merchant Activities, etc. (e.g., pre and post live events)
   d. Compare Music Label's authorized artist marketing activities
      i. Ability to deliver specific artist information (e.g., as long as these artist are under their labels)
      ii. Deliver aggregate information of artists not under their label
E. Consulting and Marketing agencies
   a. Public website of summary information such as, for example, a top 100 artists
   b. Provide ability to access more detailed information available via a paid subscription
   c. Special information on a case by case basis with additional payments
   d. Artist—Enable Artists' ability to rack their rankings and play lists (e.g., among various users, etc.)
F. Industry watchdogs
Connecting merchandise/physical delivery with video streaming in a retail setting.
   For example: A user or customer is in a shop where there are videos and music playing on various displays. In at least one embodiment, various techniques disclosed herein may be utilized to enable the video to function or to be used as an interface for facilitating product/merchandise sales based, for example, on geolocation, bar code scanning, etc.
   For example, at least one embodiment may be adapted to capture impulse purchases from an inventory-less display, and/or to process the sales transaction at the retailer's cash register (such as, for example, via scanning a bar-code which was captured by the user's mobile device). In another example, at least one embodiment may be adapted for use in a live concert event setting.

In at least one embodiment, the MQSS System may be operable to interact with other third-party systems and/or third-party entities, such as those which have been engaged or hired by the retailer to push, stream, or otherwise provide media content (e.g., music, videos, etc.) within the retail store. Using conventional techniques, such media content has not been configured or designed to allow a user or customer at the retail store to interact with the content (or to capture portions of the displayed content such as a displayed bar code) to facilitate additional merchandise sales such as, for example, artist merchandise associated with the media content being displayed to the user.

However, in at least one embodiment disclosed herein, such media content may adapted to allow a user or customer at the retail store to interact with the content (or to capture portions of the displayed content such as a displayed bar code) to facilitate additional merchandise sales. For example, by way of illustration, in at least one embodiment, the MQSS System and the third-party video content display system may be adapted to work together to enable additional functionality/features, which, for example, enables the following sequence of events to occur:
a. The customer sees a video on a monitor in the store.
b. Monitor displays bar code of items available for purchase (in at least one embodiment, the items which are available for purchase may relate to merchandise associated with an artist who is currently shown performing on the monitor).
c. Customer captures displayed bar code on customer's phone or mobile device.
d. Bar code automatically converts to coupon which can be purchased at cash register of store.

In another embodiment, a static bar code may be displayed (e.g., either on the monitor or printed on a piece of physical media which is displayed within the retail store).
a. Customer snaps picture of bar code w/ phone.
b. Picture also captures GPS and timestamp data.
c. At least a portion of this data may be transmitted back to the MQSS System.
d. MQSS System uses GPS and timestamp data to determine which add was displayed at that time/location, and then determines which item of merchandise associated with identified time/location (and bar code).

In yet another embodiment, one or more different items of merchandise may be used or adapted for use as a ticket or other authentication device for use in live events such as, for example, concerts, shows, etc. For example, in at least one embodiment, Instead of paper selling ticket, customers get option to upgrade to a “merchandise ticket” where the merchandise IS the actual ticket. The merchandise can be modified to include some type of authentication.

### Additional Examples/Features of Virtual Merchandising Relating to Brick And Mortar Retail or Broadcast Setting

In at least one embodiment, the MQSS System may be operable to provide the ability to monetize video monitors and visual digital content in a retail or broadcast settings utilizing the MQSS merchandise catalog which could include both physical and digital items (music downloads, video, etc). In one embodiment, content is matched with available merchandise and presented as a bar code or text message within the video display. MQSS System manages supply chain and after sales support requirements.
Bar codes are easily readable off of standard LCD and high definition video displays and can be read from several feet away.
Capture purchase on-the-spot utilizing retailers existing point of purchase system allowing retailer to participate in transaction without having physical inventory.
Possible use locations: clothing retailers, bars & nightclubs, entertainment venues, sporting events electronics retailers, restaurants.
Example#1: Hardrock Café patron wants to purchase t-shirt from favorite artist video that was playing during dinner.
Example#2: Best Buy offers virtual display of music merchandise at checkout counter. Example Process Flow
Customer sees bar code or text code on video monitor.
Scan bar code with mobile device which opens a page on mobile device.
Browes product catagories and selects size and options.
Adds items to their shopping cart and prepares to “check out”.
When ready to purchase, a unique bar code is returned that is readable by retailers point of purchase system, similar in functionality to activating a gift card.
Payment is made in form acceptable to retailer.
Purchase is confirmed to mobile device user can respond with shipping information via mobile or email.
In at least one embodiment, no CC information is stored, no validation of CC is required because it is swiped at point of purchase.

### Variations/Options

Purchase via mobile device or from email—retailer may be identified by unique code in bar code.
Bar code appears in any video content on the Internet or broadcast television.
Video content could be presented with a touch screen display that allows users to browse entire MQSS System merchandise catalog; literally put products in the check-out aisle in a retail environment.
Bar code could be retained for future use outside of retail environment with credit still be attributed to retailer

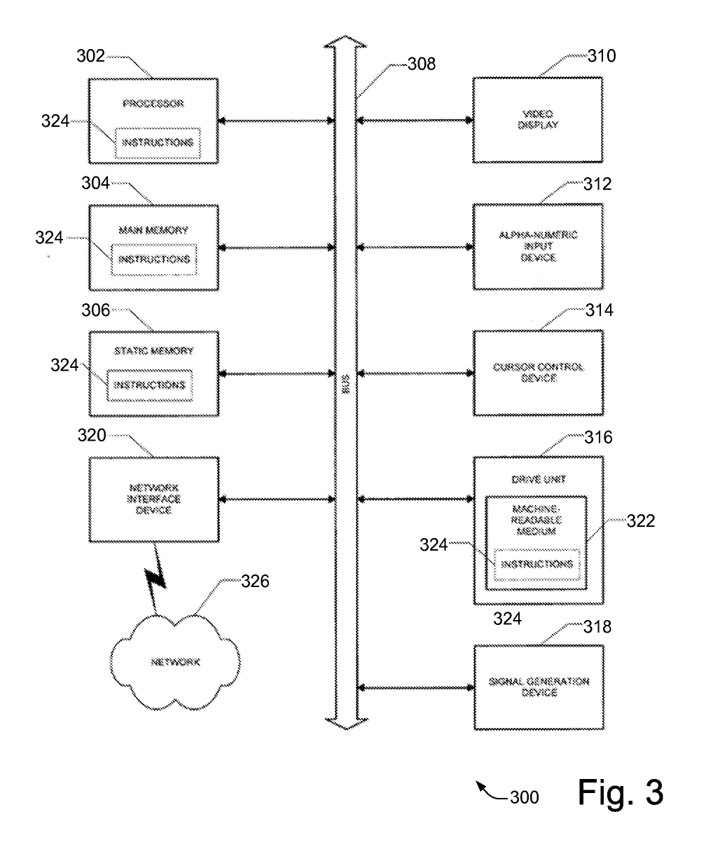

FIG. 3 shows a diagrammatic representation of machine in the exemplary form of a client (or end user) computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions and data structures (e.g., software 324) embodying or utilized by any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320 utilizing any one of a number of well-known transfer protocols (e.g., HTTP).

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Although an embodiment of the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

According to various embodiments, Client Computer System 300 may include a variety of components, modules and/or systems for providing various types of functionality. For example, in at least one embodiment, Client Computer System 300 may include a web browser application which is operable to process, execute, and/or support the use of scripts (e.g., JavaScript, AJAX, etc.), Plug-ins, executable code, virtual machines, vector-based web animation (e.g., Adobe Flash), etc.

In at least one embodiment, the web browser application may be configured or designed to instantiate components and/or objects at the Client Computer System in response to processing scripts, instructions, and/or other information received from a remote server such as a web server. Examples of such components and/or objects may include, but are not limited to, one or more of the following (or combinations thereof):
UI Components such as those illustrated, described, and/or referenced herein.
Database Components such as those illustrated, described, and/or referenced herein.
Processing Components such as those illustrated, described, and/or referenced herein.
Other Components which, for example, may include components for facilitating and/or enabling the Client Computer System to perform and/or initiate various types of operations, activities, functions such as those described herein.

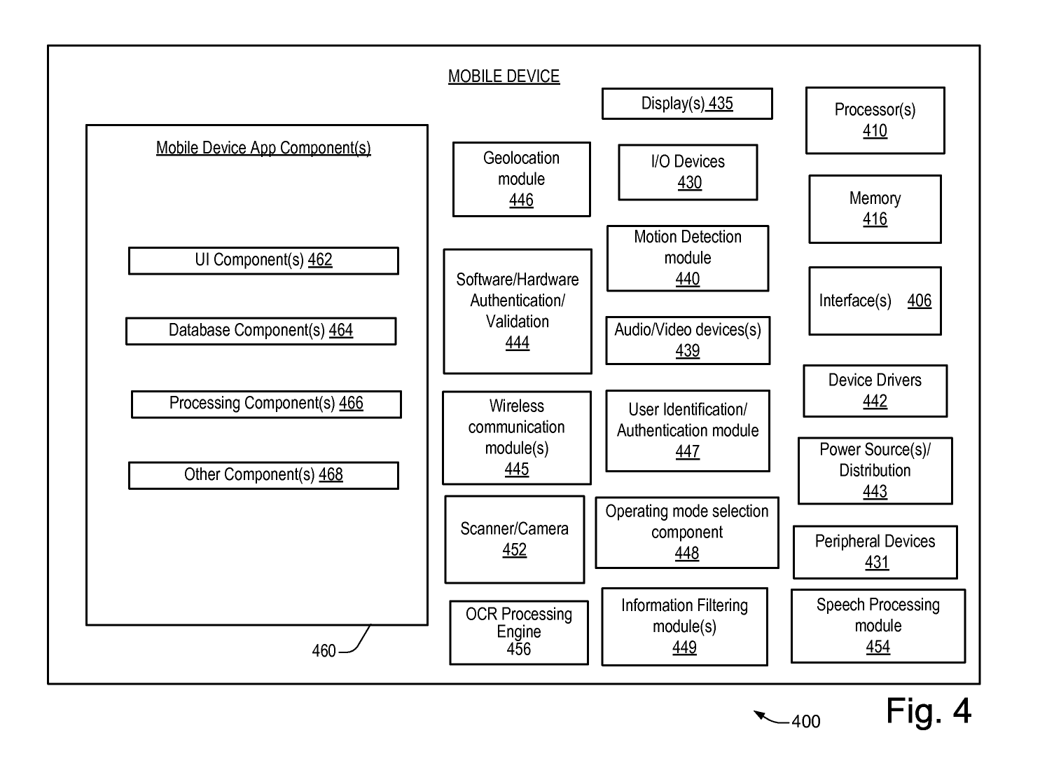

FIG. 4 is a simplified block diagram of an exemplary client system 400 in accordance with a specific embodiment. In at least one embodiment, the client system may include MQSS Mobile Device App Component(s) which have been configured or designed to provide functionality for enabling or implementing at least a portion of the various MQSS techniques at the client system.

According to specific embodiments, various aspects, features, and/or functionalities of the Mobile Device may be performed, implemented and/or initiated by one or more of the following types of systems, components, systems, devices, procedures, processes, etc. (or combinations thereof):
Processor(s) 410
Device Drivers 442
Memory 416
Interface(s) 406
Power Source(s)/Distribution 443
Geolocation module 446
Display(s) 435
I/O Devices 430
Audio/Video devices(s) 439
Peripheral Devices 431
Motion Detection module 440
User Identification/Authentication module 447
Client App Component(s) 460
Other Component(s) 468
UI Component(s) 462
Database Component(s) 464
Processing Component(s) 466
Software/Hardware Authentication/Validation 444
Wireless communication module(s) 445
Information Filtering module(s) 449
Operating mode selection component 448
Speech Processing module 454
Scanner/Camera 452
OCR Processing Engine 456
etc.

As illustrated in the example of FIG. 4 Mobile Device 400 may include a variety of components, modules and/or systems for providing various functionality. For example, as illustrated in FIG. 4, Mobile Device 400 may include Mobile Device Application components (e.g., 460), which, for example, may include, but are not limited to, one or more of the following (or combinations thereof):
UI Components 462 such as those illustrated, described, and/or referenced herein.
Database Components 464 such as those illustrated, described, and/or referenced herein.
Processing Components 466 such as those illustrated, described, and/or referenced herein.
Other Components 468 which, for example, may include components for facilitating and/or enabling the Mobile Device to perform and/or initiate various types of operations, activities, functions such as those described herein.

In at least one embodiment, the Mobile Device Application component(s) may be operable to perform and/or implement various types of functions, operations, actions, and/or other features such as, for example, one or more of those described and/or referenced herein.

According to specific embodiments, multiple instances or threads of the Mobile Device Application component(s) may be concurrently implemented and/or initiated via the use of one or more processors and/or other combinations of hardware and/or hardware and software. For example, in at least some embodiments, various aspects, features, and/or functionalities of the Mobile Device Application component(s) may be performed, implemented and/or initiated by one or more systems, components, systems, devices, procedures, processes, etc. (or combinations thereof) described and/or referenced herein.

According to different embodiments, one or more different threads or instances of the Mobile Device Application component(s) may be initiated in response to detection of one or more conditions or events satisfying one or more different types of minimum threshold criteria for triggering initiation of at least one instance of the Mobile Device Application component(s). Various examples of conditions or events which may trigger initiation and/or implementation of one or more different threads or instances of the Mobile Device Application component(s) may include, but are not limited to, one or more types of conditions and/or events described or referenced herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

According to different embodiments, Mobile Device 400 may further include, but is not limited to, one or more of the following types of components, modules and/or systems (or combinations thereof):
At least one processor 410. In at least one embodiment, the processor(s) 410 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 416, which, for example, may include volatile memory (e.g., RAM), non-volatile memory (e.g., disk memory, FLASH memory, EPROMs, etc.), unalterable memory, and/or other types of memory. In at least one implementation, the memory 416 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various MQSS techniques described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the MQSS techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 406 which, for example, may include wired interfaces and/or wireless interfaces. In at least one implementation, the interface(s) 406 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 442. In at least one implementation, the device driver(s) 442 may include functionality similar to at least a portion of functionality implemented by one or more computer system driver devices such as those described herein and/or generally known to one having ordinary skill in the art.
At least one power source (and/or power distribution source) 443. In at least one implementation, the power source may include at least one mobile power source (e.g., battery) for allowing the client system to operate in a wireless and/or mobile environment. For example, in one implementation, the power source 443 may be implemented using a rechargeable, thin-film type battery. Further, in embodiments where it is desirable for the device to be flexible, the power source 443 may be designed to be flexible.
Geolocation module 446 which, for example, may be configured or designed to acquire geolocation information from remote sources and use the acquired geolocation information to determine information relating to a relative and/or absolute position of the client system.
Motion detection component 440 for detecting motion or movement of the client system and/or for detecting motion, movement, gestures and/or other input data from user. In at least one embodiment, the motion detection component 440 may include one or more motion detection sensors such as, for example, MEMS (Micro Electro Mechanical System) accelerometers, that can detect the acceleration and/or other movements of the client system as it is moved by a user.
User Identification/Authentication module 447. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user which provides a wireless signal to the client system for determining the identity of the current user. In at least one implementation, various security features may be incorporated into the client system to prevent unauthorized users from accessing confidential or sensitive information.
One or more display(s) 435. According to various embodiments, such display(s) may be implemented using, for example, LCD display technology, OLED display technology, and/or other types of conventional display technology. In at least one implementation, display(s) 435 may be adapted to be flexible or bendable. Additionally, in at least one embodiment the information displayed on display(s) 435 may utilize e-ink technology (such as that available from E Ink Corporation, Cambridge, Mass., www.eink.com), or other suitable technology for reducing the power consumption of information displayed on the display(s) 435.
One or more user I/O Device(s) 430 such as, for example, keys, buttons, scroll wheels, cursors, touchscreen sensors, audio command interfaces, magnetic strip reader, optical scanner, etc.
Audio/Video device(s) 439 such as, for example, components for displaying audio/visual media which, for example, may include cameras, speakers, microphones, media presentation components, wireless transmitter/receiver devices for enabling wireless audio and/or visual communication between the client system 400 and remote devices (e.g., radios, telephones, computer systems, etc.). For example, in one implementation, the audio system may include componentry for enabling the client system to function as a cell phone or two-way radio device.
Other types of peripheral devices 431 which may be useful to the users of various client systems, such as, for example: PDA functionality; memory card reader(s); fingerprint reader(s); image projection device(s); social networking peripheral component(s); etc.
Information filtering module(s) 449 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 449 may also be adapted to display, in real-time, filtered information to the user based upon a variety of criteria such as that described and/or referenced herein.
Wireless communication module(s) 445. In one implementation, the wireless communication module 445 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 444 which, for example, may be used for authenticating and/or validating local hardware and/or software components, hardware/software components residing at a remote device, game play information, wager information, user information and/or identity, etc.
Operating mode selection component 448 which, for example, may be operable to automatically select an appropriate mode of operation based on various parameters and/or upon detection of specific events or conditions such as, for example: the mobile device's current location; identity of current user; user input; system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 452) which may be configured or designed for use in scanning identifiers and/or other content from other devices and/or objects such as for example: mobile device displays, computer displays, static displays (e.g., printed on tangible mediums), etc.
OCR Processing Engine (e.g., 456) which, for example, may be operable to perform image processing and optical character recognition of images such as those captured by a mobile device camera, for example.
Speech Processing module (e.g., 454) which, for example, may be operable to perform speech recognition, and may be operable to perform speech-to-text conversion.
Etc.

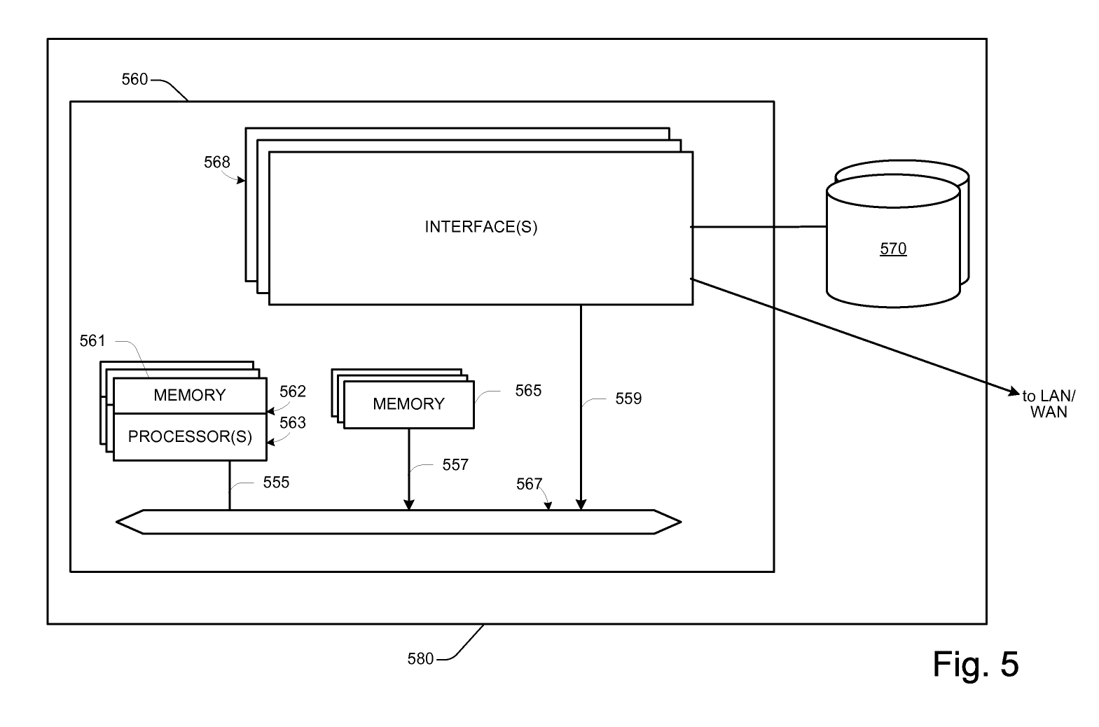

FIG. 5 illustrates an example embodiment of a server system 580 which may be used for implementing various aspects/features described herein. In at least one embodiment, the server system 580 includes at least one network device 560, and at least one storage device 570 (such as, for example, a direct attached storage device).

In one embodiment, server system 580 may be suitable for implementing at least some of the MQSS techniques described herein.

In according to one embodiment, network device 560 may include a master central processing unit (CPU) 562, interfaces 568, and a bus 567 (e.g., a PCI bus). When acting under the control of appropriate software or firmware, the CPU 562 may be responsible for implementing specific functions associated with the functions of a desired network device. For example, when configured as a server, the CPU 562 may be responsible for analyzing packets; encapsulating packets; forwarding packets to appropriate network devices; instantiating various types of virtual machines, virtual interfaces, virtual storage volumes, virtual appliances; etc. The CPU 562 preferably accomplishes at least a portion of these functions under the control of software including an operating system (e.g. Linux), and any appropriate system software (such as, for example, AppLogic™ software).

CPU 562 may include one or more processors 563 such as, for example, one or more processors from the AMD, Motorola, Intel and/or MIPS families of microprocessors. In an alternative embodiment, processor 563 may be specially designed hardware for controlling the operations of server system 580. In a specific embodiment, a memory 561 (such as non-volatile RAM and/or ROM) also forms part of CPU 562. However, there may be many different ways in which memory could be coupled to the system. Memory block 561 may be used for a variety of purposes such as, for example, caching and/or storing data, programming instructions, etc.

The interfaces 568 may be typically provided as interface cards (sometimes referred to as “line cards”). Alternatively, one or more of the interfaces 568 may be provided as on-board interface controllers built into the system motherboard. Generally, they control the sending and receiving of data packets over the network and sometimes support other peripherals used with the server system 580. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 562 to efficiently perform routing computations, network diagnostics, security functions, etc.

In at least one embodiment, some interfaces may be configured or designed to allow the server system 580 to communicate with other network devices associated with various local area network (LANs) and/or wide area networks (WANs). Other interfaces may be configured or designed to allow network device 560 to communicate with one or more direct attached storage device(s) 570.

Although the system shown in FIG. 5 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 565, which, for example, may include random access memory (RAM)) configured to store data, program instructions for the general-purpose network operations and/or other information relating to the functionality of the various MQSS techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

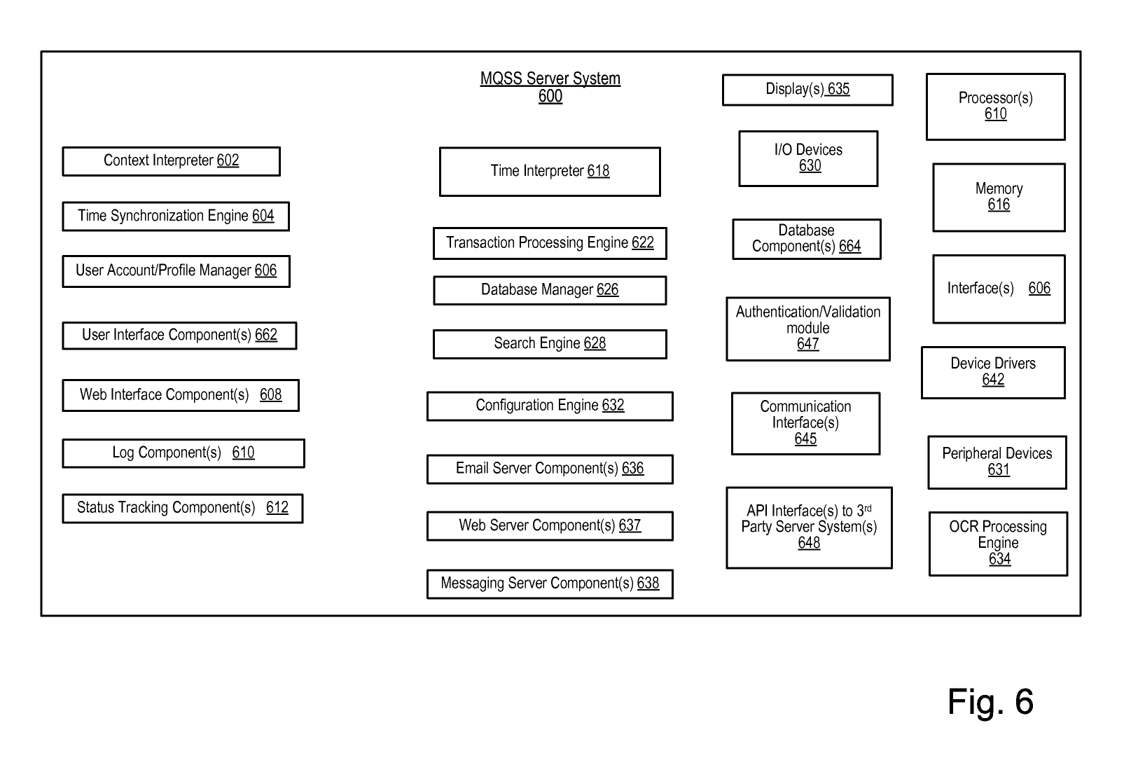

FIG. 6 illustrates an example of a functional block diagram of a MQSS Server System in accordance with a specific embodiment. In at least one embodiment, the MQSS Server System may be operable to perform and/or implement various types of functions, operations, actions, and/or other features such as, for example, one or more of those described and/or referenced herein.

In at least one embodiment, the MQSS Server System may include a plurality of components operable to perform and/or implement various types of functions, operations, actions, and/or other features such as, for example, one or more of the following (or combinations thereof):
Transaction Processing Engine (e.g., 622) which, for example, may be operable to handle various types of transaction processing tasks such as, for example, one or more of the following (or combinations thereof):
   identifying/determining transaction type
   determining which payment gateway(s) to use
   associating databases information to identifiers
   etc.
OCR Processing Engine (e.g., 634) which, for example, may be operable to perform image processing and optical character recognition of images such as those captured by a mobile device camera, for example.
Database Manager (e.g., 626) which, for example, may be operable to handle various types of tasks relating to database updating, database management, database access, etc. In at least one embodiment, the Database Manager may be operable to manage TISS databases, MQSS Device Application databases, etc.
Log Component(s) (e.g., 610) which, for example, may be operable to generate and manage transactions history logs, system errors, connections from APIs, etc.
Status Tracking Component(s) (e.g., 612) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 614) which, for example, may be operable to facilitate and manage communications and transactions with external Payment Gateways.
Web Interface Component(s) (e.g., 608) which, for example, may be operable to facilitate and manage communications and transactions with TIS web portal(s).
API Interface(s) to MQSS Server System(s) (e.g., 646) which, for example, may be operable to facilitate and manage communications and transactions with API Interface(s) to MQSS Server System(s)
API Interface(s) to 3rd Party Server System(s) (e.g., 648) which, for example, may be operable to facilitate and manage communications and transactions with API Interface(s) to 3rd Party Server System(s)
OCR Processing Engine (e.g., 634) which, for example, may be operable to perform image processing and optical character recognition of images such as those captured by a mobile device camera, for example.
At least one processor 610. In at least one embodiment, the processor(s) 610 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 616, which, for example, may include volatile memory (e.g., RAM), non-volatile memory (e.g., disk memory, FLASH memory, EPROMs, etc.), unalterable memory, and/or other types of memory. In at least one implementation, the memory 616 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the MQSS System techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 606 which, for example, may include wired interfaces and/or wireless interfaces. In at least one implementation, the interface(s) 606 may include functionality similar to at least a portion of functionality implemented by one or more computer system interfaces such as those described herein and/or generally known to one having ordinary skill in the art.
Device driver(s) 642. In at least one implementation, the device driver(s) 642 may include functionality similar to at least a portion of functionality implemented by one or more computer system driver devices such as those described herein and/or generally known to one having ordinary skill in the art.
One or more display(s) 635. According to various embodiments, such display(s) may be implemented using, for example, LCD display technology, OLED display technology, and/or other types of conventional display technology. In at least one implementation, display(s) 635 may be adapted to be flexible or bendable. Additionally, in at least one embodiment the information displayed on display(s) 635 may utilize e-ink technology (such as that available from E Ink Corporation, Cambridge, Mass., www.eink.com), or other suitable technology for reducing the power consumption of information displayed on the display(s) 635.
Email Server Component(s) 636, which, for example, may be configured or designed to provide various functions and operations relating to email activities and communications.
Web Server Component(s) 637, which, for example, may be configured or designed to provide various functions and operations relating to web server activities and communications.
Messaging Server Component(s) 638, which, for example, may be configured or designed to provide various functions and operations relating to text messaging and/or other social network messaging activities and/or communications.
Context Interpreter (e.g., 602) which, for example, may be operable to automatically and/or dynamically analyze contextual criteria relating to a given transaction, and automatically determine or identify the type of transaction to be performed (e.g., payment-related transaction, identification-related transaction, universal shopping cart-related transaction, etc.). According to different embodiments, examples of contextual criteria which may be analyzed may include, but are not limited to, one or more of the following (or combinations thereof):
   location-based criteria (e.g., geolocation of client device, geolocation of agent device, etc.)
   time-based criteria
   identity of Client user
   identity of Agent user
   user profile information
   transaction history information
   recent user activities
   proximate business-related criteria (e.g., criteria which may be used to determine whether the client device is currently located at or near a recognized business establishment such as a bank, gas station, restaurant, supermarket, etc.)
   etc.
Time Synchronization Engine (e.g., 604) which, for example, may be operable to manages universal time synchronization (e.g., via NTP and/or GPS)
Search Engine (e.g., 628) which, for example, may be operable to search for transactions, logs, items, accounts, options in the MQSS databases
Configuration Engine (e.g., 632) which, for example, may be operable to determine and handle configuration of various customized configuration parameters for one or more devices, component(s), system(s), process(es), etc.
Time Interpreter (e.g., 618) which, for example, may be operable to automatically and/or dynamically modify or change identifier activation and expiration time(s) based on various criteria such as, for example, time, location, transaction status, etc.
Authentication/Validation Component(s) (e.g., 647). In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning the user's biometric information (e.g., fingerprints, face, voice, eye/iris, etc.). In at least one implementation, various security features may be incorporated into the mobile client system to prevent unauthorized users from accessing confidential or sensitive information. In at least one embodiment, the Authentication/Validation Component(s) may be operable to perform various types of authentication/validation tasks such as, for example, one or more of the following (or combinations thereof):
   verifying/authenticating devices,
   verifying passwords, passcodes, SSL certificates, biometric identification information, and/or other types of security-related information
   verify/validate activation and/or expiration times
   etc.
Etc.

In at least one embodiment, the MQSS Server System may include functionality for enabling, managing, enforcing, validating and/or facilitating promotional activities and/or transactions such as, for example, one or more of the following (or combinations thereof):
Supplier-related promotions
Retailer-related promotions
Artist-related promotions
MQSS System-related promotions

According to different embodiments, examples of various types of promotions may include, but are not limited to, one or more of the following (or combinations thereof):
Price-related promotions
Shipping-related promotions
Give-away Promotions (e.g., Free stuff)
Time-related promotions
Location-related promotions
Event-related promotions
Etc.

### Example Procedures and Flow Diagrams

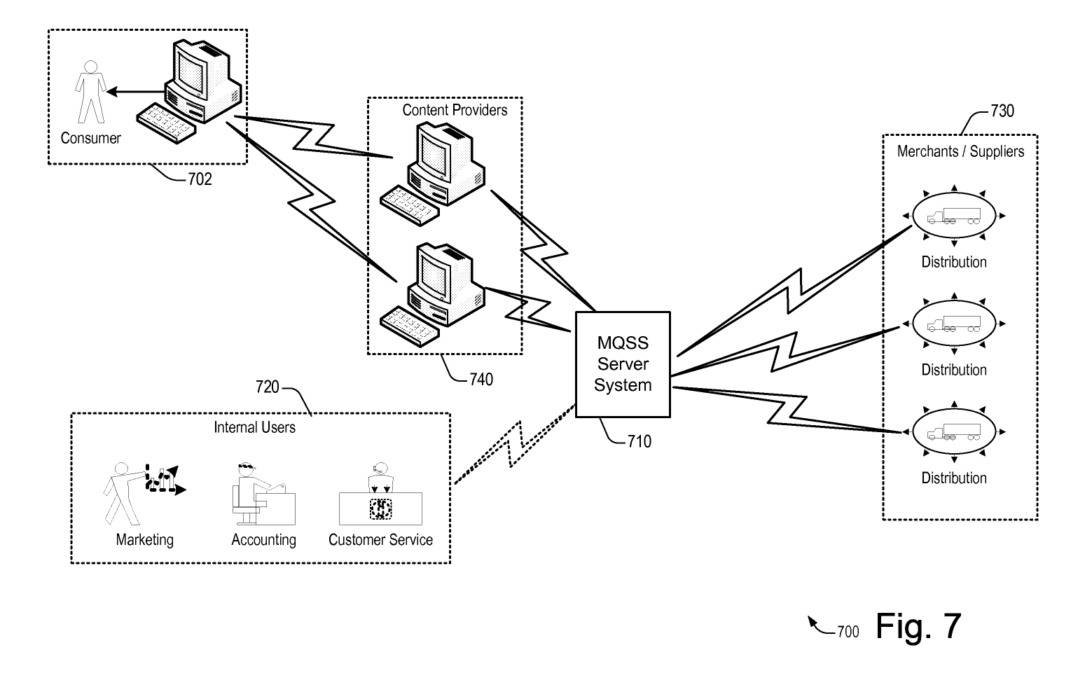

FIGS. 7-13 illustrate various example embodiments of different MQSS procedures and/or procedural flows which may be used for facilitating activities relating to one or more of the MQSS aspects disclosed herein.

According to different embodiments, at least a portion of the various types of functions, operations, actions, and/or other features provided by the MQSS Procedures of FIGS. 7-13 may be implemented at one or more client systems(s), at one or more server systems (s), and/or combinations thereof.

In at least one embodiment, one or more of the MQSS procedures may be operable to utilize and/or generate various different types of data and/or other types of information when performing specific tasks and/or operations. This may include, for example, input data/information and/or output data/information. For example, in at least one embodiment, the MQSS procedures may be operable to access, process, and/or otherwise utilize information from one or more different types of sources, such as, for example, one or more local and/or remote memories, devices and/or systems. Additionally, in at least one embodiment, the MQSS procedures may be operable to generate one or more different types of output data/information, which, for example, may be stored in memory of one or more local and/or remote devices and/or systems. Examples of different types of input data/information and/or output data/information which may be accessed and/or utilized by the MQSS procedures may include, but are not limited to, one or more of those described and/or referenced herein.

In at least one embodiment, a given instance of the MQSS procedures may access and/or utilize information from one or more associated databases. In at least one embodiment, at least a portion of the database information may be accessed via communication with one or more local and/or remote memory devices. Examples of different types of data which may be accessed by the MQSS procedures may include, but are not limited to, one or more of those described and/or referenced herein.

According to specific embodiments, multiple instances or threads of the MQSS procedures may be concurrently implemented and/or initiated via the use of one or more processors and/or other combinations of hardware and/or hardware and software. For example, in at least some embodiments, various aspects, features, and/or functionalities of the MQSS procedures may be performed, implemented and/or initiated by one or more of the various systems, components, systems, devices, procedures, processes, etc., described and/or referenced herein.

According to different embodiments, one or more different threads or instances of the MQSS procedures may be initiated in response to detection of one or more conditions or events satisfying one or more different types of minimum threshold criteria for triggering initiation of at least one instance of the MQSS procedures. Various examples of conditions or events which may trigger initiation and/or implementation of one or more different threads or instances of the MQSS procedures may include, but are not limited to, one or more of those described and/or referenced herein.

According to different embodiments, one or more different threads or instances of the MQSS procedures may be initiated and/or implemented manually, automatically, statically, dynamically, concurrently, and/or combinations thereof. Additionally, different instances and/or embodiments of the MQSS procedures may be initiated at one or more different time intervals (e.g., during a specific time interval, at regular periodic intervals, at irregular periodic intervals, upon demand, etc.).

In at least one embodiment, initial configuration of a given instance of the MQSS procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the MQSS procedures may correspond to and/or may be derived from the input data/information.

According to different embodiments, various components of the MQSS system may be built using Microsoft™ technologies and interfacing with Magento™ which is written in PHP. Adobe Flash, HTML5 and/or JavaScript™ may be used for various aspects relating to consumer interaction.

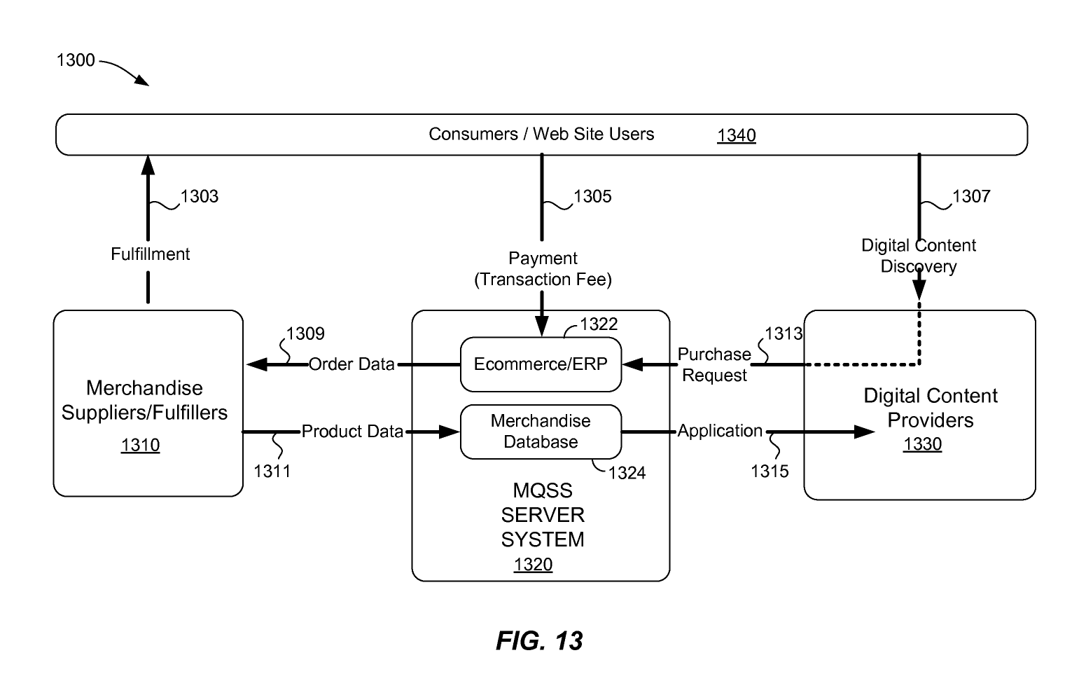

FIG. 13 illustrates a high level overview of an MQSS System Interaction flow 1300 in accordance with a specific embodiment. As described in greater detail herein, the MQSS System Interaction flow(s) may include various data flows and interactions between various systems, devices, components, and/or processes of the MQSS network, which may be utilized for implementing various aspects described herein.

FIG. 7 shows a block diagram representing an example overview of different aspects and entities of the MQSS System, in accordance with a specific embodiment. As illustrated in the example embodiment of FIG. 7, consumers (or users) 702 may access (e.g., via their client computer systems) websites of content providers 740. At least a portion of the content providers may include Internet radio websites and/or media streaming websites such as, for example, music streaming websites (e.g., Pandora.com, Grooveshark.com, LastFM.com, etc.) and/or video streaming websites (e.g., youtube.com, vimeo.com, etc.).

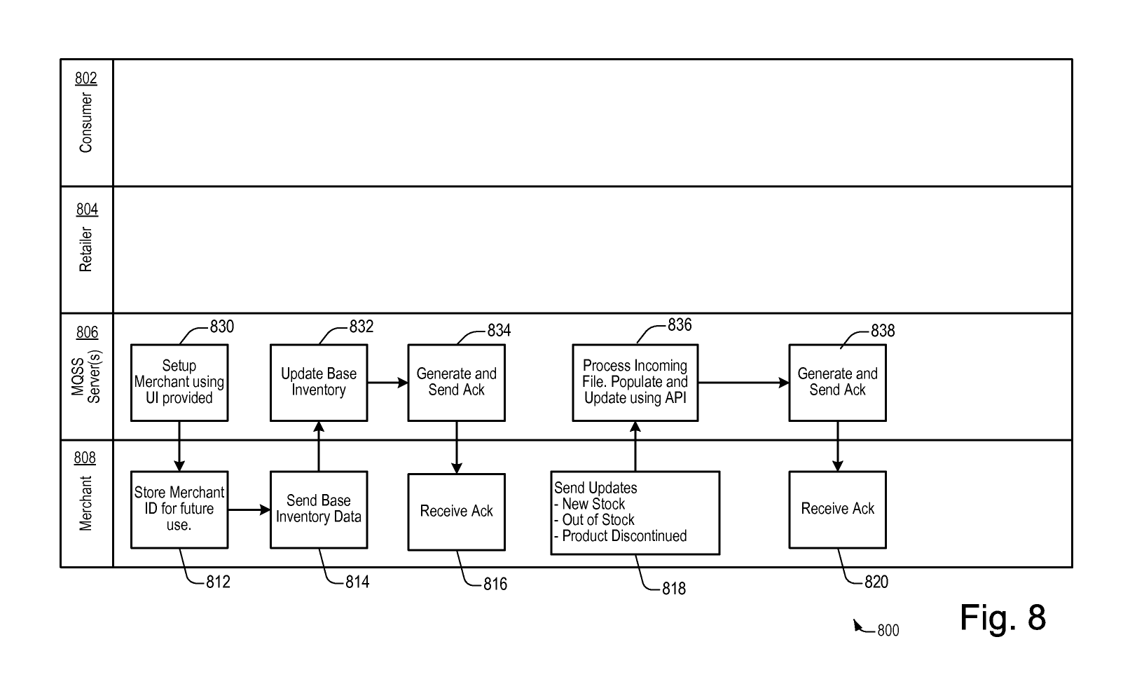

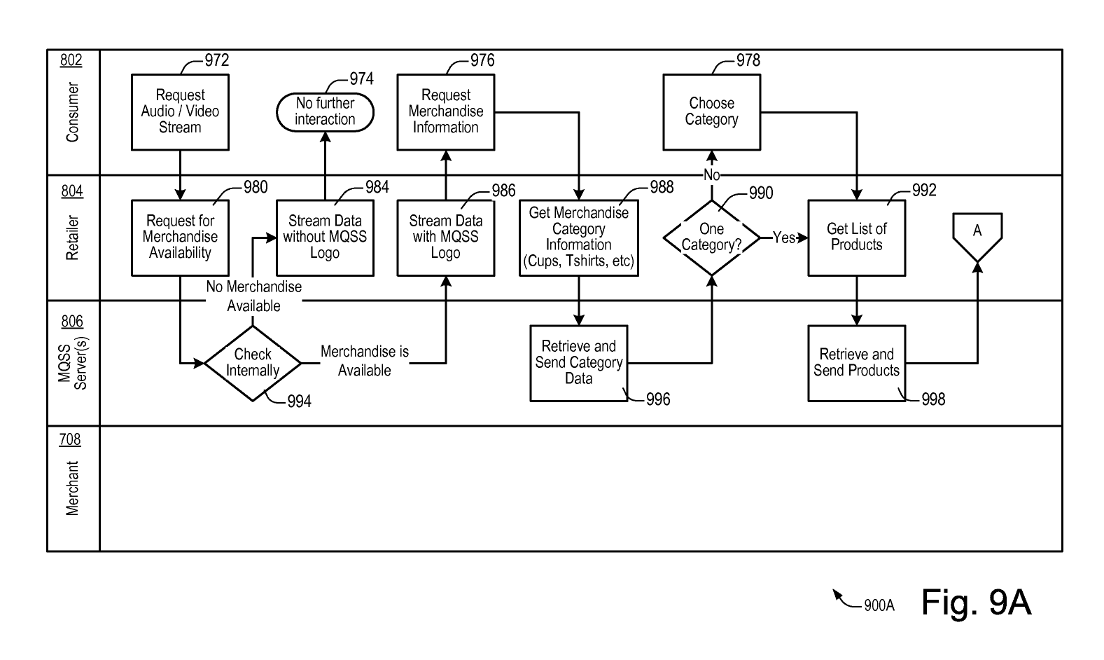

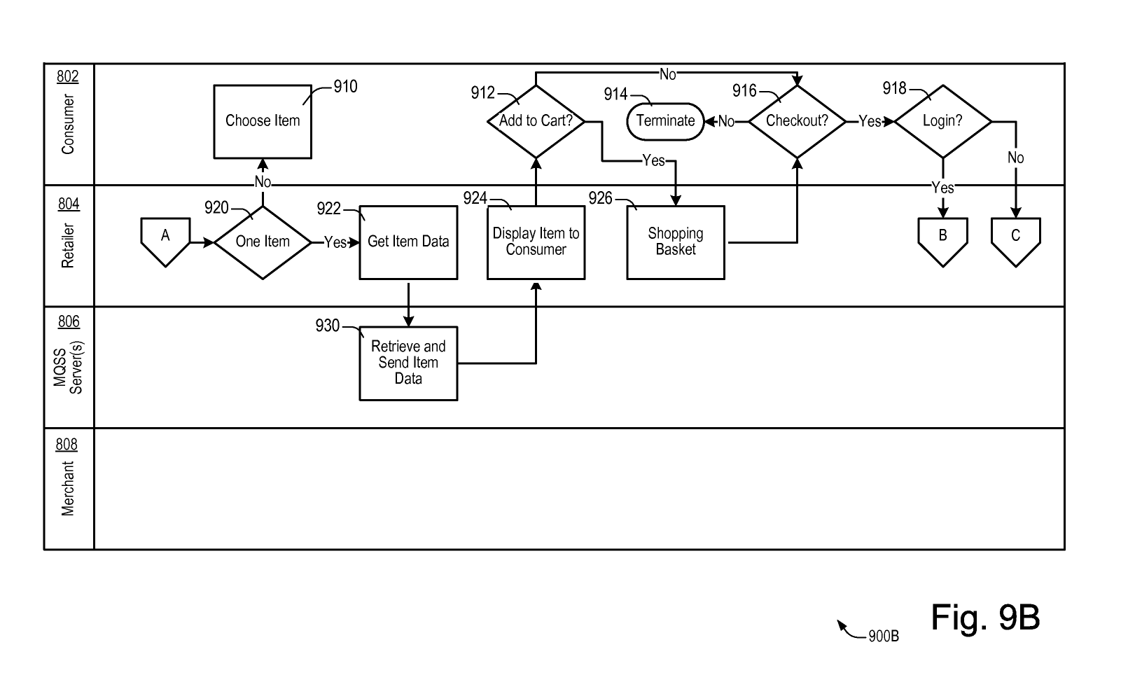

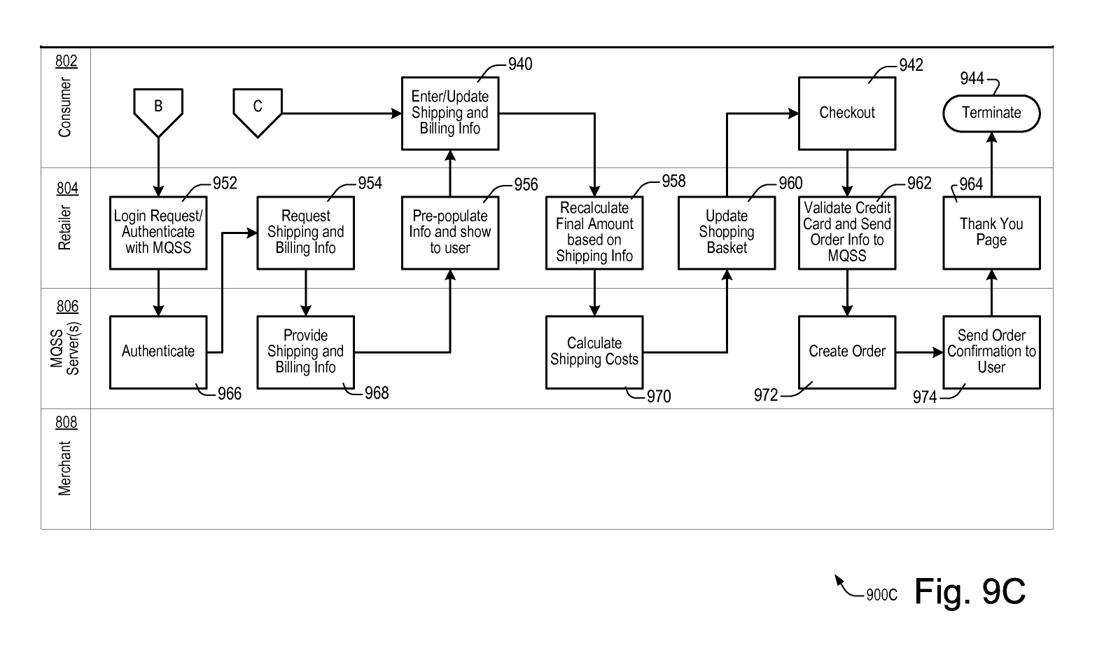

FIGS. 8, 9A-C, and 10 illustrate various example embodiments of flow diagrams relating to MQSS inventory setup, consumer interaction, and fulfillment.

FIG. 8 illustrates an example embodiment of a flow diagram relating to MQSS inventory management. In at least one embodiment, the MQSS Server System may include inventory management functionality, and may be operable to manage and maintain information on what products are available for which artists/songs/albums. It may also be responsible for updates as and when new inventory arrives. In at least one embodiment, the MQSS Server System may be configured or designed to automatically and/or dynamically remove any product(s) from being displayed (e.g., to the user) upon detecting a lack of availability of such product(s).

In at least one embodiment, MQSS inventory management procedure may include various actions involving the merchant and/or MQSS Server System such as, for example, one or more of the following (or combinations thereof):
Merchant Setup
Process Incoming Base Inventory File
Process Incoming Updates—In at least one embodiment, the processing of incoming inventory updates (e.g., 818) may be implemented as a Web Service that the Merchant may call with any updates to inventory such as, for example:
   New Stock—may include final existing quantity in inventory for the MQSS Server System to sync
   Out of Stock—this may trigger the MQSS Server System to stop taking orders
   Product Discontinues—this may trigger the MQSS Server System to remove the product from the MQSS Server System active catalog

FIGS. 9A, 9B, and 9C illustrate various example embodiments of flow diagrams relating to MQSS consumer interaction. In at least one embodiment, MQSS consumer interaction procedure(s) may include various actions involving the consumer, merchant, and/or MQSS Server System such as, for example, one or more of the following (or combinations thereof):

Check Internally—is Merchandise Available?

This process may be hit/accessed hundreds of thousands of times within minutes, and the information provided, in terms of the artist, album, song, to query the database may not be consistent and may be varied. Accordingly, the MQSS Server System may be configured or designed to:
Cache the merchandise records to be able to quickly respond to the is merchandise available requests
Create a self learning algorithm to improve the success of the response
Map information between content distributors and the MQSS System
This component may be called by the content delivery site via the http protocol. The Web Service may return a unique ID that represents that artist, song, album combination or 0 if no merchandise is available for the combination or any one element within the combined lot. This ID may help reduce the processing time in further queries.

User Interface Application

A User Interface application may be written in HTML5 and/or Flash. This application may be provided to content distributors to launch on their site or may be remotely called from their site as well.

The application may navigate the user through the merchandise and enable the user(s) to place the merchandise in their shopping basket(s). The user may also be able to edit the shopping basket and check out. The check out process may be relatively simple at this point and allow only one ship to address with only one ship method and immediate shipments. In addition, the credit card page and thank you page may also be provided in the application.

Send Information on Categories

When the consumer clicks on the “Browse for Merchandise” button, on a content distributor's site, the site may load the MQSS User Interface Application. In at least one embodiment, the MQSS User Interface Application may communicate via Web Service calls to new code written by the MQSS Server System which may interface with the MQSS Database to retrieve the data and provide it back to the MQSS User Interface Application. The data returned may amongst other things include URLs from which images may be downloaded.

Send Information on Products

This Service may send information on products within a category of merchandise.

Send Information on Item

This Service may send information on a specific item/product including price and attribute options like size, color, etc.

Login and Authentication

To provide a consistent view through different sites there may be a unique login account created at the MQSS Server System. The consumer may shop at different sites and maintain their MQSS System credentials across one or more sites. Thus the checkout process may be simple and quick irrespective of where the consumer is shopping.

The shipping and billing information may be pre-populated if the consumer chooses to login and use their registered account. The MQSS Server System may be configured or designed to provide a means of creating an account, via the MQSS User Interface Application, in case the user does not have an existing account. One or more types of account information may be stored in the MQSS Database but accessed via Web Service calls created by the MQSS Server System.

Compute Shipping Costs

Based on final shipping address as well as the number of different Merchants, e.g., the number of packages being shipped, the MQSS Server System may be configured or designed to compute the shipping costs. These costs may then be computed and sent back to be verified by the user and enable the user to complete the transaction. The MQSS Server System may communicate directly with UPS and/or FedEx to get real time live quotations for shipments.

Create Order

Once a credit card has been processed, based on the contents in the shopping basket, the MQSS Server System may create an order in the MQSS Database. This may be new code written to wrap the MQSS Database API or directly insert into the MQSS Database.

Send Order Confirmation

Once an order has been placed an order confirmation may be sent to the user. The order confirmation may be branded and customized to the content distributor's requirements.

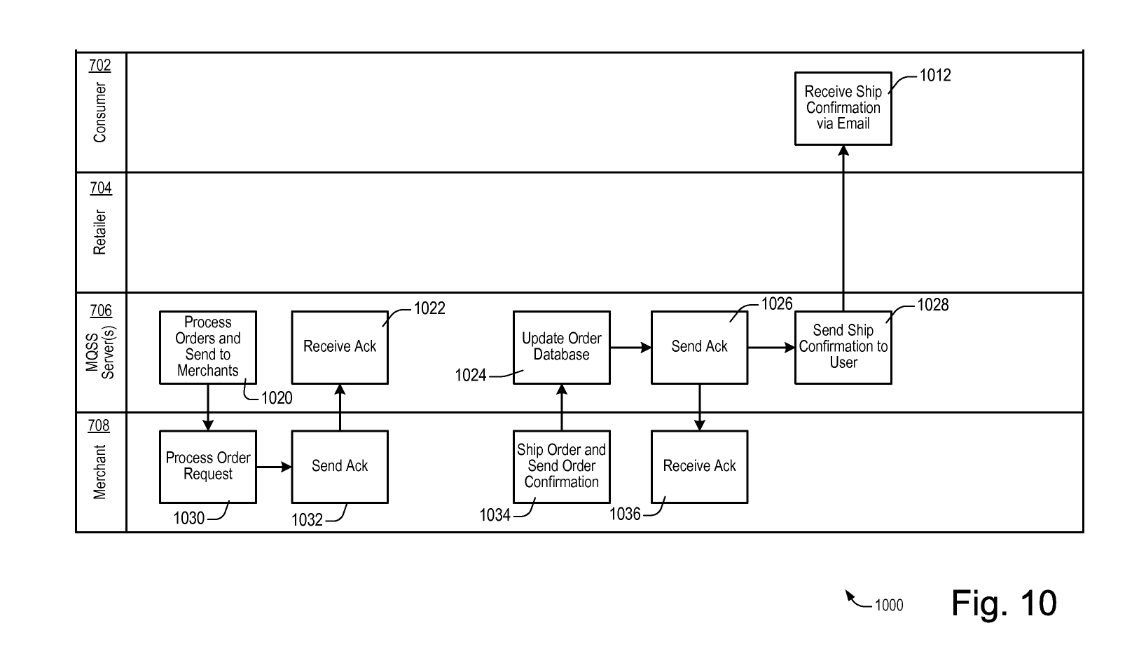

FIG. 10 illustrates an example embodiment of a flow diagram relating to MQSS fulfillment. In at least one embodiment, this process may interface with the merchandiser's fulfillment warehouse and co-ordinates shipment of product and tracks completion of the order. In at least one embodiment, MQSS fulfillment procedure may include various actions involving the fulfiller/supplier and/or MQSS Server System such as, for example, one or more of the following (or combinations thereof):

Process Orders And Send to Merchant

Individual orders may be processed by the MQSS Server System and split/sorted by Merchant. Individual Merchant orders may be configured or designed to be aggregated and a combined order file may be sent to the associated Merchant. According to different embodiments, the order file may be in a predefined XML structure and the file may be sent to the Merchant via one or more communication protocols including, for example, http, ftp, smtp, etc. In at least one alternate embodiment, standardized EDI transaction sets may be used for order communication and acknowledgement. In one embodiment, the order data may be stored in the MQSS Database, however, the MQSS Server System services may access that data and process the information and send it to the Merchants.

Process Order Acknowledgement

In at least one embodiment, the Merchant may acknowledge the order file and the MQSS Server System may process the acknowledgement.

Update Order Ship Database And Confirm

Once products have been shipped the Merchant may inform the MQSS Server System that the order has been fulfilled and provide the MQSS Server System with the tracking information. The MQSS Server System may update the MQSS Server System records and acknowledge receipt of the updates to the Merchants as well as inform the customer of the shipment of the products. According to different embodiments, the ship confirmation may be branded and customized to the content distributor's requirements.

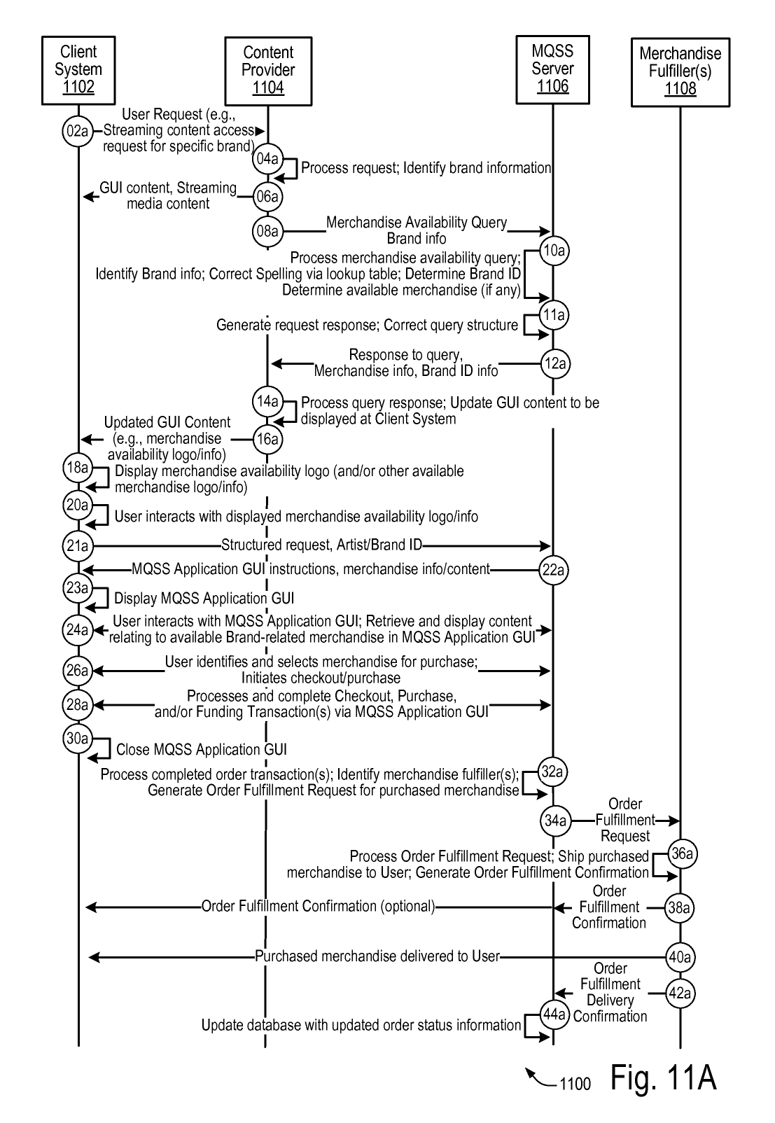

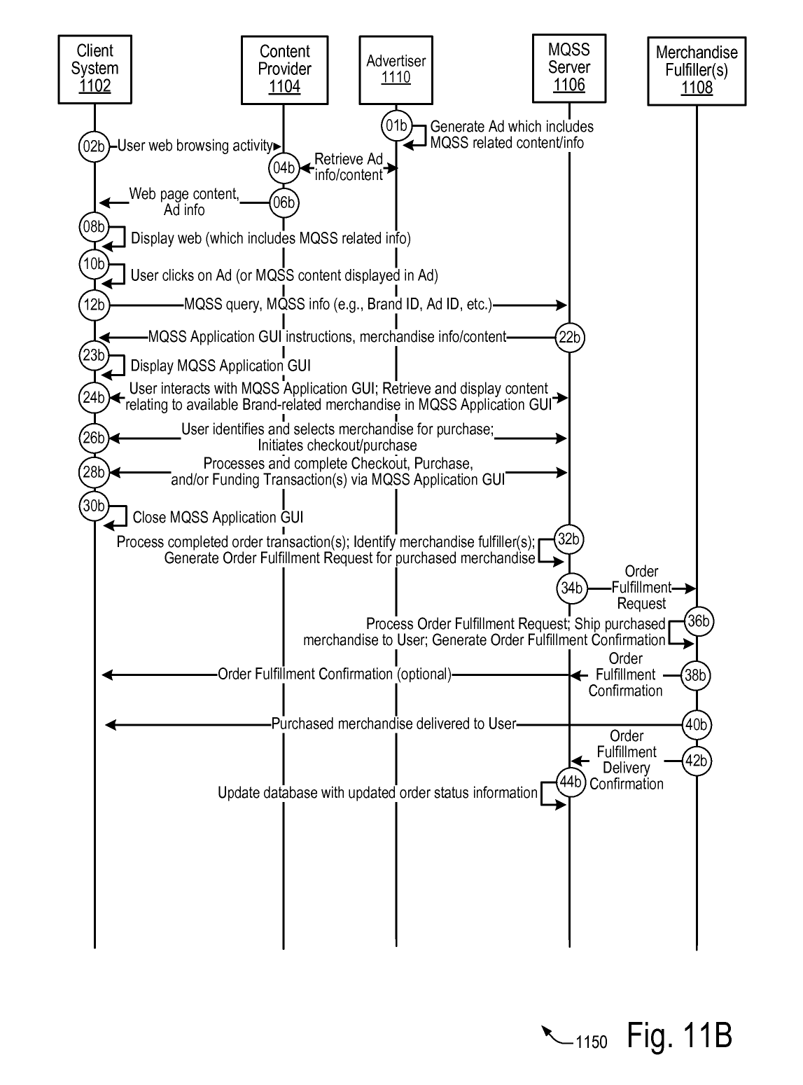

FIG. 11A shows a specific example embodiment of an MQSS Interaction Diagram, illustrating various data flows and interactions between various systems/devices of the MQSS network, which may be utilized for implementing various aspects described herein. In at least one embodiment, the interaction diagram of FIG. 11A illustrates one example embodiment of how a user/client/purchaser may utilize the hardware/software components disclosed herein to initiate and/or perform a variety of different types of operations and/or activities such as those described herein.

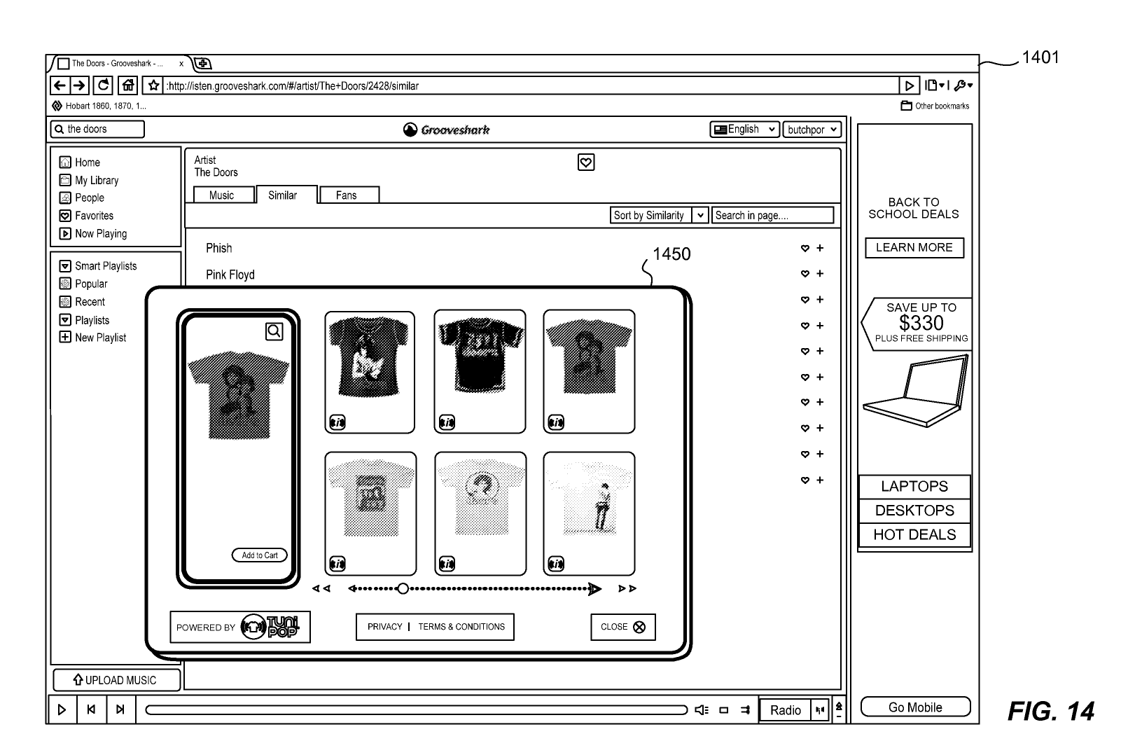

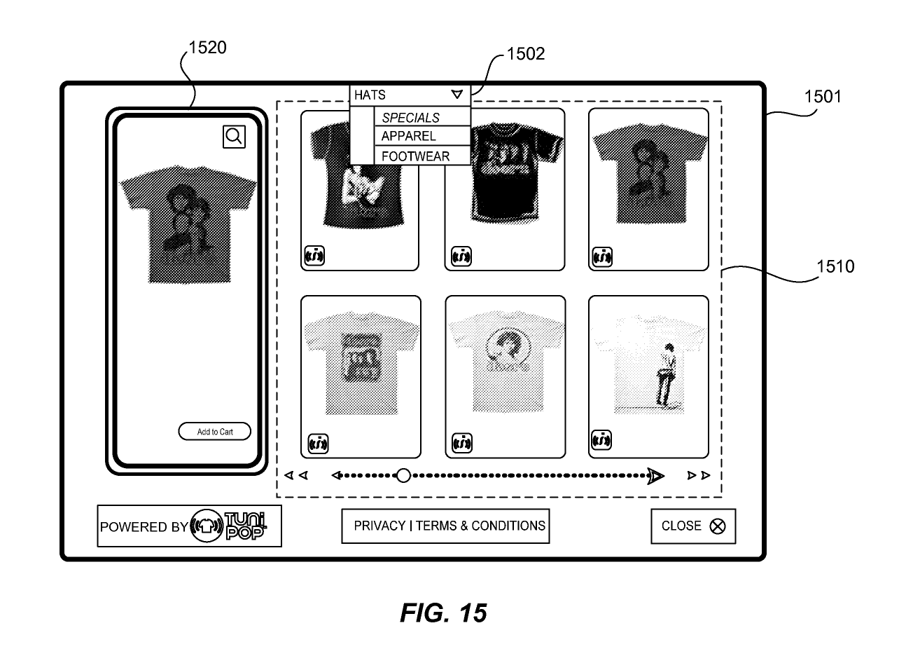

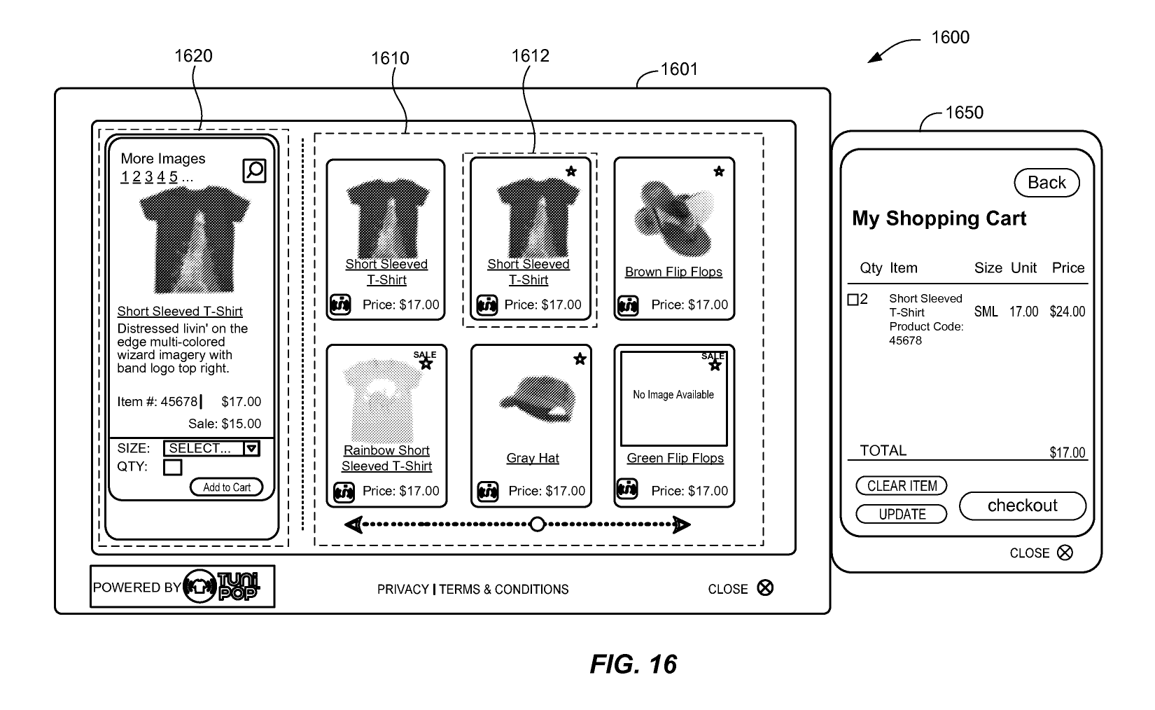

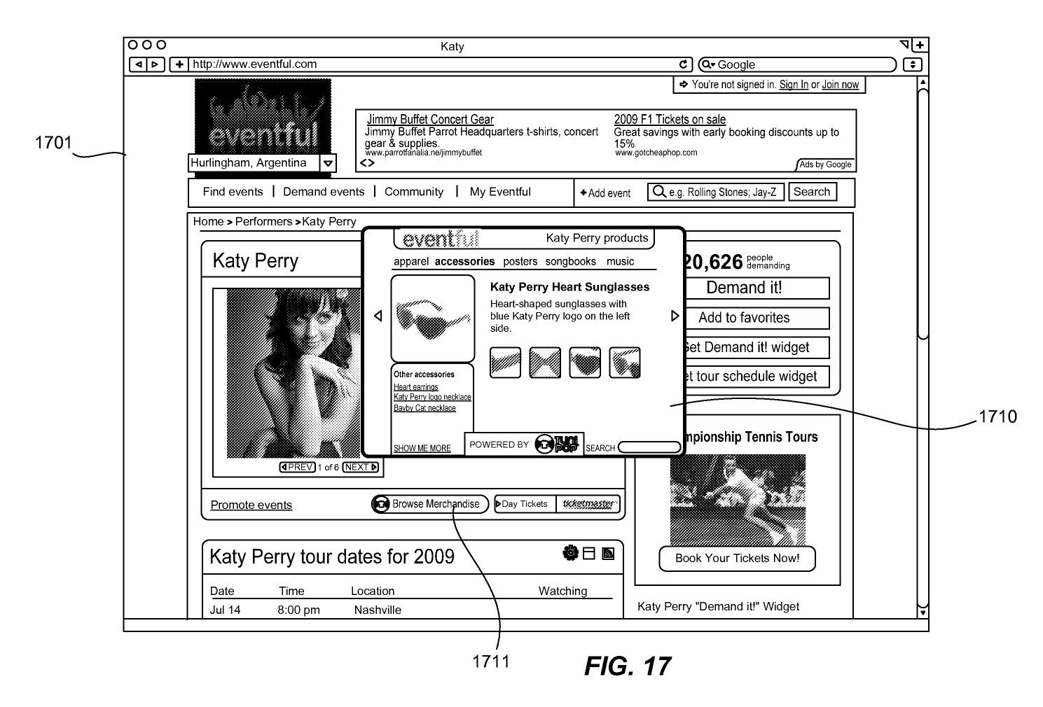

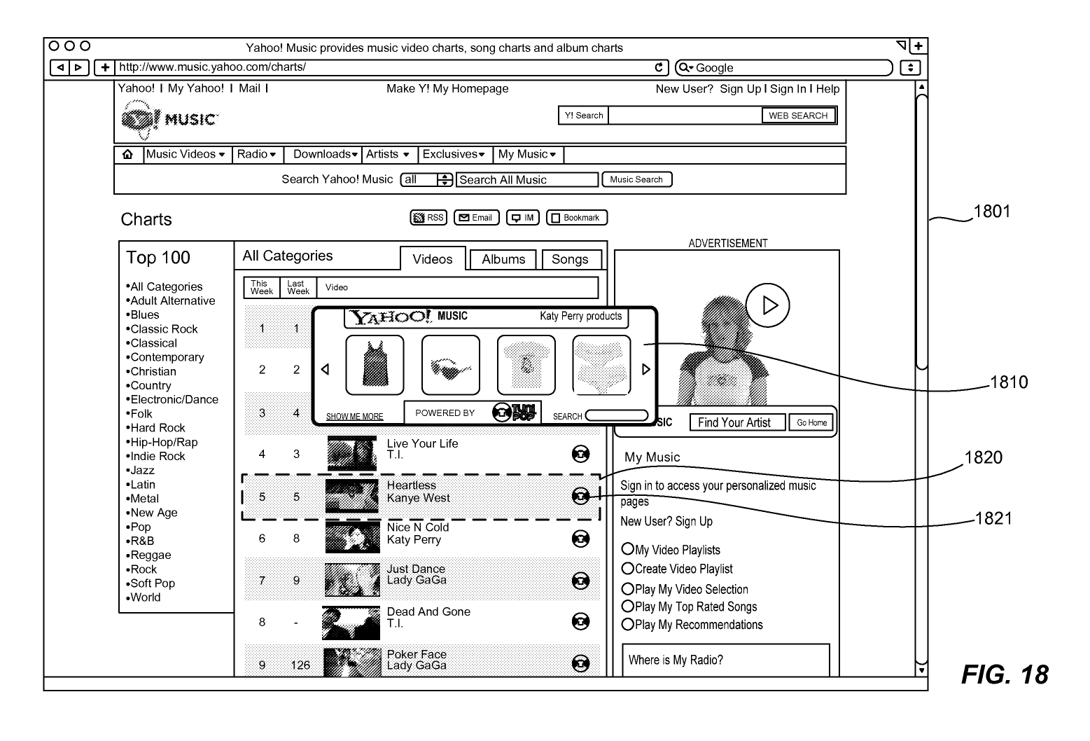

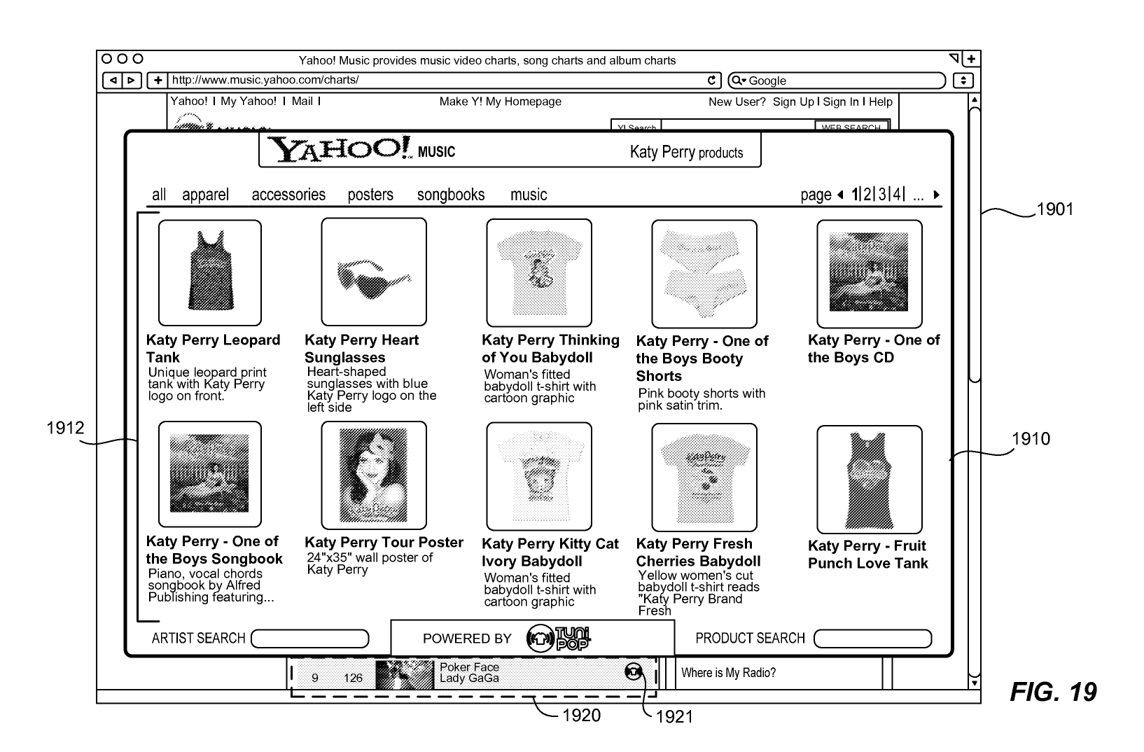

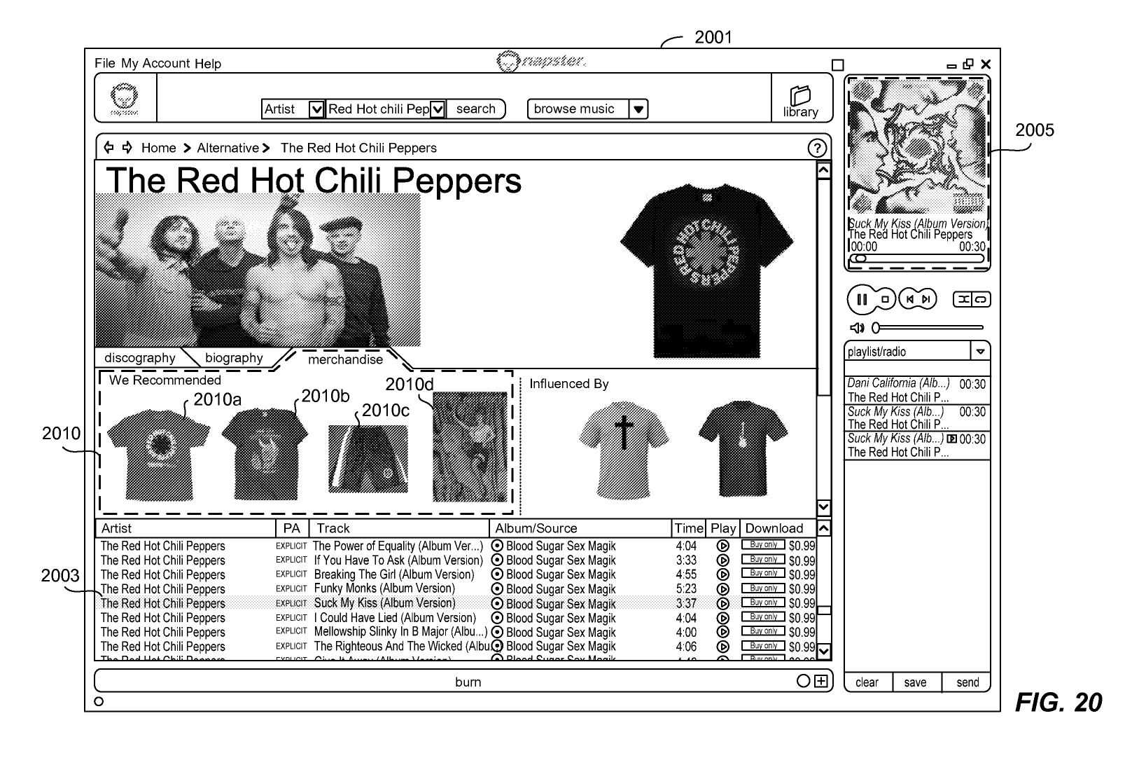

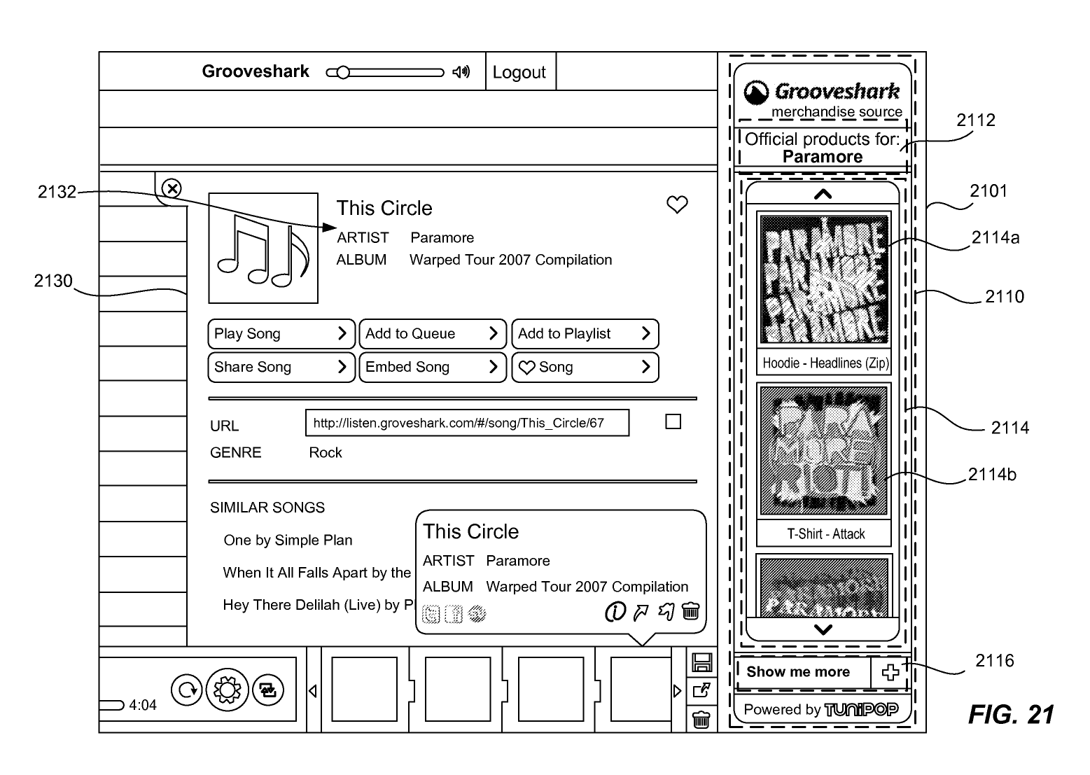

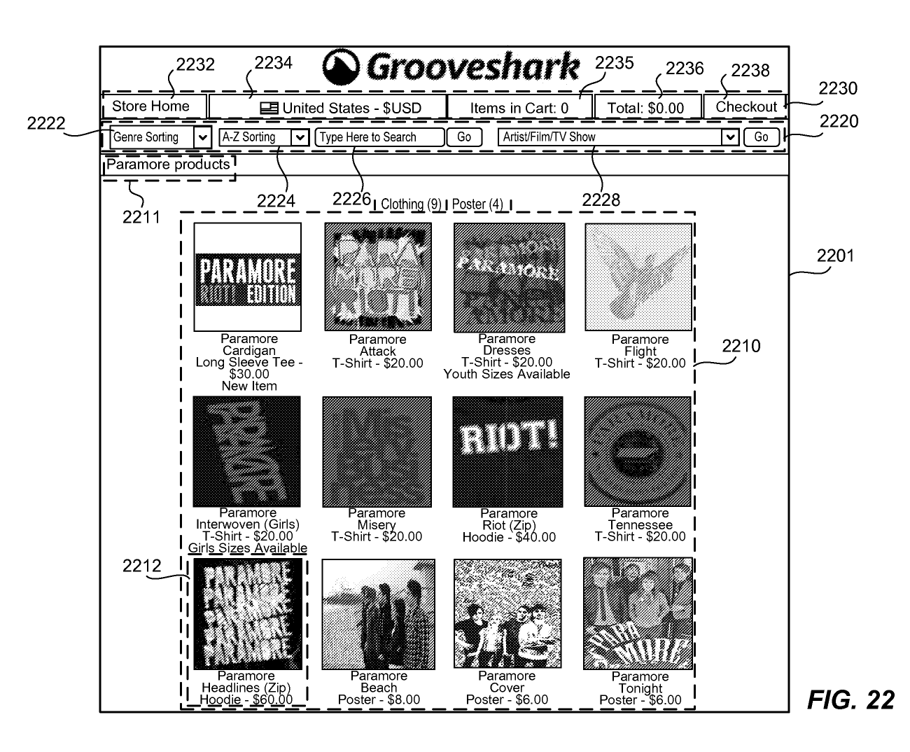

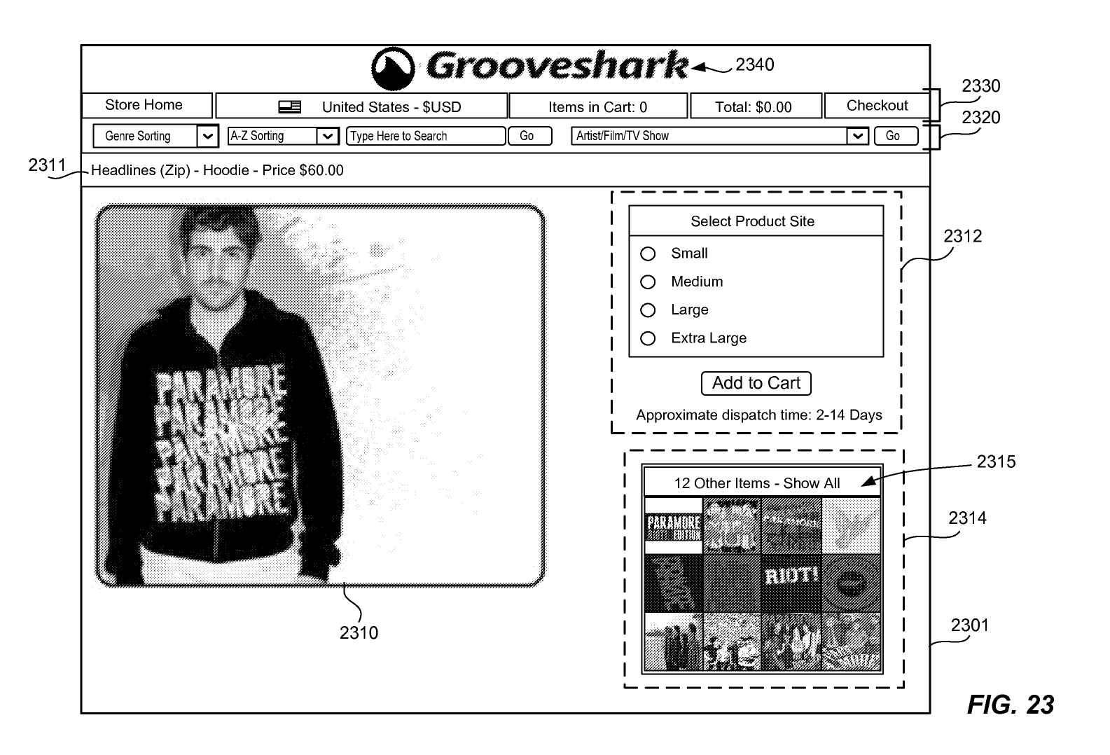

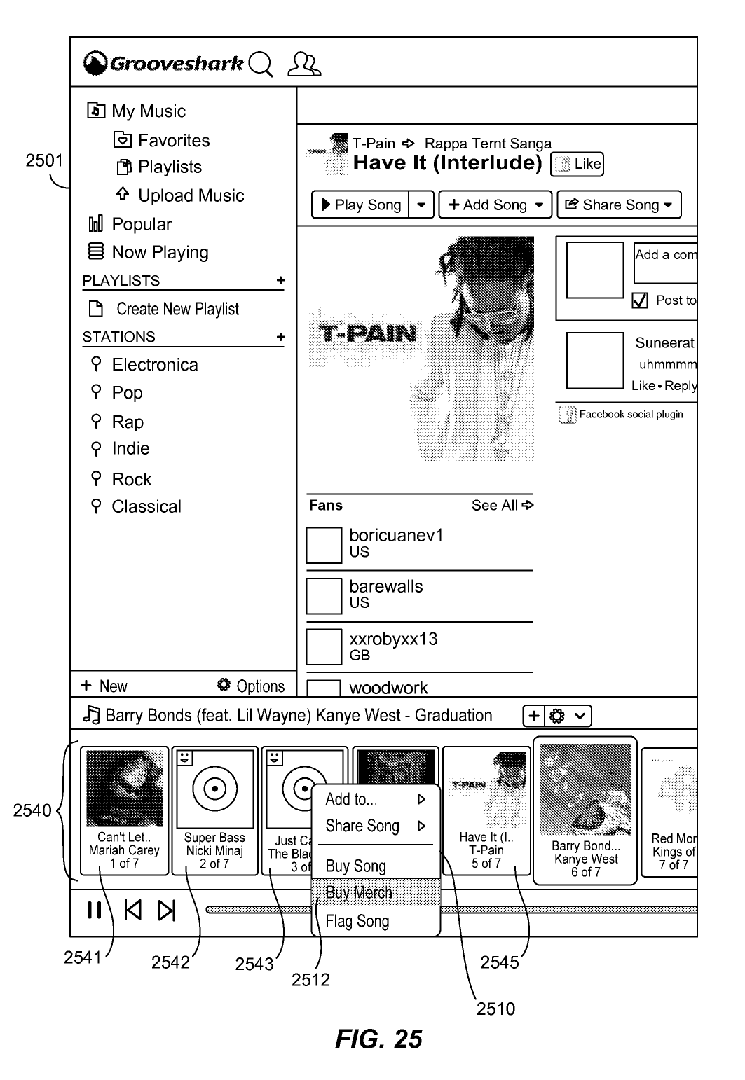

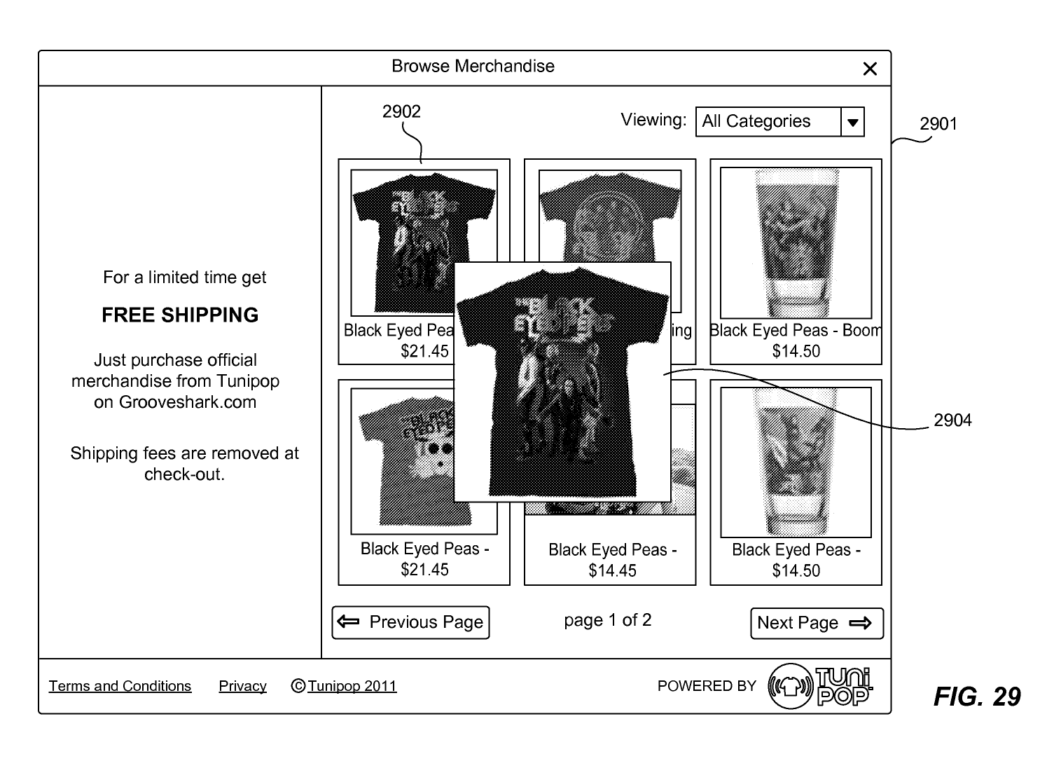

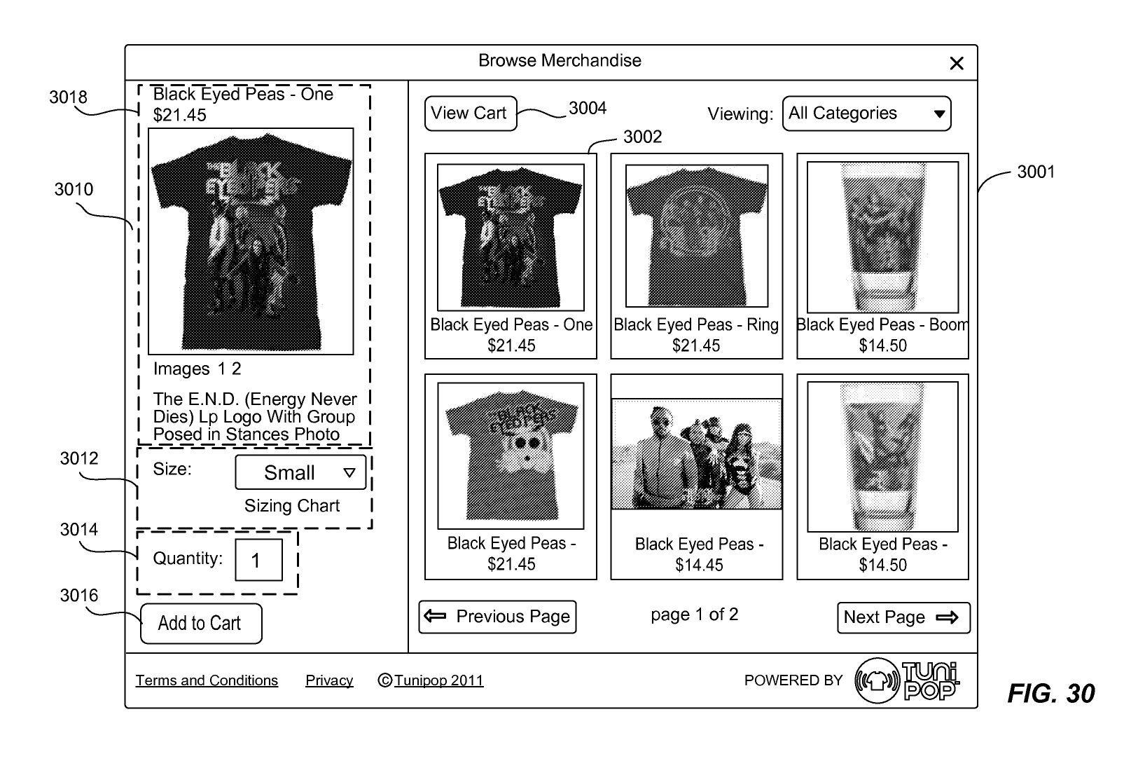

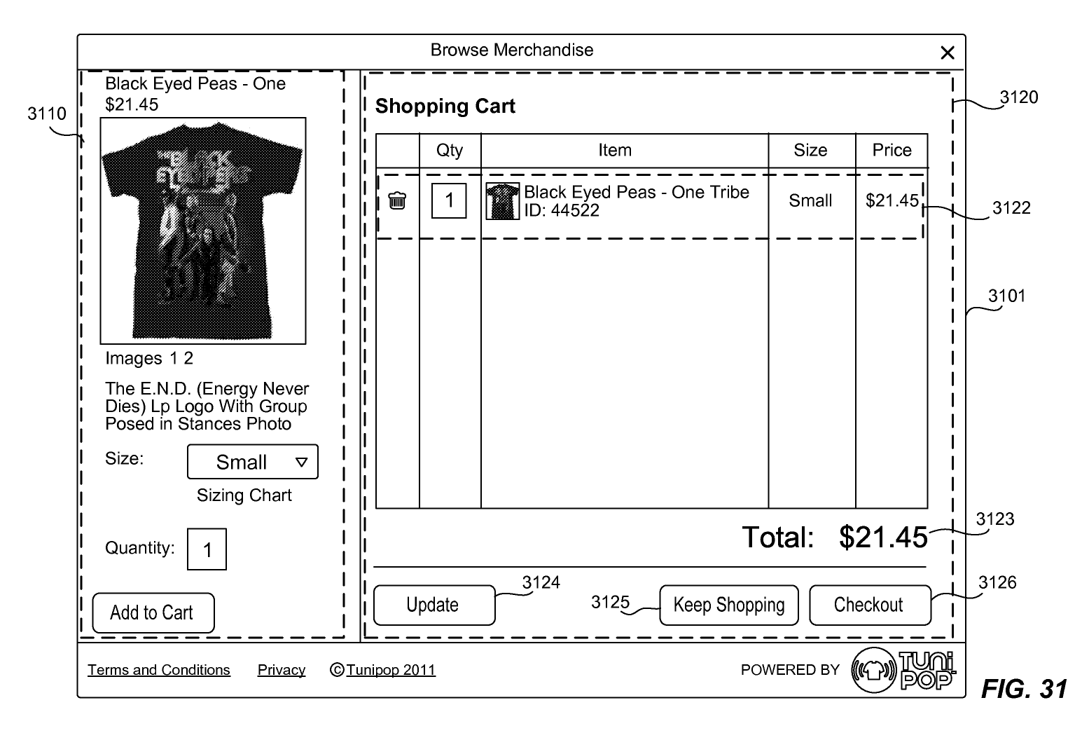

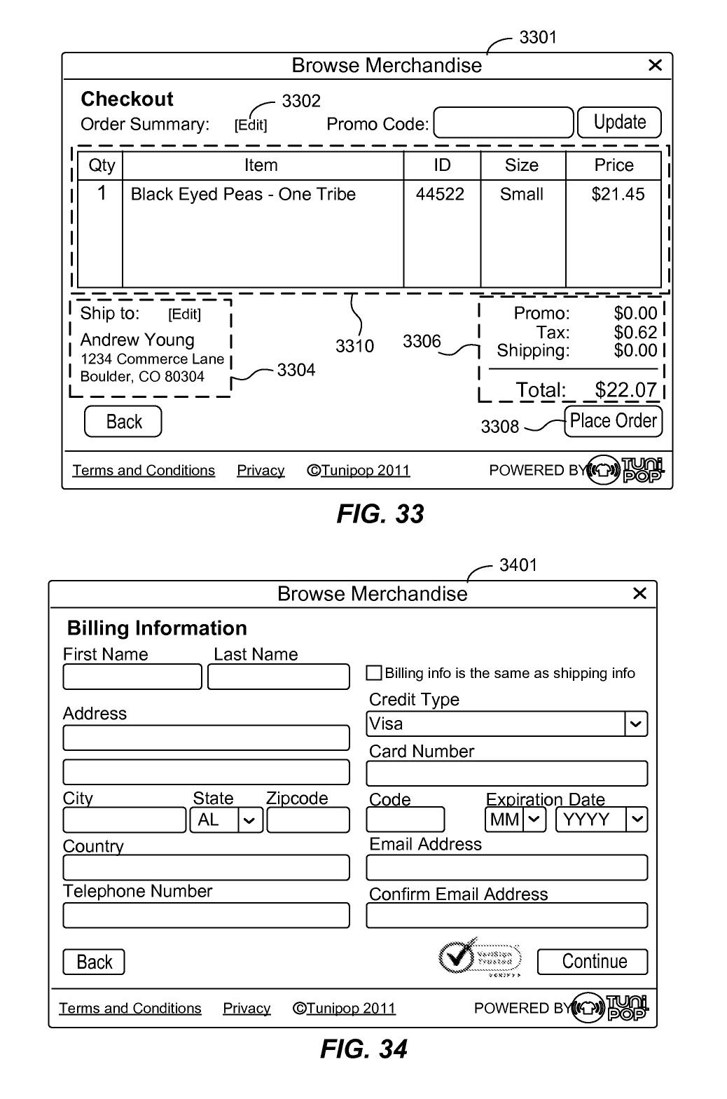

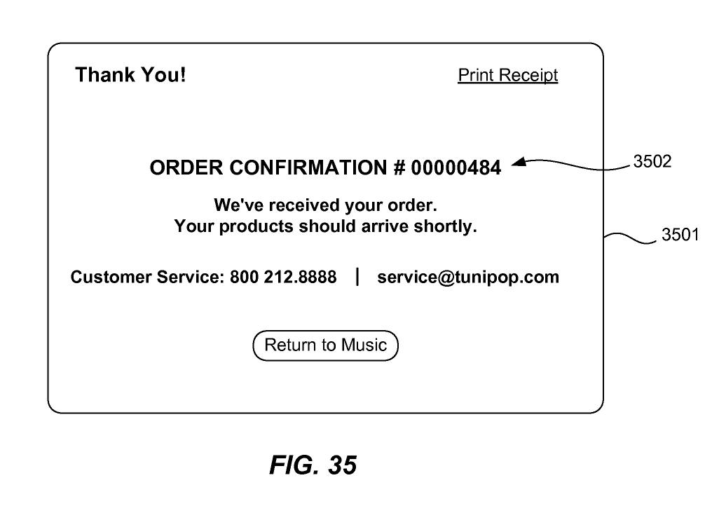

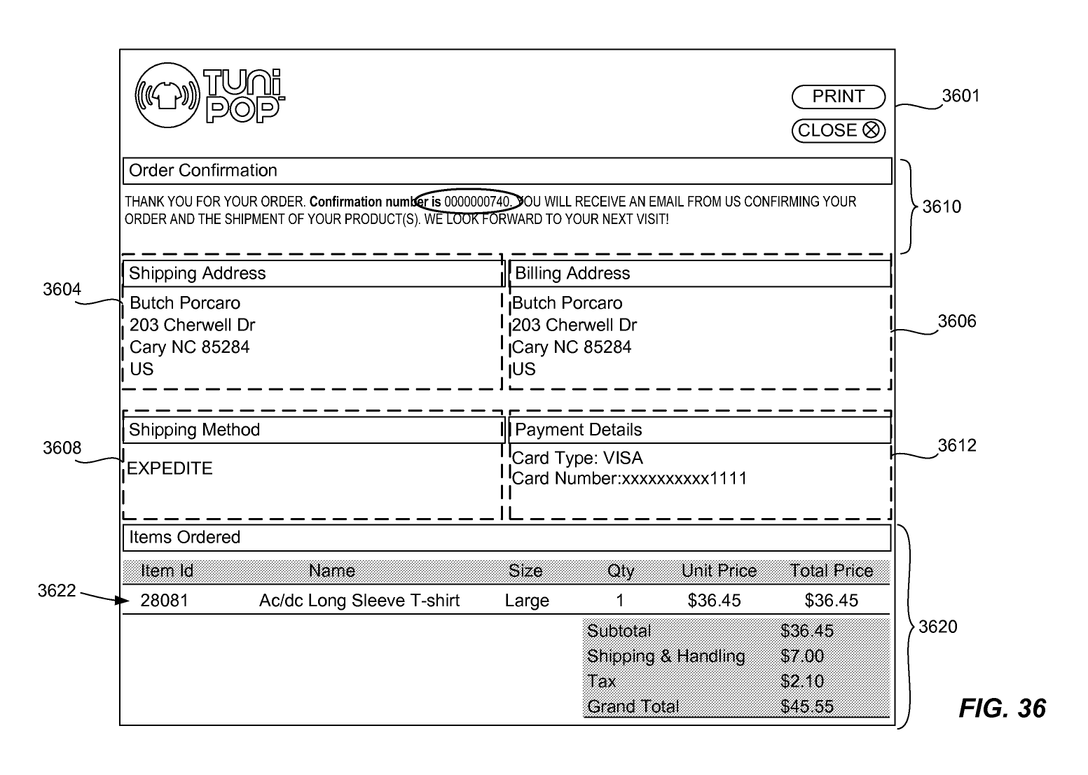

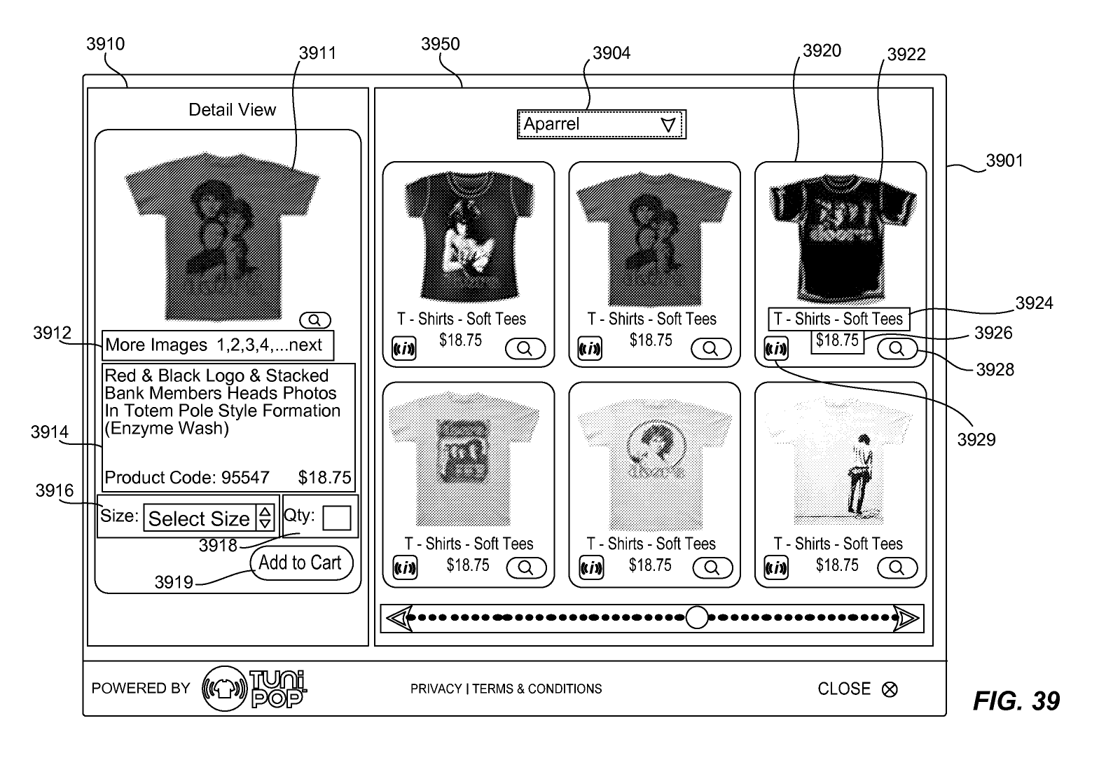

FIGS. 14-44 illustrate example screenshots of various GUIs which may be used for facilitating activities relating to one or more of the MQSS aspects disclosed herein. In at least one embodiment, at least a portion of the GUIs may be configured or designed for use at one or more Client System(s) including PCs, notebook computers, smartphones, and other mobile devices.

For purposes of illustration, the interaction diagram of FIG. 11A will now be described by way of example with reference to FIGS. 14-44 of the drawings. In this particular example it is assumed that a user is accessing an online music streaming website such as Grooveshark.com (Content Provider), and that the user initiates a music streaming session for listening to music associated with the music artist: Black Eyed Peas. As described in greater detail below, the MQSS Server System (in communication with the Content Provider's server system) identifies brands (e.g., artists, actors, movies, etc.) relating to the user's browsing and/or streaming activities, and automatically identify and present opportunities for the user (e.g., in real-time or substantially real-time) to purchase merchandise relating to (or associated with) the identified brands. A GUI is displayed to the user (e.g., via the user's computer system) to facilitate the online purchase of item(s) of merchandise. In one embodiment, the GUI may be implemented in the form of a dynamic overlay layer which enables the purchaser to complete the purchase of desired items of merchandise without causing the user's browser application to navigate away from the underlying web page. Upon completion of the merchandise order, the overlay GUI automatically closes, thereby returning the user to back to the Grooveshark.com web page that the user was viewing prior to the display of the overlay GUI. Additionally, upon completion of the merchandise order, the MQSS Server System communicates with the Fulfiller/Supplier in order to cause the order to be successfully filled and shipped to the user.

As illustrated in the example embodiment of FIG. 11A, as shown at 02a—It is assumed that a user of Client System 1102 submits to the Content Provider system 1104 a User Request such as, for example, a request for accessing digital content relating to (or associated with) a particular brand (e.g., artist, song, group, movie/video title, etc.)

As shown at 04a—As the user interacts with the content provider's website (e.g., user requests to initiate a music streaming session for a particular brand or genre), the Content Provider identifies the brand information relating to the user's request (and/or associated with digital media content being provided to the Client System 1102).

As shown at 06a—It is assumed that the Content Provider responds to the user's request by providing the requested digital media content (e.g., Content Provider may provide streaming music to the user's Client System).

As shown at 08a—The Content Provider may submit a Merchandise Availability Query to the MQSS Server System. In at least one embodiment, the Merchandise Availability Query may include various types of contextual query information which, for example, may be used by the MQSS Server System to identify one or more items of merchandise which are available for sale or purchase. For example, in one embodiment, the Merchandise Availability Query may include brand information relating to the brand identified by the Content Provider. Examples of other types of contextual query information may include, but are not limited to, one or more of the following (or combinations thereof):
Brand information
Publisher/Retailer ID
Media Type Category
User location information
Browser information (Mobile, web)
Ad ID
Sales channel information
Marketing channel information
Device platform information (e.g.,
etc.

As shown at 010a, 011a, and 012a—One or more operations may be initiated and/or performed at the MQSS Server System such as, for example, one or more of the following (or combinations thereof).
Process merchandise availability query;
Identify Brand info;
Correct Spelling via lookup table;
Determine Brand ID
Determine available merchandise (if any)
Correct query structure
Generate request response;
Send Response to query to Content Provider (which may include, for example, available merchandise info, Brand ID info, etc.)

In at least one embodiment, the MQSS Server System identifies the Artist ID and/or Brand ID from the text/search request sent from the Content Provider. For example, a user on Grooveshark searches for an artist using Grooveshark's search engine. In one embodiment, Grooveshark sends the same text search to the MQSS Server System using a structured query. If the MQSS Server System has merchandise for that Brand/Artist then the MQSS Server System sends a query response which includes information relating to any identified available merchandise. The response may also include Artist ID or Brand ID information, which, for example, may be used for subsequent queries submitted by the Content Provider.

As shown at 14a—Process query response; Update GUI content to be displayed at Client System.

As shown at 16a—Updated GUI Content (e.g., merchandise availability logo/info) may be displayed at the Client System.

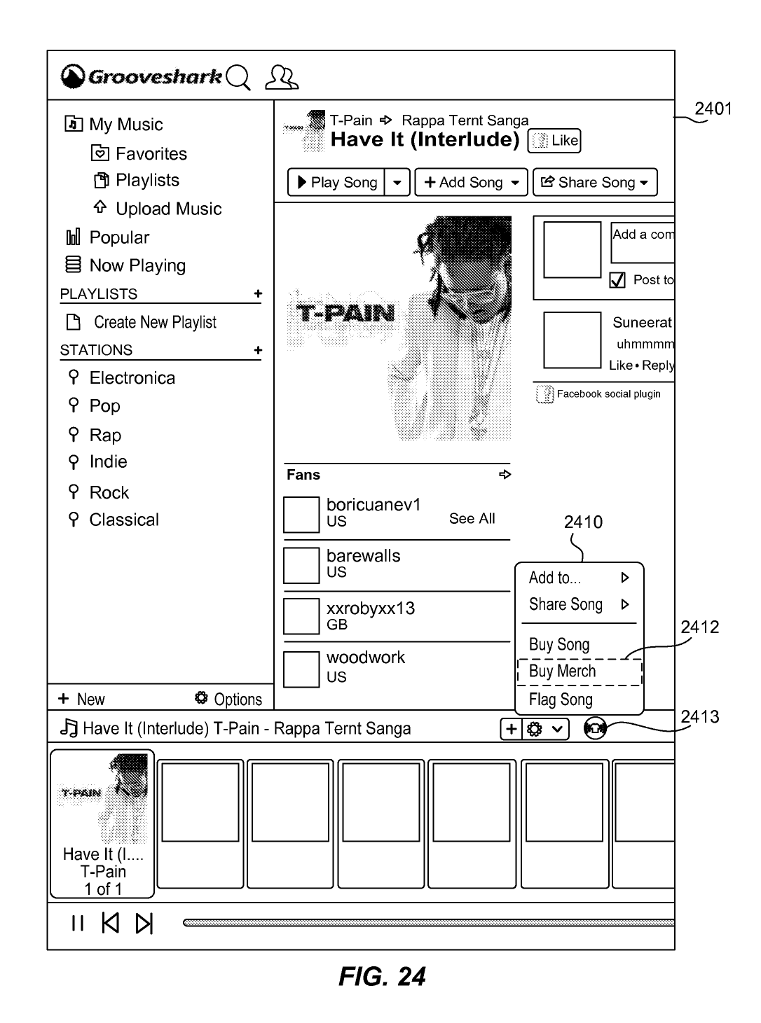

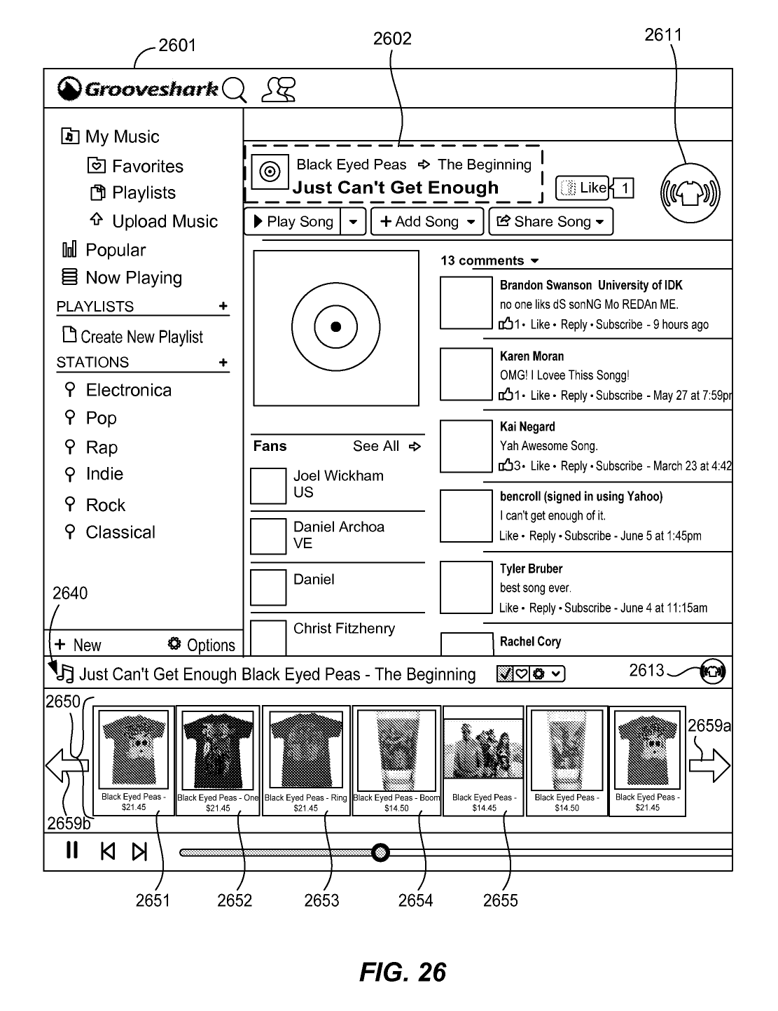

For example, in the present example embodiment, Grooveshark may provide instructions and content to the Client System for displaying a “merchandise available” button (e.g., 2413, FIG. 24; 2613, FIG. 26) on the Client System and/or for displaying available merchandise (e.g., 2650, FIG. 26) associated with the identified artist/brand. Various different embodiments of these activities are illustrated, for example, in the example screenshot GUIs of FIGS. 24-27 of the drawings.

As shown at 18a—The merchandise availability logo (and/or other available merchandise logo/info) may be automatically and/or dynamically displayed at the Client System. In at least one embodiment, if it is determined that there is available merchandise associated with the identified Artist ID/Brand ID, the appearance of the displayed merchandise availability logo/button may be automatically and/or dynamically changed or modified (e.g., in real time or substantially real time). For example, referring to the example screenshot of FIG. 24, in one embodiment, the merchandise availability logo/button 2413 may have a first appearance (e.g., displayed color of the logo/button=gray) during a first set of specified conditions (e.g., when no available merchandise is detected for the identified Artist ID/Brand ID), and may have a second appearance (e.g., displayed color of the logo/button=green) during a second set of specified conditions (e.g., when available merchandise is detected for the identified Artist ID/Brand ID).

In at least one embodiment, the merchandise availability logo/button may be rendered for display as a clickable hyperlink, and may have various types of data/metadata associated with it, such as, for example, one or more of the following (or combinations thereof):
Artist ID/Brand ID
Landing URL
Content Provider ID
Other types of information described herein.

As shown at 20a—User interacts with displayed merchandise availability logo/info.

For example, in at least one embodiment, when the user clicks on (or interacts with) the “merchandise available” button, it causes the Client System to send the MQSS Server System a structured request that includes the Artist/Brand ID, and instructs the MQSS Server System to initiate launch the MQSS Application GUI at the Client System which displays artist merchandise that matches the specified Artist/Brand ID.

As shown at 21a—Client System sends structured request (e.g., which includes Artist/Brand ID info) to MQSS Server System.

As shown at 22a—MQSS Server System processes client request, and generates MQSS Application GUI instructions, merchandise info/content to be rendered and displayed at Client System.

As shown at 23a—Display MQSS Application GUI.

As shown at 24a—User interacts with MQSS Application GUI (e.g., browses for merchandise, etc.); Client System retrieves content relating to available brand-related merchandise; Render retrieved content for display in MQSS Application GUI.

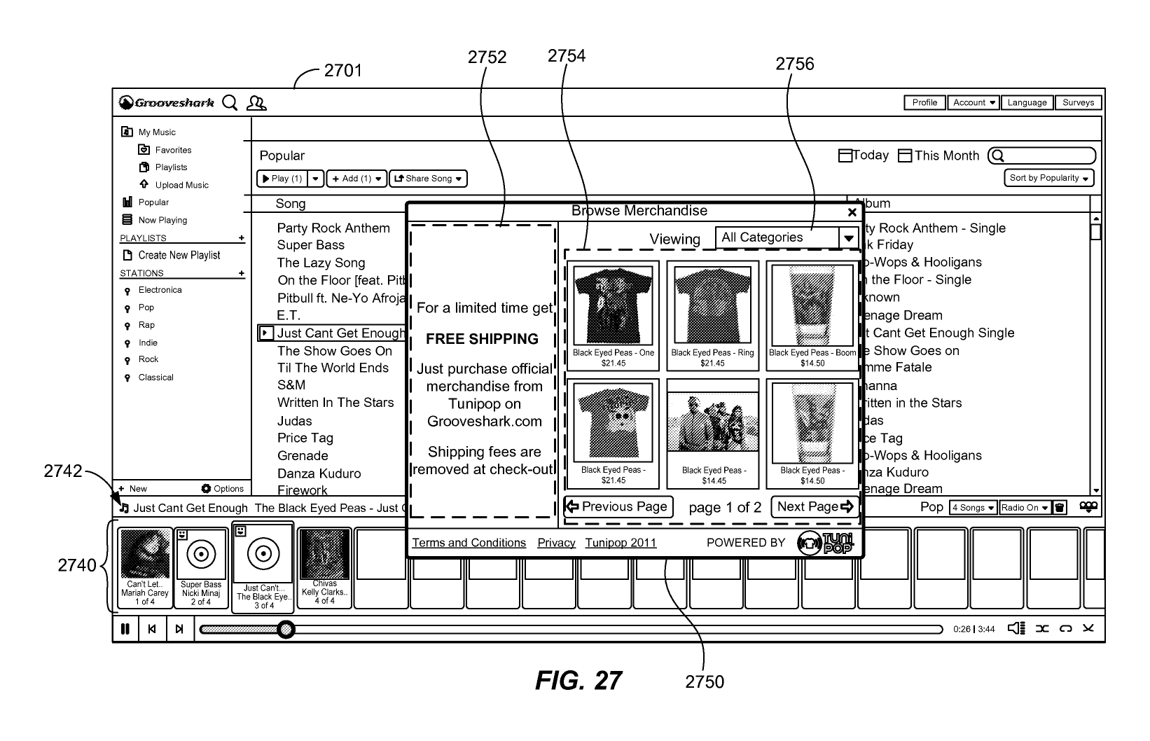

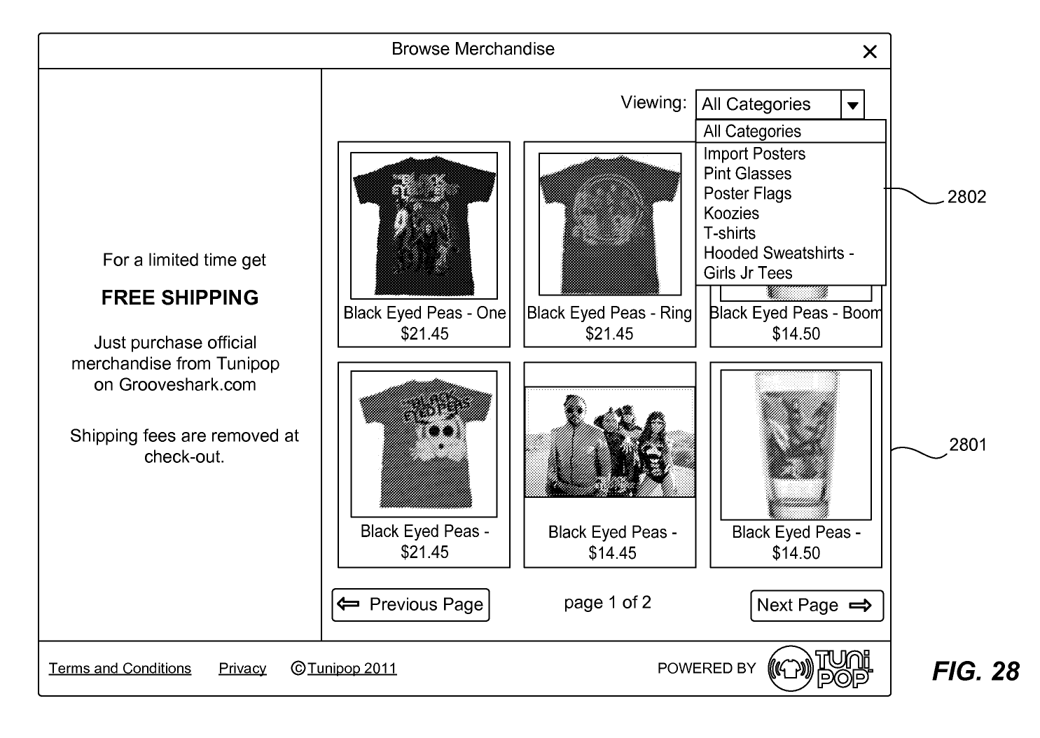

In at least one embodiment, the MQSS Application GUI (e.g., 2750, FIG. 27) is displayed to the user (via the user's computer system) to facilitate the online purchase of item(s) of merchandise. In one embodiment, the GUI may be implemented in the form of a dynamic overlay layer (e.g., using Adobe Flash, Java Script, etc.) which enables the user to browse available merchandise, add/remove items to/from the user's shopping cart, and complete the purchase of desired items of merchandise without causing the user's browser application to navigate away from the underlying web page (e.g., 2701, FIG. 27). Various different embodiments of these activities are illustrated, for example, in the example screenshot GUIs of FIGS. 28-31 of the drawings. Additional example embodiments of different GUIs which may be used to facilitate and/or enable the user's merchandise browsing activities, shopping cart activities, and/or order processing activities are illustrated, for example, in FIGS. 14-23, 39, 42, and 44-44.

As shown at 26a—User identifies and selects merchandise for purchase; Initiates checkout/purchase.

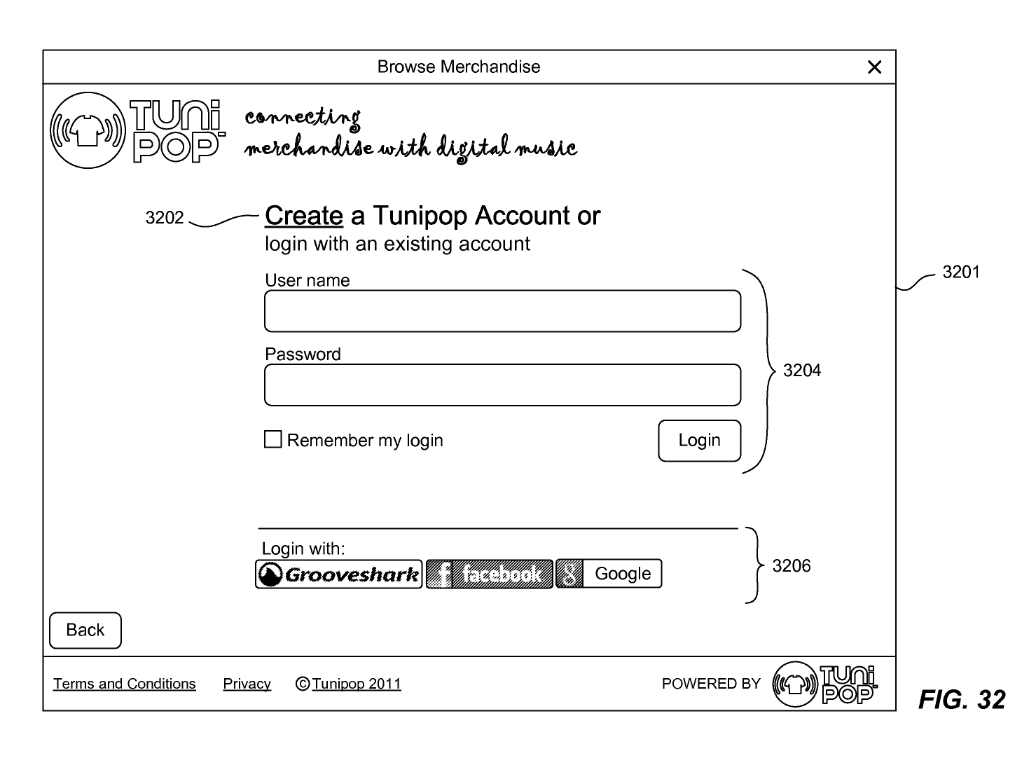

As shown at 28a—The MQSS Server System facilitates the shopping cart, checkout, and payment processes. Checkout, Purchase, and/or Funding Transaction(s) are processed and completed via MQSS Application GUI. Various different embodiments of these activities are illustrated, for example, in the example screenshot GUIs of FIGS. 32-36 of the drawings.

As shown at 30a—Close MQSS Application GUI. Upon completion of the merchandise order, the MQSS Application GUI may be automatically closed, thereby returning the user to back to the Grooveshark.com web page (e.g., 2701, FIG. 27) that the user was viewing prior to the display of the overlay GUI.

As shown at 32a—The MQSS Server System may process competed order transaction(s); Identify merchandise fulfiller(s) associated with processed order; Generate Order Fulfillment Request for purchased merchandise.

As shown at 34a—Order Fulfillment Request(s) sent to identified merchandise fulfiller(s) associated with order. In at least one embodiment, multiple different order fulfillment requests may be generated for a given order and sent to different merchandise for fillers.

As shown at 36a—Merchandise fulfiller(s) process Order Fulfillment Request(s); Ship purchased merchandise to User; Generate Order Fulfillment Confirmation.

As shown at 38a—Order Fulfillment Confirmation(s).

As shown at 40a—Purchased merchandise delivered to User.

As shown at 42a—Order Fulfillment Delivery Confirmation.

As shown at 44a—Update database with updated order status information.

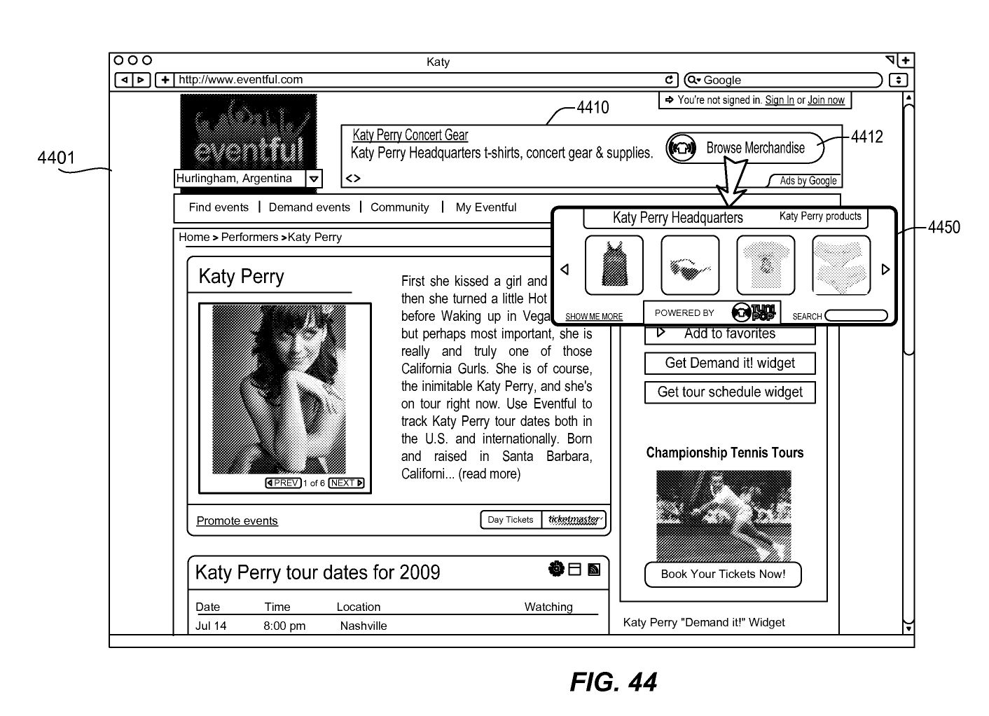

FIG. 11B shows an alternate example embodiment of an MQSS Interaction Diagram, illustrating various data flows and interactions between various systems/devices of the MQSS network, which may be utilized for implementing various aspects described herein. For purposes of illustration, the interaction diagram of FIG. 11B will now be described by way of example with reference to FIG. 44 of the drawings.

In this particular example it is assumed that a user is using her computer (e.g. Client System) to access information about Katy Perry via the website Eventful.com (Content Provider). As the user browses the website for information about Katy Perry, a webpage (e.g., 4401, FIG. 44) is displayed which includes information about Katy Perry, as well as an advertisement 4410 generated by an advertiser (e.g., 1110, FIG. 11B). In this particular example, the ad 4410 relates to the purchase of Katy Parry related merchandise, and includes an MQSS “Browse Merchandise” button 4412 which is configured or designed as an interactive hyperlink which includes specific MQSS related information (such as, for example, Ad ID information, Brand ID information, etc.). When the user clicks on (or interacts with) the “Browse Merchandise” button 4412, it causes the Client System to send the MQSS Server System an MQSS query which includes the specific MQSS related information, and instructs the MQSS Server System to initiate display of an MQSS Application GUI (e.g., 4450) at the Client System which is configured or designed to facilitate the online purchase of selected Katy Perry merchandise (e.g., selected Katy Perry merchandise that is associated with a specific supplier who sponsored the advertisement 4410). In one embodiment, the MQSS Application GUI may be implemented in the form of a dynamic overlay layer which enables the purchaser to complete the purchase of desired items of merchandise without causing the user's browser application to navigate away from the underlying web page.

As illustrated in the example embodiment of FIG. 11B, as shown at 01b—It is assumed that the advertiser 1110 generates an ad (e.g., 4410, FIG. 44) which includes MQSS related content/info. In this particular example, the advertiser knows in advance that the advertisement will relate to Katy Perry merchandise provided by a specific supplier, and therefore configures the ad to include specific MQSS related information which may subsequently provided to the MQSS Server System (e.g., via MQSS query) and used by the MQSS Server System to filter the MQSS query results so that only Katy Perry merchandise provided by the specific supplier is identified/displayed.

As shown at 02b, the user engages in web browsing activity at a Content Provider (1104) website (e.g., Eventful.com).

As shown at 04b, the Content Provider retrieves the ad information (e.g., relating to ad 4410, FIG. 44) from the advertiser 1110.

As shown at 06b, 08b, the Client System receives and renders for display, webpage content (e.g., relating to webpage 4401, FIG. 44) and ad information (e.g., relating to ad 4110, FIG. 44).

As shown at 10b, it is assumed that the user clicks on (or interacts with) the “Browse Merchandise” button 4412, which causes the Client System to send (12b) to the MQSS Server System an MQSS query (e.g., structured query) which includes the specific MQSS related information. According to different embodiments, the MQSS related information may include one or more of the following (or combinations thereof):
Brand information
Publisher/Retailer ID
Media Type Category
User location information
Browser information (Mobile, web)
Ad ID
Sales channel information
Marketing channel information
Device platform information
and/or other types of contextual information described and/or referenced herein.

As shown at 22b—MQSS Server System processes client request, and generates MQSS Application GUI instructions, merchandise info/content to be rendered and displayed at Client System.

The remainder of the operations/actions 23b-44b of FIG. 11B are similar to those described previously with respect to FIG. 11A, and therefore will not be repeated.

It will be appreciated that different embodiments of the MQSS Interaction Diagram (not shown) may include additional features and/or operations than those illustrated in the specific embodiments of FIGS. 11A and 11B, and/or may omit at least a portion of the features and/or operations of MQSS Interaction Diagram illustrated in the specific embodiments of FIGS. 11A and 11B.

### MQSS Contextual Analysis and Filtering

In at least one embodiment, the MQSS System includes contextual analysis and filtering functionality which may be used for enabling and/or facilitating various aspects disclosed herein. For example, according to different embodiments, the MQSS Server System may automatically and/or dynamically filter the merchandise items which are displayed as being available for sale/purchase based upon specific contextual conditions relating to the current MQSS merchandise shopping session, and/or based upon various types of filtering criteria such as, for example, one or more of the following (or combinations thereof):
Brand ID
Content Provider ID
Ad ID
User Location
Geographical Criteria
Time/Date
Marketing Channel
Sales Channel
Customer demographics
Media Type Category (e.g., Music, Video, Movie, TV, Ad, etc.)
Supplier ID
SKU
etc.

In this way, the MQSS platform provides both the brand owner and suppliers with the tools to suggest, approve and control the display of products that are meaningful “in-context” with the music, video, etc. They also have the ability to control the display of those products by sales channel, location, and/or other specified criteria. For example, shirt #1 may only be available via YouTube in Los Angeles, while shirt #2 may only be available via Pandora.com in Chicago, etc.

Several examples of different MQSS contextual scenarios are provided below for purposes of illustration.

Video Streaming Context Example:

In this particular example it is assumed that a user is accessing an online video streaming website such as YouTube.com (Content Provider), and that the user initiates a video streaming session for a video associated with a movie: Star Wars.

In at least one embodiment, the MQSS Server System (in communication with the YouTube.com) may acquire and processes contextual criteria relating to the user's activities such as, for example, brands (e.g., artists, actors, movies, etc.), user's geographical location, media type (e.g., video), user's browsing and/or streaming activities, and/or other types of criteria described and/or referenced herein, and in response, may automatically and/or dynamically identify and present (e.g., in real-time or substantially real-time) one or more opportunities for the user to browse and/or purchase merchandise associated with the Star Wars brand. In at least one embodiment, at least a portion of the opportunities presented to the user (e.g., to purchase merchandise associated with the Star Wars brand) may include one or more techniques similar to those described, for example, with respect to FIGS. 11A, 11B and/or 43A-B.

Television Sporting Event Example:

In this particular example it is assumed that a user is accessing broadcast television and is watching a basketball game between the LA Lakers and Chicago Bulls. The user then uses his smartphone to engage with a third party service such as Shazam.com and initiates a request with Shazam.com to indentify the sporting event being viewed and the teams that are playing. The shazam.com service captures audio from the televised basketball game, and identifies the sporting event as a basketball game being played between the LA Lakers and Chicago Bulls at the Staples Center (in Los Angeles). In at least one embodiment, Shazam.com may submit this contextual information to the MQSS Server System (e.g., via an MQSS query), whereupon the MQSS Server System may use the received contextual information to identify one or more available items of merchandise, services, and/or special offers relating to either the LA Lakers or Chicago Bulls. In at least one embodiment, if the MQSS Server System is able to identify the user's geographic location (e.g., using the smartphone's IP address), it may use such information to dynamically filter the results of the identified merchandise, services, and/or special offers. For example, in one embodiment, if the MQSS Server System determines that the user's geographic location is Chicago, it may assume from this contextual information that the user is a Chicago Bulls fan (as opposed to a LA Lakers fan), and may respond by dynamically filtering the MQSS query results such that only merchandise, services, and/or special offers relating to the Chicago Bulls (and/or its players) are identified. In at least one embodiment, the MQSS Server System (e.g., in communication with Shazam.com) may cause one or more opportunities to be presented to the user for browsing and/or purchasing one or more of the identified items of merchandise, services, and/or special offers. In at least one embodiment, at least a portion of the opportunities presented to the user may include one or more techniques similar to those described, for example, with respect to FIGS. 11A, 11B and/or 43A-B.

Hotel in-Room Entertainment Example:

In this particular example it is assumed that a user is accessing an in-room entertainment system from a hotel room and is accessing media content such as, for example, movies, music, videos, tourist information, internet content, and/or information related to events being held at the hotel or nearby. For example, the user may use the hotel's in-room entertainment system to engage in the following activities: watch a television broadcast of CIS Miami, listen to an AC/DC song, and use the hotel's local WiFi service to perform Google searches for the search terms “Gray Line Tours” and “Detroit Car Show”. In at least one embodiment, the in-room entertainment system may track contextual information relating to the user's activities in the hotel, and may submit this contextual information to the MQSS Server System (e.g., via an MQSS query). The MQSS Server System may use the received contextual information to dynamically identify one or more available items of merchandise, services, and/or special offers relating to one or more of the user's activities which were tracked by the in-room entertainment system. In at least one embodiment, the MQSS Server System (e.g., in communication with the in-room entertainment system) may cause one or more opportunities to be presented to the user for browsing and/or purchasing one or more of the identified items of merchandise, services, and/or special offers. In at least one embodiment, at least a portion of the opportunities presented to the user may include one or more techniques similar to those described, for example, with respect to FIGS. 11A, 11B and/or 43A-B.

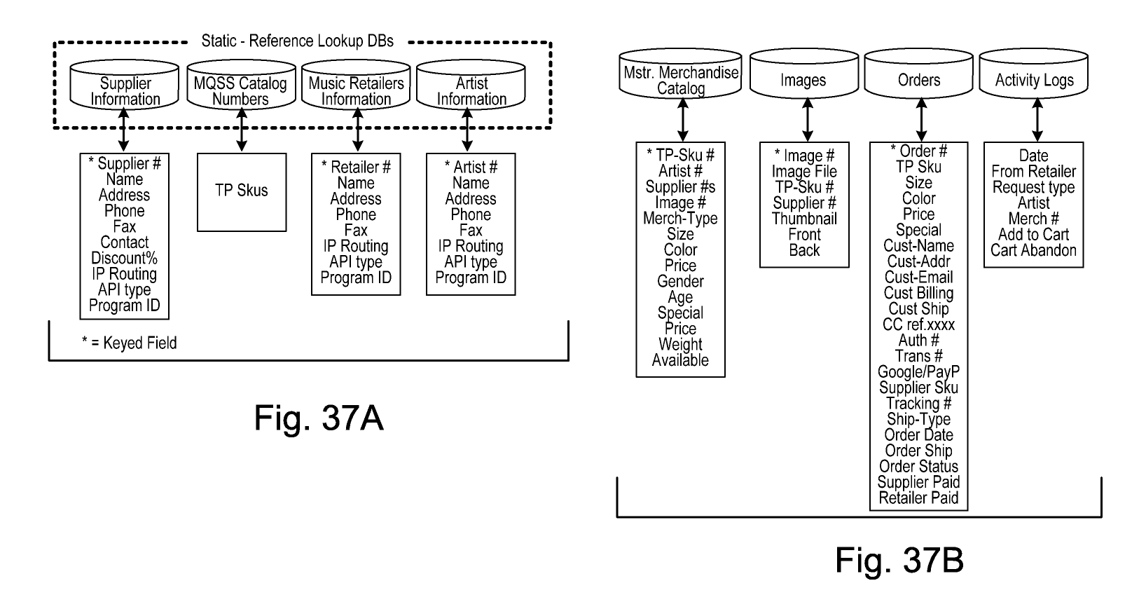

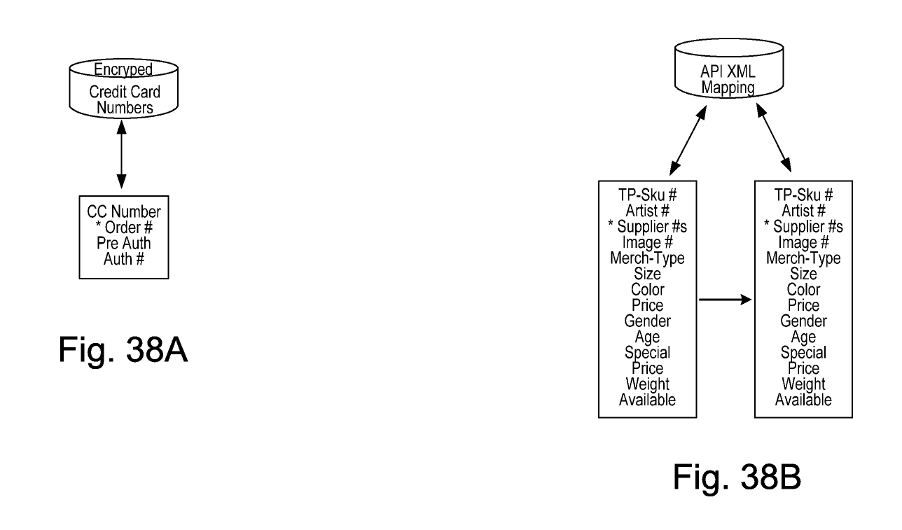

FIGS. 37A-38B illustrate example embodiments of various databases and associated database information which may be used for implementing and/or enabling one or more aspects, features, functionalities described and/or referenced herein.

In at least one embodiment, one or more instances of the MQSS procedures, processes, and/or activities described herein may access and/or utilize information from one or more associated databases. In at least one embodiment, at least a portion of the database information may be accessed via communication with one or more local and/or remote memory devices. Examples of different types of data which may be generated, stored and/or accessed by one or more procedures, processes, systems, and/or components described herein may include, but are not limited to, one or more of the following (or combinations thereof):

| | | |
|---|---|---|
| Address | Age | API type |
| API XML Mapping | Artist # | Auth # |
| Available | Back | CC Number |
| CC ref. | Color | Contact Discount % |
| Credit Card | Cust Billing | Cust Ship |
| Cust-Addr | Cust-Email | Cust-Name |
| Fax | Front | Gender |
| Google/PayP | Image # | Image File |
| IP Routing | Merch-Type | Name |
| Numbers | Order # | Order Date |
| Order Ship | Order Status | Phone |
| Pre Auth | Price | Program ID |
| Retailer # | Retailer Paid | Ship-Type |
| Size | Special | Supplier # |
| Supplier #s | Supplier Paid | Supplier Sku |
| Thumbnail | TP Sku | TP Skus |
| TP-Sku # | Tracking # | Trans # |
| Weight | Ad ID | User |
| Media Type Category | Sales Channel | Marketing Channel |

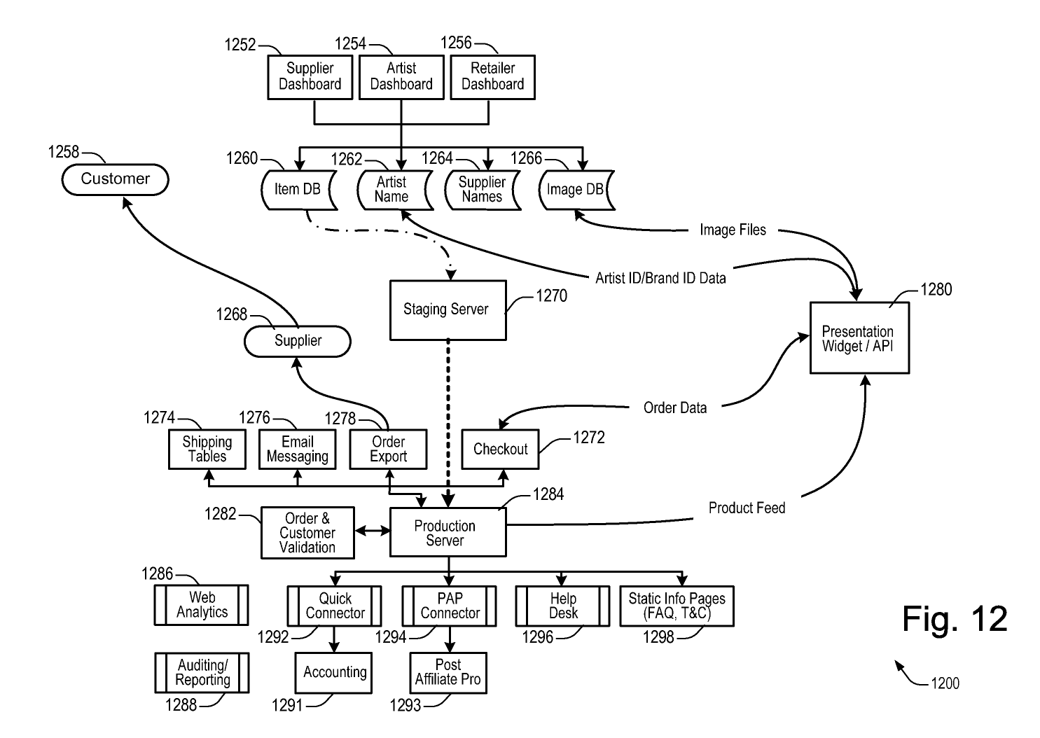

FIG. 12 shows a specific example embodiment of an MQSS Deployment Schema and associated processes, systems, functions and/or components which may be used for implementing and/or enabling various aspects described herein.

As illustrated in the example embodiment of FIG. 12, the MQSS Deployment Schema may include, among other items (shown and/or not shown):
Supplier Dashboard 1252, which, for example, may include functionality and interface(s) (e.g., GUIs) for enabling suppliers, merchants, vendors, merchandise fulfillers, etc. to access and manage specific information and/or processes at the MQSS Server System. In at least one embodiment, the Supplier Dashboard provides suppliers with the tools to view the details of current and historical orders.
Artist Dashboard 1254, which, for example, may include functionality and interface(s) (e.g., GUIs) for enabling artists and/or their agents/representatives to access and manage specific information and/or processes at the MQSS Server System. In at least one embodiment, the Artist Dashboard provides artist with the tools to view the details of current and historical orders of their merchandise.
Retailer (e.g., Content Provider) Dashboard 1256, which, for example, may include functionality and interface(s) (e.g., GUIs) for enabling retailers, content providers, etc., to access and manage specific information and/or processes at the MQSS Server System. In at least one embodiment, the Retailer Dashboard provides retailers with the tools to view the details of current and historical orders.
Presentation Widget 1280 (also referred to as “MQSS System Application”), which, for example, may include functionality for providing and/or managing client user interfaces. In at least one embodiment, the Presentation Widget APIs may include a set of queries and programming calls which returns the desired information and functionality sufficient to enable retailers to complete a MQSS System order. In at least one embodiment, API calls may be recorded in the MQSS System database and orders may be processed in the same manner as if the retailer used the MQSS System Presentation Widget GUI.
Production Server 1284, which, for example, may include a combination of hardware and software that runs the MQSS System Applications, and interfaces with other services and servers on the MQSS System network.

### Interfacing Functions

This section describes specific example embodiments of various types of interfacing functions which may be used for implementing, enabling, and/or facilitating one or more of the various MQSS aspects and/or features described herein. In at least some embodiments, and least a portion of the interfacing functions described herein may be utilized for various different types of communications among the MQSS Server System(s), Content Provider System(s), Client System(s), Merchandise Fulfiller System(s), and/or other 3^{th} party systems.
AddProduct
This function allows adding a product to the MQSS System. If there are variants to the product then one or more its variants could be added at one time.
UpdateProductStock
This function allows updating product inventory for any of the valid fulfiller SKU.
UpdateProductDetails
This function allows updating any of the valid fulfiller product information.
GetProductDisplayDetails
This function returns the display information for a single product or product variants. If TSKUID has variants associated then the response may include information for one or more the variants.
GetMerchandiseForBrand
This function returns list of one or more available products for the given brand and if the category is specified then for the given category. If the category is not specified then one or more the products for one or more categories would be returned.
CreateOrder
This function allows the MQSS Server System to create an order given the order details in the incoming xml parameter. The output is xml which may have multiple orders created if the products within the order are fulfilled by more than one fulfiller.
CalculateOrderFinancials
This function allows the MQSS Server System to calculate the different financial components for the order. Example financial components which may be calculated include Shipping and handling charge, Sales Tax and Discount, etc.
UpdateTrackingInfo
This function allows updating the tracking information for the shipped items. One or more line items could be updated in one call.
CreateUserAccount
This function allows creating a new user in the MQSS System.
ValidateUser
This function allows the user to be validated in the MQSS System.
GetUserBillingAndShippingInfo
Given the user's authentication key, this function may retrieve the users billing and shipping information previously used by the user.

### The MQSS System Query Protocol

This section describes specific example embodiments of MQSS System Query Protocols which may be used for implementing, enabling, and/or facilitating one or more of the various MQSS aspects and/or features described herein, including, for example, interfacing requirements for retailers and content providers to integrate with the MQSS System.

In at least one embodiment, retailers/content providers may submit requests to the MQSS Server System for availability of merchandise using one or more MQSS System Query Protocol queries. The MQSS Server System returns responses to the queries in the form of result code and several pieces of data. In at least one embodiment, the MQSS System is operable to accept several types of inputs which range from simple to more detailed and complex search terms. In at least one embodiment, the MQSS System Query Protocol is extensible, and context may provide the definition of the domain. Various query terms may be defined within the domain. Similar Terms may mean different things in different domains/contexts, and the terms may be interpreted in their respective context. Various examples of different MQSS search query terms, and example MQSS search queries are described below.

### Example Query Contexts

| Context | Meaning | Description |
|---|---|---|
| mm | Music Merchandise | Represents the Music |
| | | Merchandising industry. |
| sm | Sports merchandise | Represents the Sports |
| | | Merchandising industry. |

Example Well known Database Identifiers

| Context | Meaning | Description |
|---|---|---|
| tp | The MQSS System | The MQSS System brand Identifier |
| gn | GraceNotes | GraceNotes Identifier |
| mb | Music Brainz | Music Brainz Identifier |

### Example Context Specific Terms

| Term | Example | Description |
|---|---|---|
| Brand | Brand = Beatles | Brand identifies a music brand |
| | | responsible for that music. |
| Artist | Artist = Britney | Name of an Artist |
| Group | Group = Deep%20Purple | Name of a Band |
| Album | Album = Thriller | Name of an Album by the |
| | | artist or group |
| Brand | Brand = Manchester%20United | Brand identifies a Sports |
| | | brand or franchise. |
| Player | Player = Sachin%20Tendulkar | Name of the player |
| Sport | Sport = Tennis | Name of a Sport |
| Team | Team = Manchester%20United | Name of the Team |

### Example Types of MQSS Queries

According to different embodiments, various different types of MQSS merchandise availability queries may be submitted by the retailer (e.g., Content Provider), depending upon the type of brand information identified (e.g., artist, band, group, song, team, etc.). According to different embodiments, the MQSS System may also be configured or designed to include enhanced query functionality, which, for example, may be used to return artist/brand merchandise image links along with the other response information.

According to different embodiments, the MQSS query features/functionalities may also be utilized in connection with ad placement. For example, in one embodiment, using MQSS technology, the function within in ad may not only promote the artist but may also provide random previews of brand-related merchandise, for example, using the image links provided from the MQSS System's query structure.

FIGS. 14-44 illustrate example screenshots of various different GUI embodiments, illustrating different aspects and features which may be used for facilitating activities relating to one or more of the MQSS aspects disclosed herein. In at least one embodiment, at least a portion of the GUIs may be configured or designed for use at one or more mobile devices.

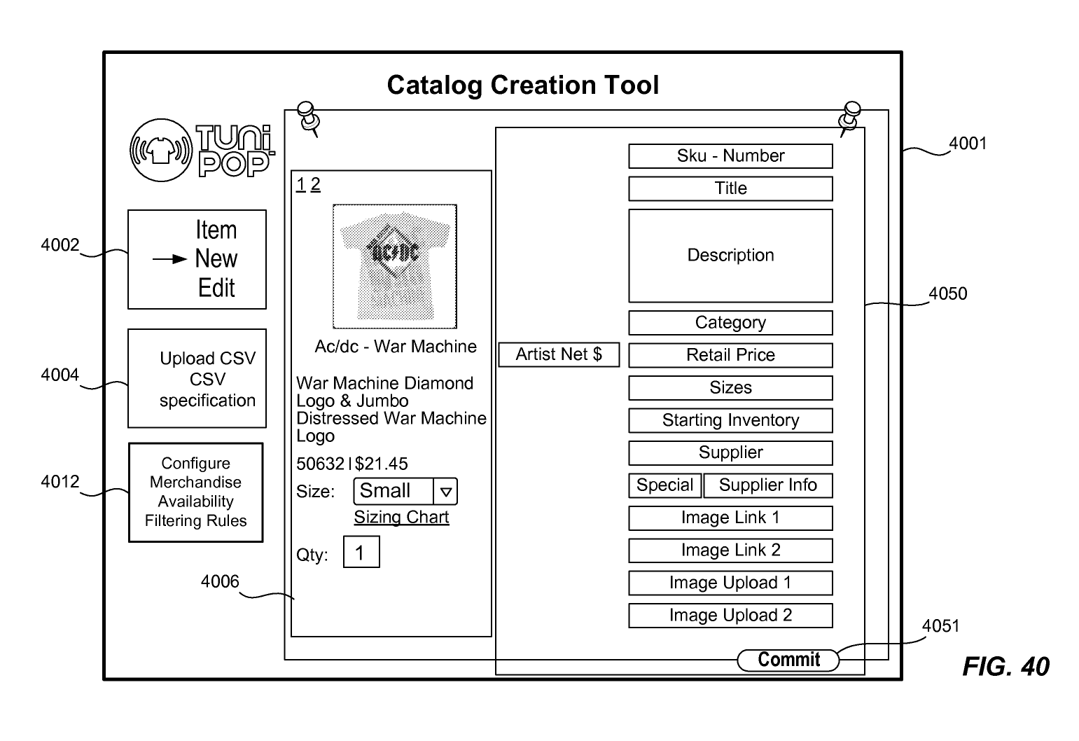

FIG. 40 shows an example screenshot of a MQSS Catalog Management GUI 4001 in accordance with a specific embodiment. According to different embodiments, the MQSS Catalog Management GUI may be operable to facilitate, initiate and/or perform one or more activities/operations relating to the management of merchandise items in the MQSS database. In at least one embodiment, merchant's, suppliers, and/or fulfiller's may manage and/or update their respective inventory of merchandise items via the MQSS Catalog Management GUI.

As illustrated in the example embodiment of FIG. 40, MQSS Catalog Management GUI may include Merchandise Availability Filtering Rules functionality (e.g., 4012), which enables a supplier to set up, define, and manage different types of merchandise availability filtering rules relating to one or more items of merchandise (and/or groups of merchandise) provided by the supplier. In at least one embodiment, the MQSS Server System may use the merchandise availability filtering rules when determining and/or identifying available items of merchandise for a given contextual situation. Examples of different types of filtering rules/criteria which may be specified by the supplier may include, but are not limited to, one or more of the following (or combinations thereof):
Content Provider criteria
Retailer related criteria
Time/Date criteria
Duration criteria
Media Type Category criteria
Brand criteria (e.g., could have multiple)
Location Product Class criteria
Product Category criteria
Product SKU criteria
Location criteria
Language criteria
Currency criteria
Content (e.g., adult, drugs, violence) criteria
Similar/Related criteria
Price criteria
Delivery Method criteria
and/or other types of criteria described and/or referenced herein

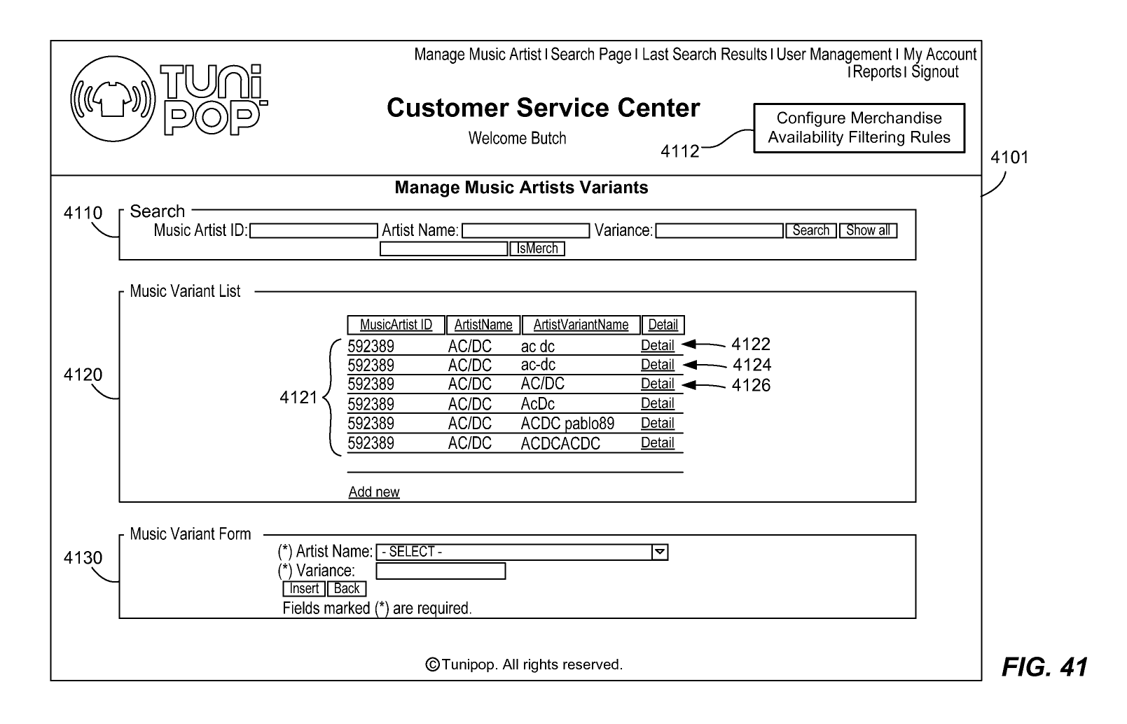

FIG. 41 shows an example screenshot of a MQSS Music Artist Management GUI 4101 in accordance with a specific embodiment. According to different embodiments, the MQSS Music Artist Management GUI may be operable to facilitate, initiate and/or perform one or more activities/operations relating to the management of information relating to music artists and variants in the MQSS database. In at least one embodiment, the MQSS Music Artist Management GUI may also include Merchandise Availability Filtering Rules functionality (e.g., 4112), which enables an artist or brand owner to set up, define, and manage different types of merchandise availability filtering rules relating to one or more items of merchandise (and/or groups of merchandise) associated with that artist/brand owner.

Similarly, in at least one embodiment, the MQSS System may also include Content Provider/Retailer Merchandise Availability Filtering Rules functionality which enables publishers/retailers to set up, define, and manage different types of merchandise availability filtering rules relating to one or more items of merchandise (and/or groups of merchandise). Examples of different types of filtering rules/criteria which may be specified by the Content Provider/retailer may include, but are not limited to, one or more of the following (or combinations thereof):
Brand criteria
Content criteria
Media Type criteria
Class criteria
Category criteria
and/or other types of criteria described and/or referenced herein

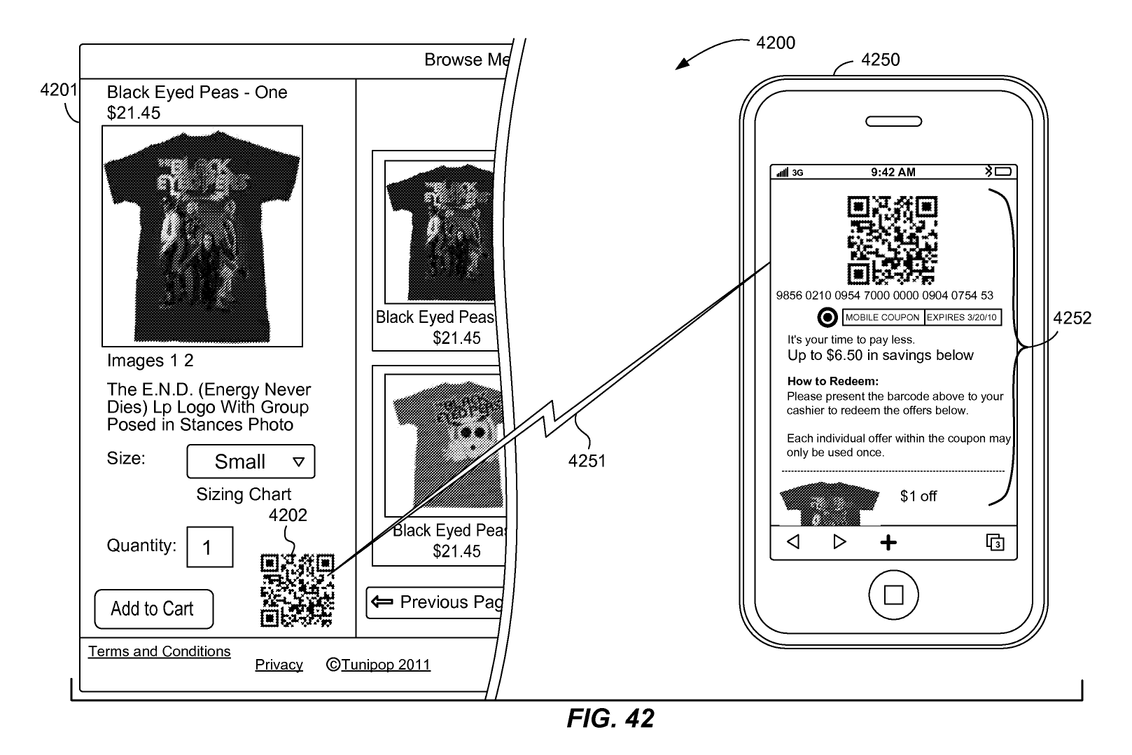

In FIG. 42 shows an example embodiment illustrating how a user's mobile device (e.g., smart phone 4250) may be used to facilitate the purchase of merchandise via the MQSS System. As illustrated in the example embodiment of FIG. 42, the MQSS Application GUI 4201 may include the display of one or more objects of machine-readable code (e.g., QR code 4202). A user may use his or her mobile device (e.g., via use of smart phone camera and appropriate software installed on the smart phone) to cause the mobile device to perform one or more of the following (or combinations thereof):
perform a read/scan of the machine-readable code;
process and interpret the information contained in the machine-readable code; and/or
initiate one or more actions/operations (such as, for example, one or more of those described and/or referenced herein) in response to the processing of the machine-readable code information.

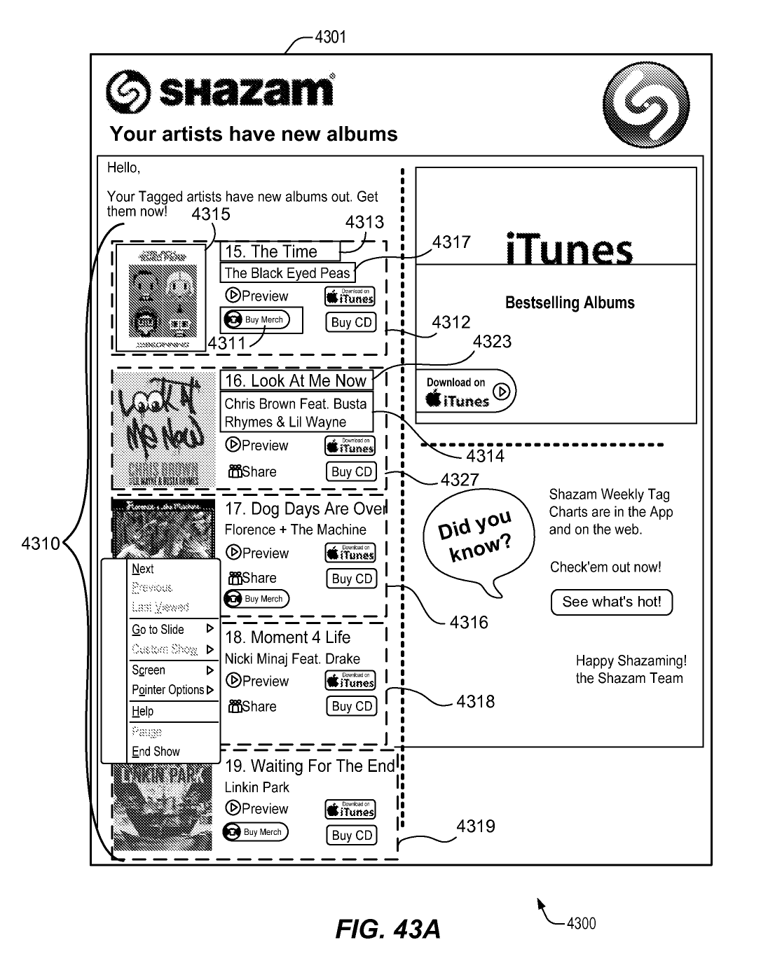

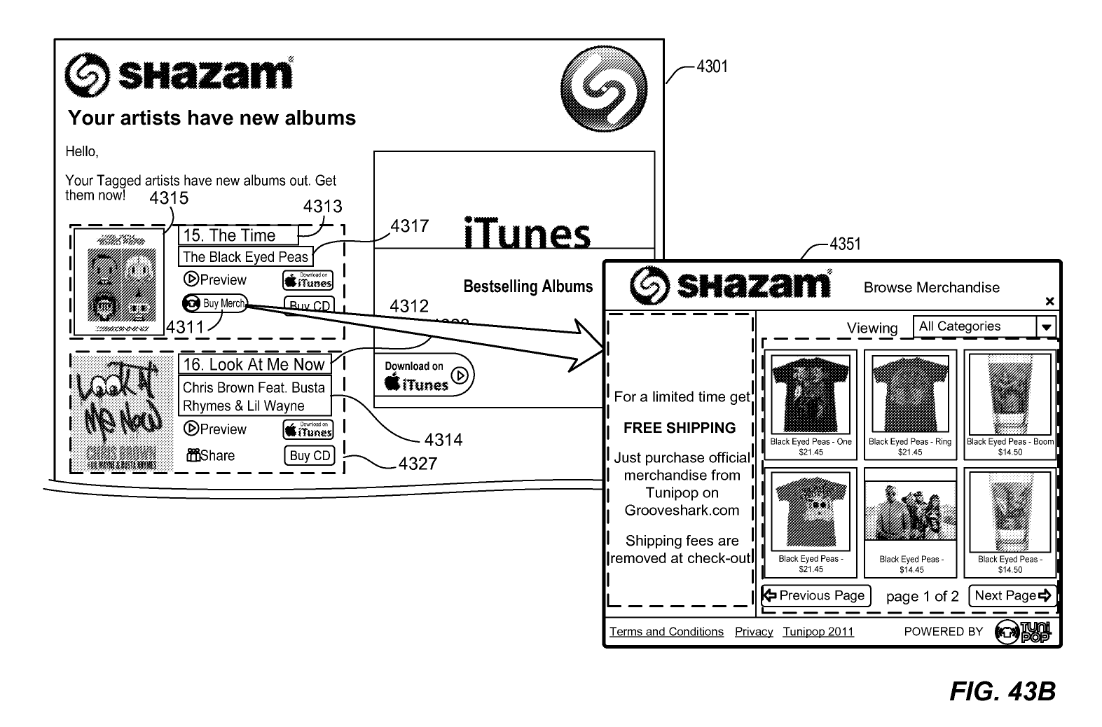

FIGS. 43A-B show example screenshots of alternate embodiments illustrating how various aspects of the MQSS technology described herein may be adapted and utilized for application in other types of electronic communication environments.

For example, FIG. 43A shows an example screenshot of content 4301 which may be included in an e-mail communication sent to one or more users. In at least one embodiment, such e-mail communications may be generated and/or sent from various entities, such as, for example, Content Providers, the MQSS Server System, etc. In the specific example embodiment of FIG. 43A, it is assumed that the e-mail communication and associated content was sent from an online music identification service (e.g., Shazam.com) to one of its customers. In at least one embodiment, the e-mail's content may include personalized information (e.g., 4310) relating to that customer's recent activities such as, for example what songs the customer requested, along with related information about the artist and links to buy the album/song.

Additionally, as illustrated in the example embodiment of FIG. 43A, the e-mail's content may also include one or more “Buy Merch” logo/buttons (e.g., 4311), each of which may be dynamically configured or designed to enable the customer to browse and purchase available merchandise relating to a specifically identified artist (e.g., Artist ID) and/or other brand (e.g., Brand ID). In at least one embodiment, each Buy Merch logo/button may be rendered for display as a clickable hyperlink, and may have various types of data/metadata associated with it, such as, for example, one or more of the following (or combinations thereof):
Artist ID/Brand ID
Landing URL
Content Provider ID
Other types of information described herein.

In at least one embodiment, when the customer clicks on a Buy Merch (e.g., 4311), the customer's computer system (e.g., Client System) may be automatically directed communicate with the MQSS Server System and to display (e.g., via a web browser window, a pop-up window, a dynamic overlay layer, etc.) an instance of the MQSS Application GUI, which may automatically and/or dynamically populate the content of the displayed MQSS Application GUI with information relating to available merchandise that is associated with the identified Artist ID/Brand ID. According to different embodiments, the displayed MQSS Application GUI may be configured or designed to facilitate and/or enable the customer's merchandise browsing activities, shopping cart activities, and/or order processing activities in a manner similar to those described, for example, with respect to FIG. 11A and/or 11B. Further, in at least one embodiment, after a merchandise purchasing transaction has been completed (or when the customer closes the MQSS Application GUI window, the customer's web browser may then be automatically directed to navigate to the Content Provider's website (e.g., Shazam.com).

### Other Features/Benefits/Advantages

According to different embodiments, at least some MQSS System(s) may be configured, designed, and/or operable to provide, enable and/or facilitate one or more of the following features, functionalities, benefits and/or advantages (or combinations thereof)
Supply
   Standardized Data Structures and Identifiers
      Supplier is assigned a MQSS System ID from MQSS System at the time of registration
      Supplier either restructures electronic merchandise's item detail to comply with MQSS System Standards or MQSS System creates scripts to restructure data to comply when data file is received
      As a result of this “Standard Data Structure” a unique MQSS System merchandise Identifier is created using a combination of the TFID, master SKU and TID.
      This MQSS System Merchandise Identifier tags is perpetual.
   Inventory updates are dependent on supplier's system. MQSS System can receive and process updates every 5 minutes as necessary.
      Updates can include
         New items
         Inventory updates on existing items
         Edits on detail description or images
         Attributes (e.g. Size, color, etc)
         Expiration or available dates
         Special/clearance tags
         Availability limits to certain Demand services (e.g. an item can be tagged to only show up on a catalog of Grooveshark and not Jambase)
      Inventory Confirmation reports are automatically generated and sent to supplier and posted on FTP servers
Fulfillment
   Order placement
      Orders are sent to Fulfiller in real time
      Order shipment confirmation is line item
      Payments are released based on order confirmation file updated by the fulfiller and confirmed to MQSS System's system
   Order Reconciliation reports may be automatically and/or dynamically delivered to the fulfiller
   Fees and cost confirmation
   Each order file contains the retail cost of the item, the cost MQSS System pays the Supplier and ship method and shipping payment information
Content Provider/Retailer
   Content Provider assigned unique ID by MQSS Server System
   Authorized to submit MQSS System query and/or API
   Can assign button location code to Query
   Sends raw brand searches to MQSS Server System via structured MQSS System Query
   Hosts MQSS System launch button and or relevant code and scripts
   Hosts Frame to display MQSS System Application
MQSS System Application & GUIs
   Displays catalog items by category
   Displays attributes for all Catalog items
   Images Zoom on mouse over
   Optional login page with Facebook, Content Provider or MQSS System login credentials
   Traditional shopping cart
   Promo and Coupons active on checkout page
   Data collection
      Search requests by Content Provider
      Negative Artist or Brand Merchandise reports
   Exact Brand Match
      Translation database and function to match official “brand” names or references with a spelling variations
      Cross reference spelling with two other fields if available to assure a perfect match
      Supplier Brand name translations are stored and assigned artist in the event Supplier or Fulfiller uses different variations
      This function facilitates integration with other 3^{rd} party database systems to share brand data and or MQSS System merchandise identifiers
   Subscription Services
      Self help dashboard to submit and manage catalog items from brand or artist managers that do not have a sophisticated inventory and order management system
      Items input includes but is not limited to
         Item descriptions
         Prices (e.g., Retail and/or wholesale
         Item images
         Item Attributes
         Specific Markets or customer assignments
         Fulfiller information
         Inventory
         Shipping methods
Other features, functions, benefits and/or advantages as described and/or referenced herein.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A method for facilitating electronic commerce via a computer network, the method comprising:
monitoring a user's interactions with an on-line content provider;
identifying a first brand of interest to the user, wherein the identified first brand of interest is based at least in part upon the user's interactions with the on-line content provider;
determining whether merchandise associated with the identified first brand is available for sale/purchase; and
presenting to the user, via an electronic display and in response to identifying available merchandise associated with the identified first brand, at least one opportunity for the user to purchase at least a portion of the identified available items of merchandise associated with the identified first brand.

2. The method of claim 1 further comprising:
accessing, in response to the user's interactions with the on-line content provider, a first portion of merchandise content from a remote Merchandise Query and Sales System, the Merchandise Query and Sales System including a first database of merchandise content which is managed by an entity other than the on-line content provider;
causing a Merchandise Application GUI to be displayed at the user's display, wherein the displayed Merchandise Application GUI is configured or designed to facilitate the user in activities relating to browsing and purchasing of merchandise associated with the identified first brand of interest; and
dynamically displaying to the user, via the Merchandise Application GUI, the first portion of the merchandise content.

3. The method of claim 1:
wherein the user's interactions include at least one action selected from a group consisting of: browsing for music-related content associated with a specific artist, and receiving streamed digital music-related content associated with the specific artist;
wherein the identified first brand corresponds to the specific artist;
wherein the determining includes determining, in substantially real time, whether merchandise associated with the specific artist is available for sale/purchase; and
wherein the presenting includes dynamically presenting to the user, in response to identifying available merchandise associated with the specific artist, the at least one opportunity for the user to purchase at least a portion of the identified available items of merchandise associated with the specific artist.

4. The method of claim 1:
wherein the user's interactions include at least one action selected from a group consisting of: browsing for video-related content associated with a specific brand, and receiving streamed digital video-related content associated with the specific brand;
wherein the identified first brand corresponds to the specific brand;
wherein the determining includes determining, in substantially real time, whether merchandise associated with the specific brand is available for sale/purchase; and
wherein the presenting includes dynamically presenting to the user, in response to identifying available merchandise associated with the specific brand, the at least one opportunity for the user to purchase at least a portion of the identified available items of merchandise associated with the specific brand.

5. The method of claim 1 further comprising:
causing a merchandise availability object to be displayed according a first appearance format in response to detecting a first set of conditions, wherein the first set of conditions relates to a failure to identify available merchandise for the identified first brand; and
dynamically and automatically causing a merchandise availability object to be displayed according to a second appearance format in response to detecting a second set of conditions, wherein the second set of conditions includes identifying at least one available item of merchandise associated with the identified first brand.

6. The method of claim 1 further comprising:
causing a merchandise availability object to be displayed at the client system, wherein the merchandise availability object is configured or designed to facilitate the user in performing activities relating to browsing and purchasing of merchandise associated with the identified first brand of interest; and
wherein the merchandise availability object is displayed in a main body portion of web page content being displayed at the client system.

7. The method of claim 1 further comprising:
causing a merchandise availability object to be displayed at the client system, wherein the merchandise availability object is configured or designed to facilitate the user in performing activities relating to browsing and purchasing of merchandise associated with the identified first brand of interest; and
wherein the merchandise availability object is displayed in an advertisement associated with a web page being displayed at the client system.

8. The method of claim 1 further comprising:
causing a merchandise availability object to be displayed at the client system, wherein the merchandise availability object is configured or designed to inform the user of at least one opportunity for the user to purchase at least a portion of the identified available items of merchandise associated with the identified first brand; and
causing a Merchandise Application GUI to be dynamically displayed at the user's display in response to detection of user interaction with the displayed merchandise availability object, wherein the displayed Merchandise Application GUI is configured or designed to facilitate the user in activities relating to browsing and purchasing of merchandise associated with the identified first brand of interest, wherein the displayed Merchandise Application GUI includes merchandise content retrieved from a remote Merchandise Query and Sales System which is managed by an entity other than the on-line content provider.

9. The method of claim 1 further comprising:
dynamically filtering the identified available merchandise to include only specific items of merchandise which match at least one filter criteria selected from a group consisting of: brand criteria, content provider criteria, ad criteria, user location criteria, sales channel criteria, media type criteria, and supplier criteria.

10. The method of claim 1 further comprising:
causing a Merchandise Application GUI to be displayed at the user's display, wherein the displayed Merchandise Application GUI is configured or designed to facilitate the user in activities relating to browsing and purchasing of merchandise associated with the identified first brand of interest, wherein the displayed Merchandise Application GUI includes merchandise content retrieved from a remote Merchandise Query and Sales System which is managed by an entity other than the on-line content provider; and
facilitating the user in successfully completing an order transaction for at least one item of merchandise associated with the identified first brand without causing the user's browser to navigate away from a current displayed URL during the order transaction process.

11. A system for facilitating electronic commerce via a computer network, the system comprising:
at least one processor;
at least one interface operable to provide a communication link to at least one network device; and
memory;
the system being operable to:
monitor a user's interactions with an on-line content provider;
identify a first brand of interest to the user, wherein the identified first brand of interest is based at least in part upon the user's interactions with the on-line content provider;
determine whether merchandise associated with the identified first brand is available for sale/purchase; and
present to the user, via an electronic display and in response to identifying available merchandise associated with the identified first brand, at least one opportunity for the user to purchase at least a portion of the identified available items of merchandise associated with the identified first brand.

12. The system of claim 11 being further operable to:
access, in response to the user's interactions with the on-line content provider, a first portion of merchandise content from a remote Merchandise Query and Sales System, the Merchandise Query and Sales System including a first database of merchandise content which is managed by an entity other than the on-line content provider;
cause a Merchandise Application GUI to be displayed at the user's display, wherein the displayed Merchandise Application GUI is configured or designed to facilitate the user in activities relating to browsing and purchasing of merchandise associated with the identified first brand of interest; and
dynamically display to the user, via the Merchandise Application GUI, the first portion of the merchandise content.

13. The system of claim 11:
wherein the user's interactions include at least one action selected from a group consisting of: browsing for music-related content associated with a specific artist, and receiving streamed digital music-related content associated with the specific artist;
wherein the identified first brand corresponds to the specific artist;
wherein the system is further operable to determine, in substantially real time, whether merchandise associated with the specific artist is available for sale/purchase; and
wherein the system is further operable to dynamically present to the user, in response to identifying available merchandise associated with the specific artist, the at least one opportunity for the user to purchase at least a portion of the identified available items of merchandise associated with the specific artist.

14. The system of claim 11:
wherein the user's interactions include at least one action selected from a group consisting of: browsing for video-related content associated with a specific brand, and receiving streamed digital video-related content associated with the specific brand;
wherein the identified first brand corresponds to the specific brand;
wherein the system is further operable to determine, in substantially real time, whether merchandise associated with the specific brand is available for sale/purchase; and
wherein the system is further operable to dynamically present to the user, in response to identifying available merchandise associated with the specific brand, the at least one opportunity for the user to purchase at least a portion of the identified available items of merchandise associated with the specific brand.

15. The system of claim 11 being further operable to:
cause a merchandise availability object to be displayed according a first appearance format in response to detect a first set of conditions, wherein the first set of conditions relates to a failure to identify available merchandise for the identified first brand; and
dynamically and automatically cause a merchandise availability object to be displayed according to a second appearance format in response to detect a second set of conditions, wherein the second set of conditions includes identifying at least one available item of merchandise associated with the identified first brand.

16. The system of claim 11 being further operable to:
cause a merchandise availability object to be displayed at the client system, wherein the merchandise availability object is configured or designed to facilitate the user in performing activities relating to browsing and purchasing of merchandise associated with the identified first brand of interest; and
wherein the merchandise availability object is displayed in a main body portion of web page content being displayed at the client system.

17. The system of claim 11 being further operable to:
cause a merchandise availability object to be displayed at the client system, wherein the merchandise availability object is configured or designed to facilitate the user in performing activities relating to browsing and purchasing of merchandise associated with the identified first brand of interest; and
wherein the merchandise availability object is displayed in an advertisement associated with a web page being displayed at the client system.

18. The system of claim 11 being further operable to:
cause a merchandise availability object to be displayed at the client system, wherein the merchandise availability object is configured or designed to inform the user of at least one opportunity for the user to purchase at least a portion of the identified available items of merchandise associated with the identified first brand;
cause a Merchandise Application GUI to be dynamically displayed at the user's display in response to detection of user interaction with the displayed merchandise availability object, wherein the displayed Merchandise Application GUI is configured or designed to facilitate the user in activities relating to browsing and purchasing of merchandise associated with the identified first brand of interest, wherein the displayed Merchandise Application GUI includes merchandise content retrieved from a remote Merchandise Query and Sales System which is managed by an entity other than the on-line content provider.

19. The system of claim 11 being further operable to:
dynamically filter the identified available merchandise to include only specific items of merchandise which match at least one filter criteria selected from a group consisting of: brand criteria, content provider criteria, ad criteria, user location criteria, sales channel criteria, media type criteria, and supplier criteria.

20. The system of claim 11 being further operable to:
cause a Merchandise Application GUI to be dynamically displayed at the user's display in response to detection of user interaction with the displayed merchandise availability object, wherein the displayed Merchandise Application GUI is configured or designed to facilitate the user in activities relating to browsing and purchasing of merchandise associated with the identified first brand of interest, wherein the displayed Merchandise Application GUI includes merchandise content retrieved from a remote Merchandise Query and Sales System which is managed by an entity other than the on-line content provider; and
facilitate the user in successfully completing an order transaction for at least one item of merchandise associated with the identified first brand without causing the user's browser to navigate away from a current displayed URL during the order transaction process.
